(19) United States
(12) Patent Application Publication
(10) Pub. No.: US 2025/0115773 A1
(43) Pub. Date: Apr. 10, 2025

(54) TWO-DIMENSIONAL PEROVSKITE TEMPLATES FOR DURABLE AND EFFICIENT PEROVSKITE SOLAR CELLS AND OPTOELECTRONIC DEVICES

(71) Applicant: William Marsh Rice University, Houston, TX (US)

(72) Inventors: Aditya D. Mohite, Houston, TX (US); Siraj Sidhik, Houston, TX (US)

(73) Assignee: William Marsh Rice University, Houston, TX (US)

(21) Appl. No.: 18/906,948

(22) Filed: Oct. 4, 2024

Related U.S. Application Data
(60) Provisional application No. 63/587,865, filed on Oct. 4, 2023.

(51) Int. Cl. C09D 11/03

(52) U.S. Cl. CPC C09D 11/03

(57) ABSTRACT

A method of forming a perovskite film includes depositing an ink onto a substrate and annealing the substrate to form the perovskite film. The ink includes one or more 2D perovskite crystals; one or more group one cations or ammonium halides; one or more metal halides; and one or more solvents. A perovskite ink includes one or more 2D perovskite crystals, one or more group one cations or ammonium halides, one or more metal halides and one or more solvents.

### CROSS REFERENCE TO RELATED APPLICATIONS

This application claims benefit of U.S. Provisional Application No. 63/587,865, filed on Oct. 4, 2023. The content of this provisional application is hereby incorporated herein in its entirety.

### STATEMENT REGARDING FEDERALLY SPONSORED RESEARCH

This invention was made with government support under Grant No. DE-EE0008843, awarded by the Department of Energy. The government has certain rights in the invention.

### BACKGROUND

As the efficiencies of perovskite solar cells (PSCs) have surpassed the commercially available silicon solar cells, the next step moving forward is to obtain a perovskite material with a high inherent ambient, thermal, and light stability. The FAPbI₃ 3D perovskite has recently been a point of attraction due to its low band gap (1.48 eV) which is close to the Shockley-Queisser limit. However, the temperature-dependent polymorphic nature of FAPbI₃ 3D perovskite makes it undesirable to use in its pure form. As a result, different additives which include small organic cations (for example, cesium, rubidium, methylammonium,) bulkier cations (for example, phenyl ethyl ammonium, ethylenediaminetetraacetic acid,) and nanomaterials (for example, lead sulfide, cesium lead iodide) have mainly been used to stabilize the 3D FAPbI₃ perovskite. However, the use of these additives tends to lead to an increase in bandgap (1.53-1.55 eV) compared to the optimum bandgap (1.48 eV). In addition, it introduces multiple degradation pathways reducing the inherent material stability, and device stability. Accordingly, there exists a need for a perovskite composition with the least degradation pathways enhancing the overall material and device stability.

### SUMMARY

In one aspect, embodiments described herein relate to a method of forming a perovskite film including: depositing a ink onto a substrate and annealing the substrate to form the perovskite film. The ink includes one or more 2D perovskite crystals; one or more group one cations or ammonium halides; one or more metal halides; and one or more solvents. The annealing may include heating the substrate to a temperature ranging from room temperature to 200° C.

The group one cation or ammonium halide may be selected from the group consisting of a formamidinium halide, a cesium halide, a guanidinium halide, methyl ammonium halide and combinations thereof. The metal halide may be lead iodide.

The ink may include from 0.1 to 50 mol % of the 2D perovskite crystals.

The 2D perovskite crystals may include a perovskite having a formula A′Aₙ₋₁BₙX₃ₙ₊₁ or A′AₙBₙX₃ₙ₊₁, where A′ is a spacer cation, A is a monovalent cation, B is a divalent metal, n=1-7, and X is a halide. The spacer cation A′ may be selected from the group consisting of butylammonium, pentyl ammonium, hexyl ammonium, heptyl ammonium, phenyl ethyl ammonium, octyl ammonium, 4-aminomethyl piperidine, 3-aminomethyl piperidine, 3-(aminomethyl)pyridine, butyldiamine and combinations thereof.

The monovalent cation A may be selected from formamidinium, cesium (Cs), methyl ammonium and guanidinium. The halide X may be selected from iodide, bromide, chloride and combinations thereof. The divalent metal B may be lead, germanium, bismuth, copper, silver, gold, gallium, indium, antimony, tin, and combinations thereof. The 2D perovskite may be selected from the group consisting of BA₂PbI₄, and BA₂FAPb₂I₇. The perovskite film may include a material selected from perovskites with the following formula ABX₃, such as FAPbI₃.

The solvent may be a solvent that has a Donor Guttman number>10. The solvent may be selected from the group consisting of dimethylformamide, dimethyl sulfoxide and combinations thereof. The solvent may be a mixture of DMF and DMSO provided in a ratio ranging from 1:1 to 9:1 DMF:DMSO.

The methods may also be used to form an optoelectronic device. The optoelectronic device may include a solar cell. The solar cell may exhibit an efficiency of at least 23.5%.

Embodiments disclosed herein also relate to a perovskite ink that includes one or more 2D perovskite crystals; one or more group one cations or ammonium halides; one or more metal halides; and one or more solvents discussed above.

### BRIEF DESCRIPTION OF THE DRAWINGS

Specific embodiments of the disclosed technology will now be described in detail with reference to the accompanying figures. Like elements in the various figures are denoted by like reference numerals for consistency.

FIG. 1 is a schematic of a method for fabricating 3D stabilized perovskite films according to one or more embodiments.

FIG. 2A depicts the in-situ absorption measurements during annealing during the evolution of the α-FAPbI₃ 3D perovskite with an excess additive of n=1, 2D RP in accordance with Example 1.

FIG. 2B depicts the in-situ absorption measurements during annealing during the evolution of the control FAPbI₃ in accordance with Example 1.

FIG. 3 shows a comparison of GIXRD spectra for the 2D stabilized FAPbI₃ perovskite and control FAPbI₃, respectively, in accordance with Example 1.

FIG. 4 shows the correlation length, and micro strain extracted from the Halder-Wagner plot as a function of the concentration of the 2D perovskite used for stabilizing 3D FAPbI₃ perovskite in accordance with Example 1.

FIGS. 5A-5B depict the experimental log and corresponding time evolution of a WAXS diffraction pattern during thin-film formation of a 2D stabilized FAPbI₃ in accordance with Example 1.

FIG. 6 shows a plot comparing the degradation of control and 2D stabilized FAPbI₃ extracted by integrating the main perovskite peak (001) as a function of time in accordance with Example 1.

FIG. 7 shows shelf life stability of the thin films of 2D stabilized FAPbI₃ measured by monitoring the GIXRD over a period of 60 days under ambient conditions in accordance with Example 1.

FIG. 8 shows shelf life stability of the thin films of 2D stabilized FAPbI₃ measured by monitoring the absorption over a period of 60 days under ambient conditions in accordance with Example 1.

FIG. 9 shows the d(011) interplanar spacing for n=1 and FA-based n=2 2D perovskites with various A′ cations: PA, BA, OA, and PEA and the range of reported values for FAPbI₃ d(001) interplanar spacing in accordance with Example 1.

FIG. 10 is a schematic of the templated FAPbI₃ drop-coating method in accordance with Example 2.

FIG. 11 shows integrated peak areas for the (100)d (orange, left axis) and (001)3D (right axis) peaks over time for control FAPbI₃ (bottom), FAPbI₃ with 0.5 mol % PEA n=2 added (middle), and FAPbI₃ with 0.5 mol % BA n=2 added (top), in accordance with Example 3.

FIG. 12 shows azimuthally integrated WAXS patterns averaged across the first 90 s of annealing after reaching 150° C. for each FAPbI₃ additive tested (2D concentration is 1 mol %) in accordance with Example 4.

FIG. 13 shows the α-FAPbI₃ (001) lattice parameter for films with 1 mol % of each 2D additive, as measured on separately fabricated samples at RT in accordance with Example 4.

FIG. 14 shows a schematic diagram illustrating the mechanism of lattice matched 2D-templated FAPbI₃ perovskite formation in accordance with Example 4.

FIG. 15A shows a representative azimuthally integrated nano-XRD pattern for a film of BA₂FAPb₂I₇-templated FAPbI₃ after integrating several nano-XRD patterns obtained for different pixels within the testing region, in accordance with Example 5.

FIGS. 15B-C show a representative azimuthally integrated nano-XRD pattern for a film of BA₂FAPb₂I₇-templated FAPbI₃ for the (210) and the (211) peaks of BA₂FAPb₂I₇-templated FAPbI₃, respectively, after integrating several nano-XRD patterns obtained for different pixels within the testing region, in accordance with Example 5.

FIG. 16 shows a histogram of nano-XRD peak FWHM values for different pixels of a BA₂FAPb₂I₇-stabilized FAPbI₃ film (left) and a MACl-stabilized FAPbI₃ film (right), in accordance with Example 5.

FIG. 17 shows an absorption spectra of MACl-stabilized FAPbI₃ (bottom line) and BA₂FAPb₂I₇-stabilized FAPbI₃ (top line) with their bandgaps indicated, in accordance with Example 5.

FIG. 18 shows a photoluminescence (PL) spectra of MACl-stabilized FAPbI₃ (bottom line) and BA₂FAPb₂I₇-stabilized FAPbI₃ (top line), in accordance with Example 5.

FIG. 19 shows the time-resolved photoluminescence (TRPL) spectra of MACl-stabilized FAPbI₃ (bottom line) and BA₂FAPb₂I₇-stabilized FAPbI₃ (top line), in accordance with Example 5.

FIG. 20 shows a J-V curve of the champion device shows both a forward sweep (solid line) and reverse sweep (dashed line) in accordance with Example 6.

FIG. 21 shows the external quantum efficiency (EQE) of the champion 2D-stabilized FAPbI₃ device compared with the champion MACl-stabilized FAPbI₃ device, in accordance with Example 6.

FIG. 22 shows stability test data for an unencapsulated 2D FAPbI₃ (top) and MACl-FAPbI₃ (bottom) cell under 1-sun illumination at 60° C. with MPPT, in ambient air, in accordance with Example 6.

FIG. 23 shows stability test data for an encapsulated cell under 1-sun illumination at 60° C. with MPPT, in accordance with Example 6.

FIG. 24 shows stability test data for an encapsulated cell under 1-sun illumination at 85° C. with MPP tracking, in accordance with Example 6.

### DETAILED DESCRIPTION

Specific embodiments of the invention will now be described in detail with reference to the accompanying figures. In the following detailed description of embodiments, numerous specific details are set forth in order to provide a more thorough understanding of the invention. As used herein, “include” means “include, but is not limited to”.

In general, embodiments of this disclosure relate to a method of forming a perovskite material. The perovskite material may be in the form of a film coated on a surface including a conductive glass. The conductive glass may include a glass sheet further coated with a transparent conductive material, such as indium tin oxide, indium oxide, fluorine-doped tin oxide and aluminum zinc oxide. The method may include depositing an ink onto a substrate and annealing the substrate to form the perovskite material. The ink may include 2D perovskite crystals, one or more group one cations or ammonium halide, one or more metal halides, and one or more solvents. The ink provides 2D perovskite crystals that may be used as a template to form a 3D bulk phase that is lattice matched to the 2D perovskite.

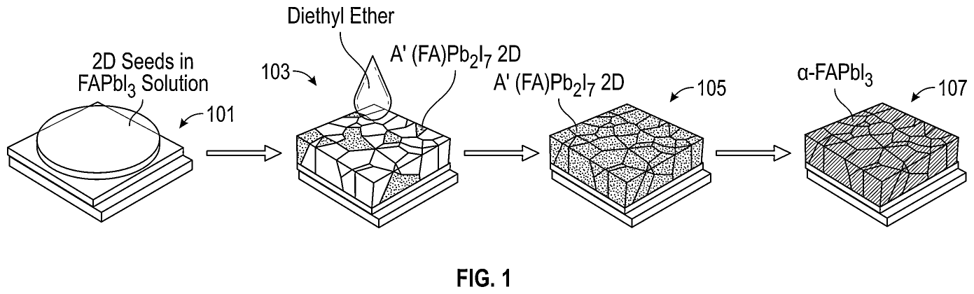

One embodiment of the method is described in FIG. 1. As shown in FIG. 1, 2D perovskite seed crystals may be combined in an ink including one or more group one cations or ammonium halide and one or more metal halides or pseudohalides 101 (exemplified as FAPbI₃). The ink may be deposited onto a surface to form a film. A solvent or combination or solvents, including diethyl ether, may be used to wash the resultant film to aid in crystallization 103 (so-called solvent annealing). The deposited film may undergo intermediate stages during annealing where the color of the film transforms according to their crystallographic structure, as will be explained in greater detail in subsequent sections. Before solvent annealing 103, the film may include 2D crystals and an undesirable 3D perovskite phase, such as hexagonal, as indicated in the unshaded portions in 103. After further annealing, such as thermal annealing 105, the film comprises a cubic or near-cubic alphα-phase 3D perovskite material, such as FAPbI₃ 107.

The ink may also be referred to as a precursor solution. While FIG. 1 depicts FAPbI₃ as the precursor solution, the methods described herein are not limited to FAPbI₃ and may therefore use other precursor solutions to ultimately stabilize the respective resulting perovskite film. More particularly, as noted above, the ink includes one or more group one cations or ammonium halides. Examples of the group one cations or ammonium halides include but are not limited to dimethyl ammonium halides, formamidinium (FA) halides, cesium halides, guanidinium halides, and combinations thereof. As used throughout the disclosure, the term “halide” refers to halides and pseudohalides. Halides include fluoride, chloride, bromide, and iodide. Pseudohalides include cyanide, cyaphide, isocyanide, hydroxide, hydrosulfide, hydroselenide, hydrotelluride, cyanate, isocyanate, fulminate, thiocyanate, isothiocyanate, selenocyalate, tellurocyanate, azide, nitroxide, tetracarbonylcobaltate, trinitromethanide, tricyanomethanide and auride.

The ink also includes one or more metal halides. The metal in the metal halide may be any suitable metal for the perovskite, and in some embodiments may be lead, germanium, bismuth, copper, silver, gold, gallium, indium, antimony, or tin. In one or more particular embodiments, the metal halide may be lead iodide. The halide is as previously described.

The group one cation or ammonium halide and the metal halide may be combined in a ratio ranging from 1:1.1 to 1.1:1. The concentration of the one or more group one cations or ammonium halides and the metal halides in the ink may be in the range of 0.1 to 5M, such as from a lower limit of any one of 0.1, 0.2, 0.5, 0.8 or 1.0 M to any upper limit of any of one 2, 3, 4 or 5M, where any lower limit may be mathematically paired with any upper limit. As a non-limiting example, if FAPbI₃ is a precursor in the precursor solution, it may have a concentration of 1.0 M in the solvent.

In one or more embodiments, the 2D perovskite seed crystal in the ink includes 2D perovskites having a general formula of A′AₓB_{y}X_{z} according to A′Aₙ₋₁BₙX₃ₙ₊₁, where A′ is a bulky monovalent or divalent cation, A is a smaller monovalent cation relative to A′, B is a divalent metal, λ is a monovalent anion, such as a halide or pseudo halide, and n is the number of octahedra in the quantum well, which may also be referred to as the layer thickness. Throughout the disclosure, it should be understood that the variables describing the stoichiometry of various components, such as “n” in the crystal structure recited in the aforementioned formulae, do not necessarily correspond to an exact whole number value. As will be appreciated by those skilled in the art, crystal systems can include elemental substitutions, vacancies, and other defects. Therefore, it should be understood that a reference to a whole number for a value such as n can include variations on the order of 0.1 to 10%. In one or more embodiments, n has a value in the range from 1 to 7, and may be 1, 2, 3, 4, 5, 6 or 7. In particular embodiments, n is less than or equal to 4. In one or more embodiments, a phase pure material is described by the above general formula for a single n value. Suitable 2D perovskites may be halide perovskites such as Ruddlesden-popper 2D perovskites, Dion-Jacobson 2D perovskites, Alternating Cation 2D perovskites, and combinations thereof, among others. The 2D perovskite crystals may be mono-crystalline, having a crystalline structure and a high phase purity (≥90%). For example, suitable 2D perovskites may include the compounds listed in Table 1.

TABLE 1

| | DJ | | | | |
|---|---|---|---|---|---|
| Space | or | | No. of | Spacer (interlayer) | Intralayer |
| group | RP | Compound | layers | cation, A′ | cation, A |
| Pbca | RP | [CH₃(CH₂)₃NH₃]₂PbI₄ | 1 | Butylammonium | — |
| Pbca | RP | [CH₃(CH₂)₃NH₃]₂SnI₄ | 1 | Butylammonium | — |
| Pnma | else | [CH₃(CH₂)₃NH₃]₂GeI₄ | 1 | Butylammonium | — |
| Pbca | RP | [CH₃(CH₂)₃NH₃]₂PbBr₄ | 1 | Butylammonium | — |
| Cmcm | RP | [CH₃(CH₂)₃NH₃]₂[CH₃NH₃]Pb₂I₇ | 2 | Butylammonium | Methyl- |
| (Cccm) | | | | | ammonium |
| Cmca | RP | [CH₃(CH₂)₃NH₃]₂[CH₃NH₃]₂Pb₃I₁₀ | 3 | Butylammonium | Methyl- |
| (Acam) | | | | | ammonium |
| Cmcm | RP | [CH₃(CH₂)₃NH₃]₂[CH₃NH₃]₃Pb₄I₁₃ | 4 | Butylammonium | Methyl- |
| (Acam) | | | | | ammonium |
| Ama2 | RP | [CH₃(CH₂)₃NH₃]₂[CH₃NH₃]Pb₂I₇ | 2 | Butylammonium | Methyl- |
| | | | | | ammonium |
| Cmca | RP | [CH₃(CH₂)₃NH₃]₂[CH₃NH₃]₄Pb₅I₁₆ | 5 | Butylammonium | Methyl- |
| (Acam) | | | | | ammonium |
| Aba2 | RP | [CH₃(CH₂)₃NH₃]₂[CH₃NH₃]₄Pb₅I₁₆ | 5 | Butylammonium | Methyl- |
| (C2cb) | | | | | ammonium |
| Cmc21 | else | [CH₃CH₂NH₃]₄Pb₃Cl₁₀ | 3 | Ethylammonium | — |
| Aba2 | RP | [CH₃CH₂NH₃]₄Pb₃Br₁₀ | 3 | Ethylammonium | — |
| (C2cb) | | | | | |
| Cmc21 | else | [CH₃CH₂NH₃]₄Pb₃Cl₁₀ | 3 | Ethylammonium | — |
| (A21ma) | | | | | |
| Pbca | else | [CH₃(CH₂)₃NH₃]₂PbI₄ | 1 | Butylammonium | — |
| Pbca | RP | [CH₃(CH₂)₃NH₃]₂PbI₄ | 1 | Butylammonium | — |
| P21/c | else | [CH₃(CH₂)₄NH₃]₂PbI₄ | 1 | Pentylammonium | — |
| (P21/a) | | | | | |
| P21/c | else | [CH₃(CH₂)₄NH₃]₂PbI₄ | 1 | Pentylammonium | — |
| (P21/a) | | | | | |
| Pbca | RP | [CH₃(CH₂)₄NH₃]₂PbI₄ | 1 | Pentylammonium | — |
| P21/c | else | [CH₃(CH₂)₅NH₃]₂PbI₄ | 1 | Hexylammonium | — |
| (P21/a) | | | | | |
| Pbca | RP | [CH₃(CH₂)₅NH₃]₂PbI₄ | 1 | Hexylammonium | — |
| P21/c | else | [CH₃(CH₂)₆NH₃]₂PbI₄ | 1 | Heptylammonium | — |
| (P21/a) | | | | | |
| Pbca | RP | [CH₃(CH₂)₆NH₃]₂PbI₄ | 1 | Heptylammonium | — |
| Pbca | RP | [CH₃(CH₂)₆NH₃]₂PbI₄ | 1 | Heptylammonium | — |
| P21/c | else | [CH₃(CH₂)₇NH₃]₂PbI₄ | 1 | Octylammonium | — |
| (P21/a) | | | | | |
| Pbca | RP | [CH₃(CH₂)₇NH₃]₂PbI₄ | 1 | Octylammonium | — |
| Cmca | RP | [CH₃(CH₂)₈NH₃]₂PbI₄ | 1 | Nonylammonium | — |
| (Acam) | | | | | |
| P21/c | else | [CH₃(CH₂)₈NH₃]₂PbI₄ | 1 | Nonylammonium | — |
| (P21/a) | | | | | |
| Pbca | RP | [CH₃(CH₂)₈NH₃]₂PbI₄ | 1 | Nonylammonium | — |
| P21/c | else | [CH₃(CH₂)₈NH₃]₂PbI₄ | 1 | Decylammonium | — |
| (P21/a) | | | | | |
| Pbca | RP | [CH₃(CH₂)₉NH₃]₂PbI₄ | 1 | Decylammonium | — |
| Pbca | RP | [CH₃(CH₂)₉NH₃]₂PbI₄ | 1 | Decylammonium | — |
| Pbca | RP | [CH₃(CH₂)₉NH₃]₂PbI₄ | 1 | Decylammonium | — |
| Pbca | RP | [CH₃(CH₂)₉NH₃]₂PbI₄ | 1 | Decylammonium | — |
| Pbca | RP | [CH₃(CH₂)₉NH₃]₂PbI₄ | 1 | Decylammonium | — |
| P21/c | else | [NH₃(CH₂)₆NH₃]PbI₄ | 1 | 1,6-hexanediammonium | — |
| P21/c | else | [NH₃(CH₂)₆NH₃]PbBr₄ | 1 | 1,6-hexanediammonium | — |
| P21/c | else | [NH₃(CH₂)₆NH₃]PbI₄ | 1 | 1,6-hexanediammonium | — |
| P21/c | else | [NH₃(CH₂)₈NH₃]PbI₄ | 1 | 1,8-octanediammonium | — |
| P21/c | DJ | [NH₃(CH₂)₁₂NH₃]PbI₄ | 1 | 1,12-dodecanediammonium | — |
| P-1 | else | [NH₃(CH₂)₄NH₃]PbBr₄ | 1 | 1,4-butyldiamine | — |
| C2/c | else | [NH₃(CH₂)₄NH₃]PbI₄ | 1 | 1,4-butyldiamine | — |
| P21/c | else | [NH₃(CH₂)₈NH₃]PbI₄ | 1 | 1,8-octanediammonium | — |
| P21/c | else | [NH₃(CH₂)₁₀NH₃]PbBr₄ | 1 | 1,10-decanediammonium | — |
| P21/c | DJ | [NH₃(CH₂)₁₂NH₃]PbI₄ | 1 | 1,12-dodecanediammonium | — |
| P21/c | DJ | [NH₃C₁₀H₆NH₃]PbI₄ | 1 | Naphthalene-1,5-diamine | — |
| Cc | RP | [NH₃(CH₂)₈NH₃][CH₃NH₃]Pb₂I₇ | 2 | 1,8-octanediammonium | Methyl- |
| | | | | | ammonium |
| Pc | RP | [NH₃(CH₂)₈NH₃][CH₃NH₃]₂Pb₃I₁₀ | 3 | 1,8-octanediammonium | Methyl- |
| | | | | | ammonium |
| Cc | RP | [NH₃(CH₂)₈NH₃][CH₃NH₃]₃Pb₄I₁₄ | 4 | 1,8-octanediammonium | Methyl- |
| | | | | | ammonium |
| Cc | else | [NH₃(CH₂)₉NH₃]PbI₄ | 1 | 1,9-nonanediammonium | — |
| Cc | RP | [NH₃(CH₂)₉NH₃][CH₃NH₃]Pb₂I₇ | 2 | 1,9-nonanediammonium | Methyl- |
| | | | | | ammonium |
| Pc | RP | [NH₃(CH)₉NH₃][CH₃NH₃]₂Pb₃I₁₀ | 3 | 1,9-nonanediammonium | Methyl- |
| | | | | | ammonium |
| Pbca | RP | [CH₃(CH₂)₃NH₃]₂PbBr₄ | 1 | Butylammonium | — |
| Pbca | RP | [CH₃(CH₂)₃NH₃]₂SnI₄ | 1 | Butylammonium | — |
| P21/c | else | [NH₃(CH₂)₃NH₂CH₃]PbBr₄ | 1 | N1-methylpropane-1,3- | — |
| | | | | diammonium | |
| Imma | else | [C(NH₂)₃][CH₃NH₃]₃Pb₃I₁₀ | 3 | Guanidinium | Methyl- |
| | | | | | ammonium |
| Amma | else | [C(NH₂)₃][CH₃NH₃]₂Pb₂I₇ | 2 | Guanidinium | Methyl- |
| | | | | | ammonium |
| Imma | else | [C(NH₂)₃][CH₃NH₃]PbI₄ | 1 | Guanidinium, | — |
| | | | | Methylammonium | |
| C2 | else | [NH₃(CH₂)₂O(CH₂)₂O(CH₂)₂NH₃]PbCl₄ | 1 | 1,8-Diamino-3,6-dioxaoctane | — |
| P21/c | else | [NH₃(CH₂)₂O(CH₂)₂O(CH₂)₂NH₃]PbBr₄ | 1 | 1,8-Diamino-3,6-dioxaoctane | — |
| P21/c | else | [NH₃(CH₂)₂O(CH₂)₂O(CH₂)₂NH₃]PbI₄ | 1 | 1,8-Diamino-3,6-dioxaoctane | — |
| P21/c | DJ | [NH₃(CH₂)₂SC(NH₂)NH₃]PbBr₄ | 1 | 2-(aminoethyl)-isothiourea | — |
| | | | | protonated | |
| P21/c | else | [CHC(CH₂)₂NH₃]₂PbBr₄ | 1 | 4-amino-1-butyne | — |
| | | | | protonated | |
| P-1 | else | [ICHC(I)(CH₂)₂NH₃]₂PbBr₄ | 1 | 4-amino-1,2-diiodo-1- | — |
| | | | | butene protonated | |
| P21/c | else | [CH₂CH(CH₂)₂NH₃]₂PbBr₄ | 1 | 4-aminobutylene | — |
| | | | | protonated | |
| Pnma | else | [F(CH₂)₂NH₃]₂PbCl₄ | 1 | 2-fluoroethylammonium | — |
| P21/c | — | [(CH₃)₂CHCH₂NH₃]₂[PbBr₄] | 1 | Isobutylammonium | — |
| Cmca | RP | [(CH₃)₂CHCH₂NH₃]₂[PbBr₄] | 1 | Isobutylammonium | — |
| P21/c | else | [HO(CH₂)₂NH₃]₂PbI₄ | 1 | Ethanolammonium | — |
| P21/c | else | [HO(CH₂)₃NH₃]₂PbI₄ | 1 | 3-aminopropanol protonated | — |
| P21/c | else | [I(CH₂)₂NH₃]₂PbI₄ | 1 | 2-iodoethylammonium | — |
| P21/c | else | [I(CH₂)₃NH₃]₂PbI₄ | 1 | 3-iodopropylammonium | — |
| P21/c | else | [I(CH₂)₄NH₃]₂PbI₄ | 1 | 4-iodobutylammonium | — |
| P21/c | DJ | [I(CH₂)₅NH₃]₂PbI₄ | 1 | 5-iodopentylammonium | — |
| Pbca | RP | [I(CH₂)₆NH₃]₂PbI₄ | 1 | 6-iodohexylammonium | — |
| Pnma | else | [Br(CH₂)₂NH₃]₂PbI₄ | 1 | 2-bromoethylammonium | — |
| P21/c | else | [NH₃(CH₂)₂SS(CH₂)₂NH₃]₂Pb₂I₈ | 1 | 2,2′-dithiobisethanammonium | — |
| P21/c | RP | [C₃H₅NH₃]₂PbI₄ | 1 | Cyclopropylammonium | — |
| P21/c | else | [C₃H₅NH₃]₂PbBr₄ | 1 | Cyclopropylammonium | — |
| P21/c | else | [C₄H₇NH₃]₂PbBr₄ | 1 | Cyclobutylammonium | — |
| P21/c | else | [C₅H₉NH₃]₂PbBr₄ | 1 | Cyclopentylammonium | — |
| Cmc21 | else | [C₆H₁₁NH₃]₂PbBr₄ | 1 | Cyclohexylammonium | — |
| P21/c | else | [C₃H₅NH₃]₂PbCl₄ | 1 | Cyclopropylammonium | — |
| P21/c | else | [C₄H₇NH₃]₂PbCl₄ | 1 | Cyclobutylammonium | — |
| Cmca | else | [C₅H₉NH₃]₂PbCl₄ | 1 | Cyclopentylammonium | — |
| P21/m | else | [C₆H₁₁NH₃]₄Pb₂Cl₈ | 1 | Cyclohexylammonium | — |
| P21/c | else | [C₆H₁₀CH₂NH₃]₂PbBr₄ | 1 | Cyclohexylmethylammonium | — |
| P21/c | else | [NH₂(C₂H₄)₂NH₂]PbCl₄ | 1 | Piperazinium | — |
| P21/c | else | [C₅H₁₁NCH₂NH₃]PbI₄ | 1 | 3-(aminomethyl)-piperidinium | — |
| Cc | DJ | [C₅H₁₁NCH₂NH₃][CH₃NH₃]Pb₂I₇ | 2 | 3-(aminomethyl)-piperidinium | Methyl- |
| | | | | | ammonium |
| Pc | DJ | [C₅H₁₁NCH₂NH₃][CH₃NH₃]₂Pb₃I₁₀ | 3 | 3-(aminomethyl)-piperidinium | Methyl- |
| | | | | | ammonium |
| Cc | DJ | [C₅H₁₁NCH₂NH₃][CH₃NH₃]₃Pb₄I₁₃ | 4 | 3-(aminomethyl)-piperidinium | Methyl- |
| | | | | | ammonium |
| Pc | DJ | [C₅H₁₁NCH₂NH₃]PbI₄ | 1 | 4-(aminomethyl)-piperidinium | — |
| Cc | DJ | [C₅H₁₁NCH₂NH₃][CH₃NH₃]Pb₂I₇ | 2 | 4-(aminomethyl)-piperidinium | Methyl- |
| | | | | | ammonium |
| P1 | DJ | [C₅H₁₁NCH₂NH₃][CH₃NH₃]₂Pb₃I₁₀ | 3 | 4-(aminomethyl)-piperidinium | Methyl- |
| | | | | | ammonium |
| Cc | DJ | [C₅H₁₁NCH₂NH₃][CH₃NH₃]₃Pb₄I₁₃ | 4 | 4-(aminomethyl)-piperidinium | Methyl- |
| | | | | | ammonium |
| Pbca | RP | [(C₆H₁₁)PH₃]₂SnI₄ | 1 | Cyclohexylphosphonium | — |
| P21/c | else | [NH₃CH₂C₆H₁₀CH₂NH₃]PbI₄ | 1 | 4,4′-bipyridine | — |
| Cmc21 | else | [C₆H₅CH₂NH₃]PbCl₄ | 1 | Phenylmethylammonium | — |
| Cmc21 | else | [C₆H₅CH₂NH₃]PbCl₄ | 1 | Phenylmethylammonium | — |
| Cmc21 | else | [C₆H₅CH₂NH₃]PbCl₄ | 1 | Phenylmethylammonium | — |
| Cmc21 | else | [C₆H₅CH₂NH₃]PbCl₄ | 1 | Phenylmethylammonium | — |
| Cmc21 | else | [C₆H₅CH₂NH₃]PbCl₄ | 1 | Phenylmethylammonium | — |
| Cmca | RP | [C₆H₅CH₂NH₃]PbCl₄ | 1 | Phenylmethylammonium | — |
| Cmc21 | else | [C₆H₅CH₂NH₃]PbCl₄ | 1 | Phenylmethylammonium | — |
| Cmca | RP | [C₆H₅CH₂NH₃]PbBr₄ | 1 | Phenylmethylammonium | — |
| Cmca | RP | [C₆H₅CH₂NH₃]PbBr₄ | 1 | Phenylmethylammonium | — |
| Cmca | RP | [C₆H₅CH₂NH₃]PbBr₄ | 1 | Phenylmethylammonium | — |
| Cmca | RP | [C₆H₅CH₂NH₃]PbBr₄ | 1 | Phenylmethylammonium | — |
| Cmc21 | else | [C₆H₅CH₂NH₃]₂PbCl₄ | 1 | Phenylmethylammonium | — |
| Pbca | else | [C₆H₅CH₂NH₃]₂PbI₄ | 1 | Phenylmethylammonium | — |
| Cc | else | [C₄H₃S(CH₂)₂NH₃]₂PbI₄ | 1 | 2-(2-thienyl)-ethanaminium | — |
| P21/c | else | [C₃H₄N₂(CH₂)₂NH₃]PbI₄ | 1 | Histammonium | — |
| P21/c | else | [C₃H₄N₂(CH₂)₂NH₃]SnI₄ | 1 | Histammonium | — |
| Pbca | else | [C₆H₅CH₂NH₃]₂PbI₄ | 1 | Phenylmethylammonium | — |
| Pbca | RP | [C₆H₅CH₂NH₃]₂SnI₄ | 1 | Phenylmethylammonium | — |
| Aba2 | RP | [C₄H₃SCH₂NH₃]₂[CH₃NH₃]Pb₂I₇ | 2 | 2-(2-thienyl)-methylaminium | Methyl- |
| | | | | | ammonium |
| Pbca | RP | [C₄H₃SCH₂NH₃]₂PbI₄ | 1 | 2-(2-thienyl)-methylaminium | — |
| Pbca | else | [CH₁₁NCH₂NH₃]PbBr₄ | 1 | 2-(aminomethyl)-piperidinium | — |
| P21/c | else | [BrC₆H₄(CH₂)₂NH₃]₂SnI₄ | 1 | 2-bromophenylethyl- | — |
| | | | | ammonium | |
| P21/c | else | [(CH₃)₂NHC₆H₄NH₃]PbCl₄ | 1 | N,N-Dimethylbenzene- | — |
| | | | | 1,4-diammonium | |
| P2/c | else | [NH₃C₆H₄NH₃]PbCl₄ | 1 | m-phenylenediammonium | — |
| P21/c | else | [(CH₃)₂NHC₆H₄NH₃]PbBr₄ | 1 | N,N-Dimethylbenzene- | — |
| | | | | 1,4-diammonium | |
| C2/c | else | [NH₂C(NH₂)CH₄NH]PbBr₄ | 1 | 3-amidinopyridinium | — |
| Cmc21 | RP | [C₆H₅CH₂NH₃]₂PbBr₄ | 1 | Phenylmethylammonium | — |
| P-1 | else | [C₆H₅(CH₂)₂NH₃]₂PbI₄ | 1 | Phenylethylammonium | — |
| Cmc21 | else | [C₁₀H₇CH₂NH₃]₂PbBr₄ | 1 | 1-(2-naphthyl)- | — |
| | | | | methanammonium | |
| Pc | else | [C₁₀H₇(CH₂)₂NH₃]₂PbI₄₄ | 1 | 2-(2-naphthyl)- | — |
| | | | | ethanammonium | — |
| P1 | else | [C₁₀H₇(CH₂)₂NH₃]₂PbBr₄ | 1 | 2-(2-naphthyl)- | — |
| | | | | ethanammonium | |
| C2/c | else | [C₇H₇N₂]₂PbI₄ | 1 | Benzimidazolium | — |
| C2/c | else | [C₇H₇N₂]₂PbCl₄ | 1 | Benzimidazolium | — |
| C2/c | else | [C₇H₇N₂]₂PbBr₄ | 1 | Benzimidazolium | — |
| Cc | else | [C₁₀H₇₀O(CH₂)₂NH₃]₂PbI₄ | 1 | Naphthalene-O- | — |
| | | | | ethylammonium | |
| P21/c | else | [C₁₀H₇₀O(CH₂)₃NH₃]₂PbI₄ | 1 | Naphthalene-O- | — |
| | | | | propylammonium | |
| P-1 | else | [C₁₀H₇₀O(CH₂)₃NH₃]₂PbI₄*0.5(C₄H₆O₂) | 1 | Naphthalene-O- | — |
| | | | | ethylammonium | |
| Cc | else | [C₁₆H₉O(CH₂)₂NH₃]₂PbI₄ | 1 | Pyrene-O- | — |
| | | | | ethylammonium | |
| Cc | else | [C₁₆H₉O(CH₂)₃NH₃]₂PbI₄ | 1 | Pyrene-O- | — |
| | | | | propylammonium | |
| C2/c | else | [C₁₆H₉O(CH₂)₄NH₃]₂PbI₄ | 1 | Pyrene-O- | — |
| | | | | butylammonium | |
| P21/c | else | [C₂₀H₁₁O(CH₂)₂NH₃]₂PbI₄ | 1 | Perylene-O- | — |
| | | | | ethylammonium | |
| P-1 | else | [NH₃(CH₂)₂S(C₄H₃S)₂S(CH₂)₂NH₃]PbI₄ | 1 | 5-ammonium- | — |
| | | | | ethylsulfanyl-2,2′-bithiophene | |
| P21/c | else | [FC₆H₅CH₂NH₃]₂PbI₄ | 1 | 4-fluorophenyl- | — |
| | | | | methylammonium | |
| P21/c | else | [C₃H₃N₂(CH₂)₃NH₃]PbBr₄ | 1 | N-(3-aminopropyl)- | — |
| | | | | imidazole | |
| C2/c | else | [C₇H₇N₂]₂SnI₄ | 1 | Benzimidazolium | — |
| P21 | else | [ClC₆H₅CH₂NH₃]₂PbI₄ | 1 | 4-chlorophenylmethyl- | — |
| | | | | ammonium | |
| P-1 | else | [C₆H₅(CH₂)₂NH₃]₂PbBr₄ | 1 | Phenylethylammonium | — |
| Pc | DJ | [C₅H₁₁NCH₂NH₃][CH₃NH₃]₆Pb₇I₂₂ | 7 | 4-(aminomethyl)- | Methyl- |
| | | | | piperidinium | ammonium |
| Ama2 | RP | [CH₃(CH₂)₃NH₃]₂[CH₃NH₃]₅Pb₆I₁₉ | 6 | Butylammonium | Methyl- |
| | | | | | ammonium |
| Aba2 | RP | [CH₃(CH₂)₃NH₃]₂[CH₃NH₃]₆Pb₇I₂₂ | 7 | Butylammonium | Methyl- |
| | | | | | ammonium |
| P-1 | else | [FC₆H₄(CH₂)₂NH₃]₂PbI₄ | 1 | 2-fluorophenylethyl- | — |
| | | | | ammonium | |
| C2/c | else | [FC₆H₄(CH₂)₂NH₃]₂PbI₄ | 1 | 3-fluorophenylethyl- | — |
| | | | | ammonium | |
| C2/c | else | [FC₆H₄(CH₂)₂NH₃]₂[CH₃NH₃]Pb₂I₇ | 2 | 4-fluorophenylethyl- | Methyl- |
| | | | | ammonium | ammonium |
| P21 | else | [BrC₆H₅CH₂NH₃]₂PbI₄ | 1 | 4-bromophenylmethyl- | — |
| | | | | ammonium | |
| P21/c | else | [IC₆H₅CH₂NH₃]₂PbI₄ | 1 | 4-iodophenylmethyl- | — |
| | | | | ammonium | |
| Cmmm | — | Cs₂[C(NH₂)3]Pb₂Br₇ | 2 | Guanidinium, | — |
| | | | | Caesium | |
| Imma | — | Cs[C(NH₂)3]PbBr₄ | 1 | Guanidinium, | — |
| | | | | Caesium | |
| Pnnm | — | Cs[C(NH₂)3]PbI₄ | 1 | Guanidinium, | — |
| | | | | Caesium | |
| Pnnm | — | Cs[C(NH₂)3]PbI₄ | 1 | Guanidinium, | — |
| | | | | Caesium | |
| P21/c | else | [FC₆H₄(CH₂)₂NH₃]₂PbI₄ | 1 | 4-fluorophenylethyl- | — |
| | | | | ammonium | |
| P1 | else | [FC₆H₄(CH₂)₂NH₃]₂PbI₄ | 1 | 2-fluorophenylethyl- | — |
| | | | | ammonium | |
| P1 | else | [FC₆H₄(CH₂)₂NH₃]₂PbI₄ | 1 | 3-fluorophenylethyl- | — |
| | | | | ammonium | |
| P21/c | else | [FC₆H₄(CH₂)₂NH₃]₂[CH₃NH₃]₂Pb₃I₁₀ | 3 | 4-fluorophenylethyl- | Methyl- |
| | | | | ammonium | ammonium |
| P21/c | else | [FC₆H₄(CH₂)₂NH₃]₂[CH₃NH₃₂]₂Pb₃I₁₀ | 3 | 4-fluorophenylethyl- | Methyl- |
| | | | | ammonium | ammonium |
| P21/c | else | [FC₆H₄(CH₂)₂NH₃]₂PbI₄ | 1 | 4-fluorophenylethyl- | — |
| | | | | ammonium | |
| Pmna | DJ | [C(NH₂)₃]₂SnI₄ | 1 | Guanidinium | — |
| Pnnm | DJ | [C(NH₂)₃]₂SnI₄ | 1 | Guanidinium | |
| P21/c | else | [C(NH₂)₃]₂SnI₄ | 1 | Guanidinium | — |
| P-1 | else | [C(NH₂)₃]₂SnI₄ | 1 | Guanidinium | — |
| Pmna | DJ | [C(NH₂)₃]₂PbI₄ | 1 | Guanidinium | — |
| Pnnm | DJ | [C(NH₂)₃]₂PbI₄ | 1 | Guanidinium | — |
| P21/c | else | [C(NH₂)₃]₂PbI₄ | 1 | Guanidinium | — |
| P-1 | else | [C₃H₅N₂][C(NH₂)₃]PbBr₄ | 1 | Imidazolium, | — |
| | | | | Guanidinium | |
| P21/c | else | [C₂H₄N₃][C(NH₂)₃]PbBr₄ | 1 | 1,2,4-triazolium, | — |
| | | | | Guanidinium | |
| P2/c | — | [C₂H₄N₃][C(NH₂)₃]PbBr₄ | 1 | 1,2,4-triazolium, | — |
| | | | | Guanidinium | |
| P-1 | else | [C₃H₅N₂][C(NH₂)₃]PbBr₄ | 1 | Imidazolium, | — |
| | | | | Guanidinium | |
| Cmcm | RP | [CH₃(CH₂)₄NH₃]₂[CH₃NH₃]Pb₂I₇ | 2 | Pentylammonium | Methyl- |
| | | | | | ammonium |
| C2/c | else | [CH₃(CH₂)₄NH₃]₂[CH₃NH₃]Pb₂I₇ | 2 | Pentylammonium | Methyl- |
| | | | | | ammonium |
| Cmcm | RP | [CH₃(CH₂)₃NH₃]₂[CH₃NH₃]Pb₂I₇ | 2 | Butylammonium | Methyl- |
| | | | | | ammonium |
| P-1 | else | [CH₃(CH₂)₃NH₃]₂[CH₃NH₃]Pb₂I₇ | 2 | Butylammonium | Methyl- |
| | | | | | ammonium |
| P21/m | else | [CH₃(CH₂)₄NH₃]₂[CH₃NH₃]Pb₂I₇ | 2 | Pentylammonium | Methyl- |
| | | | | | ammonium |
| Cmca | RP | [CH₃(CH₂)₃NH₃]₂[CH₃NH₃]₂Pb₃I₁₀ | 3 | Butylammonium | Methyl- |
| | | | | | ammonium |
| P-1 | else | [CH₃(CH₂)₃NH₃]₂[CH₃NH₃]₂Pb₃I₁₀ | 3 | Butylammonium | Methyl- |
| | | | | | ammonium |
| Cmcm | RP | [CH₃(CH₂)₃NH₃]₂[CH₃NH₃]₃Pb₄I₁₃ | 4 | Butylammonium | Methyl- |
| | | | | | ammonium |
| P-1 | else | [CH₃(CH₂)₃NH₃]₂[CH₃NH₃]₃Pb₄I₁₃ | 4 | Butylammonium | Methyl- |
| | | | | | ammonium |
| Cmcm | RP | [CH₃(CH₂)₅NH₃]₂[CH₃NH₃]Pb₂I₇ | 2 | Hexylammonium | Methyl- |
| | | | | | ammonium |
| C2/c | else | [CH₃(CH₂)₅NH₃]₂[CH₃NH₃]Pb₂I₇ | 2 | Hexylammonium | Methyl- |
| | | | | | ammonium |
| Cmcm | RP | [CH₃(CH₂)₃NH₃]₂[HC(NH₂)₂]Pb₂I₇ | 2 | Butylammonium | Forma- |
| | | | | | midinium |
| P-1 | else | [CH₃(CH₂)₃NH₃]₂[HC(NH₂)₂]Pb₂I₇ | 2 | Butylammonium | Forma- |
| | | | | | midinium |
| P-1 | else | [CH₃NHNH₃]₂PbI₄ | 1 | Methylhydrazinium | — |
| Pccn | else | [CH₃NHNH₃]₂PbI₄ | 1 | Methylhydrazinium | — |
| Pmmn | else | [CH₃NHNH₃]₂PbI₄ | 1 | Methylhydrazinium | — |
| Pmmn | else | [CH₃NHNH₃]₂PbI₄ | 1 | Methylhydrazinium | — |
| P21/c | else | [CH₃(CH₂)₃CH(C₂H₅)CH₂NH₃]₂PbI₄ | 1 | 2-ethyl-hexylammonium | — |
| P21/c | else | [CH₃(CH₂)₄CH(CH₃)NH₃]₂PbI₄ | 1 | 1-methyl- | — |
| | | | | hexylammonium | |
| P21/c | else | [(C₅H₈)NH₃]PbI₄ | 1 | 1-methyl- | — |
| | | | | butylammonium | |
| P42/ncm | RP | [CH₃CH₂CH(CH₃)NH₃]₂PbI₄ | 1 | 1-methyl- | — |
| | | | | propylammonium | |
| P21 | else | [ClC₆H₅CH₂NH₃]₂PbI₄ | 1 | 4-chlorophenylmethyl- | — |
| | | | | ammonium | |
| Cmc21 | else | [C₆H₁₁NH₃]PbBr₄ | 1 | Cyclohexylammonium | — |
| Cmca | RP | [HOOCC₆H₁₀CH₂NH₃]SnI₄ | 1 | | — |
| P21/c | else | [I(CH₂)₃NH₃]₂SnI₄ | 1 | 3-iodopropylammonium | — |
| (P21/a) | | | | | |
| Pbca | RP | [HOOC(CH₂)₃NH₃]₂SnI₄ | 1 | γ-Aminobutyric acid protonated | — |
| P21/c | else | [C₅H₁₁N(CH₂)₂NH₃]SnI₄ | 1 | 1-(aminoethyl)- | — |
| | | | | piperidinium | |
| Pnma | DJ | [IC₅H₅N]₂SnI₄ | 1 | 3-iodopyridine | — |
| C2/c | else | [NH₃(CH₂)₅NH₃]SnI₄ | 1 | 1,5-pentyldiammonium | |
| C2/m | else | [C₆H₅(CH₂)₂NH₃]₂SnI₄ | 1 | Phenylethylammonium | — |
| C2/m | else | [ClC₆H₄(CH₂)₂NH₃]₂SnI₄ | 1 | 2-chlorophenylethyl- | — |
| | | | | ammonium | |
| P-1 | DJ | [F₂C₇H₇N₂]₂SnI₄ | 1 | 5,6-difluorobenzimidazolium | — |
| Pbca | RP | [CH₃(CH₂)₁₁NH₃]₂PbI₄ | 1 | n-dodecylammonium | — |
| P1 | else | [(_{2,3}-C₄H₄S(CH₃)-_{2,5}-C₄H₄S)₂(CH₂)₂NH₃]₂SnI₄ | 1 | 2-(3′′′,4′-dimethyl- | — |
| | | | | [2,2′:5′,2″:5″,2′′′- | |
| | | | | quaterthiophen]-5-yl)ethan- | |
| | | | | 1-ammonium | |
| P-1 | else | [C₆H₅(CH₂)₂NH₃]₂SnI₄ | 1 | Phenylethylammonium | — |
| Cmca | DJ | [(CH₃)₃N(CH₂)₂NH₃]SnI₄ | 1 | 2-trimethylammonium- | — |
| | | | | ethylammonium | |
| C2/c | else | [(C₃H₆N₂)₂]PbI₄ | 1 | 2,2′-biimidazolium | — |
| C2/c | else | [(C₃H₆N₂)₂]SnI₄ | 1 | 2,2′-biimidazolium | — |
| Pbca | else | [CH₃(CH₂)₃NH₃]₂SnI₄ | 1 | Butylammonium | — |
| C2/c | else | [C₆F₅(CH₂)₂NH₃][C₁₀H₇(CH₂)₂NH₃]SnI₄ | 1 | 2,3,4,5,6-pentafluorophenethyl- | — |
| | | | | ammonium, | |
| | | | | 2-naphthyleneethyl- | |
| | | | | ammonium | |
| C2/c | else | [FC₆H₄(CH₂)₂NH₃]₂SnI₄ | 1 | 2-fluorophenylethyl- | — |
| | | | | ammonium | |
| C2/c | else | [FC₆H₄(CH₂)₂NH₃]₂SnI₄ | 1 | 3-fluorophenylethyl- | — |
| | | | | ammonium | |
| P21c | else | [FC₆H₄(CH₂)₂NH₃]₂SnI₄ | 1 | 4-fluorophenylethyl- | — |
| | | | | ammonium | |
| Cmca | RP | [CH₃(CH₂)₃NH₃]₂[CH₃NH₃]₂Sn₃I₁₀ | 3 | Butylammonium | Methyl- |
| | | | | | ammonium |
| P42 cm | RP | [(CH₃)₂CHNH₃]₃Sn₂I₇ | 2 | isopropylammonium | — |
| Ama2 | RP | (CH₃(CH₂)₃NH₃)₂(CH₃NH₃)Sn₂I₇ | 2 | Butylammonium, | — |
| | | | | Methylammonium | |
| P-1 | else | [C₆H₅(CH₂)₂NH₃]₂GeI₄ | 1 | Phenylethylammonium | — |
| Pbca | else | [CH₃(CH₂)₃NH₃]₂SnI₄ | 1 | Butylammonium | — |
| P21/c | else | [HO(CH₂)₂NH₃]₂SnI₄ | 1 | 2-hydroxyethyl- | — |
| | | | | ammonium | |
| Pmna | else | [HO(CH₂)₂NH₃]₂SnI₄ | 1 | 2-hydroxyethyl- | — |
| | | | | ammonium | |
| P21/c | else | [HO(CH₂)₂NH₃]₂PbI₄ | 1 | 2-hydroxyethyl- | — |
| | | | | ammonium | |
| Pbcn | else | [HO(CH₂)₂NH₃]₂PbBr₄ | 1 | 2-hydroxyethyl- | — |
| | | | | ammonium | |
| Imma | — | Cs[C(NH₂)₃]SnBr₄ | 1 | Caesium, Guanidinium | — |
| Cmmm | — | Cs₂[C(NH₂)₃]Sn₂Br₇ | 2 | Caesium, Guanidinium | Cs |
| C2/m | else | [C₈H₈N₄]SnI₄ | 1 | Benzodiimidazolium | — |
| C2/m | else | [C₈H₈N₄]PbI₄ | 1 | Benzodiimidazolium | — |
| Cmc21 | RP | [CH₃(CH₂)₃NH₃]₂ | 3 | Butylammonium | Methyl- |
| | | [CH₃NH₃]₂Sn₃Br₁₀ | | | ammonium |
| Cmca | RP | [CH₃(CH₂)₃NH₃]₂ | 3 | Butylammonium | Methyl- |
| | | [CH₃NH₃]₂Sn3Br₁₀ | | | ammonium |
| I4/m | RP | [CH₃(CH₂)₃NH₃]₂ | 3 | Butylammonium | Methyl- |
| | | [CH₃NH₃]₂Sn₃Br₁₀ | | | ammonium |
| Cmc21 | else | [CH₃(CH₂)₃NH₃]₂ | 3 | Butylammonium | Methyl- |
| | | [CH₃NH₃]₂Sn₃Br₁₀ | | | ammonium |
| Cmca | RP | [CH₃(CH₂)₃NH₃]₂ | 3 | Butylammonium | Methyl- |
| | | [CH₃NH₃]₂Sn₃Br₁₀ | | | ammonium |
| C/2c | else | [C₆H₅(CH₂)₂NH₃]₂SnI₄*C₆H₆ | 1 | Phenylethylammonium | — |
| C/2c | else | [C₆H₅(CH₂)₂NH₃]₂SnI₄*C₆F₆ | 1 | Phenylethylammonium | — |
| C2/m | else | [NH₃(CH₂)₂(C₄H₄S)₄(CH₂)₂NH₃]Bi_{2/3}I₄ | 1 | 5,5′′′-bis-(aminoethyl)- | — |
| | | | | 2,2′:5′,2″:5″,2′′′-quaterthiophene | |
| C2/c | else | [NH₃(CH₂)₂(C₄H₄S)4(CH₂)₂NH₃]Bi_{2/3}I₄ | 1 | 5,5′′′-bis-(aminoethyl)- | — |
| | | | | 2,2′:5′,2″:5″,2′′′-quaterthiophene | |
| Cmc21 | RP | [C₆H₅CH₂NH₃]₂SnCl₄ | 1 | Phenylmethylammonium | — |
| Cmc21 | RP | [C₆H₅CH₂NH₃]₂SnBr₄ | 1 | Phenylmethylammonium | — |
| Pbca | RP | [C₆H₅CH₂NH₃]₂SnI₄ | 1 | Phenylmethylammonium | — |
| P21/c | else | [C₆H₁₁CH₃NH₃]₂SnI₄ | 1 | Cyclohexylmethylammonium | — |
| Cmca | RP | [C₆H₁₁CH₃NH₃]₂SnI₄ | 1 | Cyclohexylmethylammonium | — |
| P1 | else | [C₆H₅(CH₂)₂NH₃]₂[CH₃NH₃]₂Pb₃I₁₀ | 3 | Phenylethylammonium | — |
| P21/c | else | [C₃H₄N₂(CH₂)₂NH₃]PbI₄ | 1 | Histammonium | — |
| Pbca | else | [C₆H₅CH₂NH₃]PbI₄ | 1 | Phenylmethylammonium | — |
| P21/c | else | [I(CH₂)₂NH₃]₂PbI₄ | 1 | 2-iodoethylammonium | — |
| (P21/a) | | | | | |
| C2/c | else | [Br(CH₂)₂NH₃]₂PbI₄ | 1 | 2-bromoethylammonium | — |
| Pnma | else | [Br(CH₂)₂NH₃]₂PbI₄ | 1 | 2-bromoethylammonium | — |
| (Pbnm) | | | | | |
| P21/c | else | [NH₃(CH₂)₂SS(CH₂)₂NH₃]₂PbI₄ | 1 | 2,2′-dithiobisethanammonium | — |
| (P21/a) | | | | | |
| P21/c | else | [NH₃(CH₂)₂SS(CH₂)₂NH₃]₂PbI₄ | 1 | 2,2′-dithiobisethanammonium | — |
| (P21/n) | | | | | |
| Pna21 | else | [NH₃(CH₂)₂SS(CH₂)₂NH₃]₂SnI₄ | 1 | 2,2′-dithiobisethanammonium | — |
| (P21cn) | | | | | |
| Pbca | else | [C₅H₄N(CH₂)NH₃]PbI₄ | 1 | 3-Pyridinylmethylammonium | — |
| Pbca | else | [C₅H₄N(CH₂)NH₃]PbI₄ | 1 | 3-Pyridinylmethylammonium | — |
| Pbca | else | [C₅H₄N(CH₂)NH₃]PbBr₄ | 1 | 3-Pyridinylmethylammonium | — |
| Pbca | else | [CH₄N(CH₂)NH₃]PbBr₄ | 1 | 3-Pyridinylmethylammonium | — |
| Pna21 | else | [C₅H₄N(CH₂)NH₃]Pb₄Cl₁₆ | 1 | 3-Pyridinylmethylammonium | — |
| Pbca | else | [C₅H₄N(CH₂)NH₃]PbCl₄ | 1 | 3-Pyridinylmethylammonium | — |
| P21/c | else | [(CH₃)₂NH(CH₂)₂NH₃]PbBr₄ | 1 | 2-(dimethylamino)ethylammonium | — |
| P21/c | else | [(CH₃)₂NH(CH₂)₃NH₃]PbBr₄ | 1 | N,N′-dimethylpropane- | — |
| | | | | 1,3-diammonium | |
| Aba2 | else | [(CH₃)₂NH(CH₂)₄NH₃]PbBr₄ | 1 | 2-(dimethylamino)butylammonium | — |
| P1 | else | [(HOOC)₂C₇H₇N₂]₂SnI₄ | 1 | 5,6-dicarboxybenzimidazolium | — |
| P21/c | else | [(CH₃)₂NHC₆H₄NH₃]PbI₄ | 1 | N,N-Dimethylbenzene- | — |
| (21/n) | | | | 1,4-diammonium | |
| C2/m | else | [FC₆H₅(CH)₂C₆H₅(CH₂)₂NH₃]₂[CH₃NH₃]Sn₂I₇ | 2 | 2-(4-(3- | — |
| | | | | fluoro)stilbenyl)ethanammonium | |
| P-1 | else | [FC₆H₅(CH)₂C₆H₅(CH₂)₂NH₃]₂[CH₃NH₃]Sn₂I₇ | 1 | 2-(4-(3-fluoro)stilbenyl)ethan- | Methyl- |
| | | | | ammonium | ammonium |
| C2/m | else | [C₆H₅(CH₂)₂NH₃]SnI₄ | 1 | Phenylethylammonium | — |
| P-1 | else | [FC₆H₅(CH)₂C₆H₅(CH₂)₂NH₃]₂SnI₄ | 1 | 2-(4-(3- | — |
| | | | | fluoro)stilbenyl)ethanammonium | |
| C2/m | else | [FC₆H₅(CH)₂C₆H5(CH₂)₂NH₃]₂SnI₄ | 1 | 2-(4-(3- | — |
| | | | | fluoro)stilbenyl)ethanammonium | |
| P21/c | else | [NH₃(CH₂)₈NH₃]PbBr₄ | 1 | 1,8-octanediammonium | — |
| P-1 | else | [NH₃(CH₂)₄NH₃]PbBr₄ | 1 | 1,4-butanediammonium | — |
| P21/c | else | [COOH(CH₂)₃NH₃]₂PbBr₄ | 1 | 3-carboxypropan-1-ammonium(γ- | — |
| | | | | ammoniobutyric acid) | |
| P21/c | else | [C₃H₄N₂(CH₂)₂NH₃]PbBr₄ | 1 | Histammonium | — |
| P21/c | else | [NH₃C₆H₄(CH₂)₂NH₃]PbBr₄ | 1 | 3-(2-aminoethyl)anilinium | — |
| Pbca | else | [HO(CH₂)₂NH₃]₂PbBr₄ | 1 | 2-hydroxyethylammonium | — |
| P21/c | else | [C₃H₄N₂(CH₂)₂NH₃]PbBr₄ | 1 | Histammonium | — |
| C2/c | else | [NH₃CH₂CH(CH₃)(CH₂)₃NH₃]PbBr₄ | 1 | | — |
| P-1 | else | [C₆H₅(CH₂)₂NH₃]₂SnBr₄ | 1 | Phenylethylammonium | — |
| P-1 | else | [C₆H₉(CH₂)₂NH₃]₂SnBr₄ | 1 | 2-(1- | — |
| | | | | cyclohexenyl)ethylammonium | |
| P-1 | else | [C₆H₉(CH₂)₂NH₃]₂PbBr₄ | 1 | 2-(1- | — |
| | | | | cyclohexenyl)ethylammonium | |
| P-1 | else | [C₆H₅(CH₂)₂NH₃]₂PbI₄ | 1 | Phenylethylammonium | — |
| P-1 | else | [C₆H₅(CH₂)₂NH₃]₂PbBr₄ | 1 | Phenylethylammonium | — |
| Cc | else | [NH₃(CH₂)₂(CH₃)(CH₂)₃NH₃]PbCl₄ | 1 | | — |
| Pnma | else | [F(CH₂)₂NH₃]₂PbBr₄ | 1 | 2-fluoroethylammonium | — |
| Pbca | RP | [F₂CHCH₂NH₃]₂PbBr₄ | 1 | 2,2-difluoroethylammonium | — |
| Pnma | else | [F₃CCH₂NH₃]₂PbBr₄ | 1 | 2,2,2-trifluoroethylammonium | — |
| Pca21 | else | [NH₂C₅H₉CH₂NH₃]PbBr₄ | 1 | 4-(aminomethyl)piperidinium | — |
| C2/c | DJ | [CH₃NHC₄H₈NH₂]₂Pb₃Br₁₀ | 3 | 1-methylpiperazine | — |
| P21/c | else | [NH₃(CH₂)₄NH₃]PbCl₄ | 1 | 1,4-butyldiamine | — |
| P-1 | else | [C₆H₅(CH₂)₂NH₃]₂PbI₄ | 1 | Phenylethylammonium | — |
| P-1 | else | [C₆H₅(CH₂)₂NH₃]₂PbI₄ | 1 | Phenylethylammonium | — |
| P-1 | else | [CH₃C₆H₄(CH₂)₂NH₃]₂PbI₄ | 1 | p-methylphenylethylammonium | — |
| P-1 | else | [CH₃C₆H₄(CH₂)₂NH₃]₂PbI₄ | 1 | p-methylphenylethylammonium | — |
| C2/c | else | [BrC₆H₄(CH₂)₂NH₃]₂PbI₄ | 1 | p-bromophenylethylammonium | — |
| C2/c | else | [ClC₆H₄(CH₂)₂NH₃]₂PbI₄ | 1 | p-chlorophenylethylammonium | — |
| P21/c | else | [C₅H₄NH(CH₂)₂NH₃]PbI₄ | 1 | 2-(1-Pyridyl)ethylammonium | — |
| Pc | DJ | [C₅H₁₁NCH₂NH₃][CH₃NH₃]Pb₂Br₇ | 2 | 3-(aminomethyl)piperidinium | Methyl- |
| | | | | | ammonium |
| Cc | DJ | [C₅H₁₁NCH₂NH₃][CH₃NH₃]Pb₂Br₇ | 2 | 4-(aminomethyl)piperidinium | Methyl- |
| | | | | | ammonium |
| Cm | DJ | [C₅H₁₁NCH₂NH₃][CH(NH₂)₂]Pb₂Br₇ | 2 | 3-(aminomethyl)piperidinium | Forma- |
| | | | | | midinium |
| Pc | DJ | [C₅H₁₁NCH₂NH₃][CH(NH₂)₂]Pb₂Br₇ | 2 | 4-(aminomethyl)piperidinium | Forma- |
| | | | | | midinium |
| Cmc21 | RP | [CH₃(CH₂)₃NH₃]₂CsPb₂Br₇ | 2 | Butylammonium | Cs |
| Cmc21 | RP | [CH₃(CH₂)₃NH₃]₂CsPb₂Br₇ | 2 | Butylammonium | Cs |
| Cmca | RP | [CH₃(CH₂)₃NH₃]₂CsPb₂Br₇ | 2 | Butylammonium | Cs |
| Cmc21 | RP | [CH₃(CH₂)₃NH₃]₂ | 2 | Butylammonium | Forma- |
| | | [CH(NH₂)₂]Pb₂Br₇ | | | midinium |
| Cmcm | RP | [CH₃(CH₂)₃NH₃]₂ | 2 | Butylammonium | Forma- |
| | | [CH(NH₂)₂]Pb₂Br₇ | | | midinium |
| Cmc21 | else | [CH₃(CH₂)₃NH₃]₂ | 3 | Butylammonium | Methyl- |
| | | [CH₃NH₃]₂Pb₃Br₁₀ | | | ammonium |
| Cmca | RP | [CH₃(CH₂)₃NH₃]₂ | 3 | Butylammonium | Methyl- |
| | | [CH₃NH₃]₂Pb₃Br₁₀ | | | ammonium |
| Cmc21 | RP | [CH₃(CH₂)₃NH₃]₂(CH₃NH₃)Pb₂Br₇ | 2 | Butylammonium | Methyl- |
| | | | | | ammonium |
| Cmca | RP | [CH₃(CH₂)₃NH₃]₂(CH₃NH₃)Pb₂Br₇ | 2 | Butylammonium | Methyl- |
| | | | | | ammonium |
| Pnma | else | [CH₃(CH₂)₄NH₃]₂[CH(NH₂)₂]Pb₂I₇ | 2 | Pentylammonium | Forma- |
| | | | | | midinium |
| Cmc21 | else | [CH₂CHCH₂NH₃]₂ | 3 | Allylammonium | Ethyl- |
| | | [CH₃CH₂NH₃]₂Pb₃Br₁₀ | | | ammonium |
| Fmmm | RP | [CH₂CHCH₂NH₃]₂ | 3 | Allylammonium | Ethyl- |
| | | [CH₃CH₂NH₃]₂Pb₃Br₁₀ | | | ammonium |
| I4/mmm | RP | [CH₂CHCH₂NH₃]₂ | 3 | Allylammonium | Ethyl- |
| | | [CH₃CH₂NH₃]₂Pb₃Br₁₀ | | | ammonium |
| Cmc21 | else | [F₂C₆H₉NH₃]₂PbI₄ | 1 | 4,4-difluorocyclohexylammonium | — |
| Pbca | else | [F₂C₆H₉NH₃]₂PbI₄ | 1 | 4,4-difluorocyclohexylammonium | — |
| Cmc21 | else | [CH₃CH₂NH₃]₂[CH₃NH₃]₂Pb₃Br₁₀ | 3 | Ethylammonium | Methyl- |
| | | | | | ammonium |
| I4/mmm | RP | [CH₃CH₂NH₃]₂[CH₃NH₃]₂Pb₃Br₁₀ | 3 | Ethylammonium | Methyl- |
| | | | | | ammonium |
| Pbca | RP | (HOOC(CH₂)₃NH₃)PbI₄ | 1 | ammonium 4-butyric acid | — |
| Aba2 | RP | (HOOC(CH₂)₃NH₃)₂(CH₃NH₃)Pb₂I₇ | 2 | ammonium 4-butyric acid | Methyl- |
| (C2cb) | | | | | ammonium |
| P21/c | else | [C₁₆H₉(CH₂)₂NH₃]₂PbI₄ | 1 | pyrene-butylammonium | — |
| Pbca | RP | [CH₃(CH₂)₃NH₃]₂PbBr₄ | 1 | Butylammonium | — |
| Aba2 | RP | [CH₃(CH₂)₃NH₃]₂[CH₃NH₃]₂Pb₃I₁₀ | 3 | Butylammonium | Methyl- |
| (C2cb) | | | | | ammonium |
| Ama2 | RP | [CH₃(CH₂)₃NH₃]₂[CH₃NH₃]₃Pb₄I₁₃ | 4 | Butylammonium | Methyl- |
| (Cc2m) | | | | | ammonium |
| P21 | else | [NH₃(CH₂)₂SS(CH₂)₂NH₃]PbBr₄ | 1 | 2,2′-dithiobisethanammonium | — |
| P21 | else | [NH₂(C₂H₄)₂NH₂]PbBr₄ | 1 | Piperazinium | — |
| Cmc21 | else | [C₆H₁₁NH₃]PbBr₄ | 1 | Cyclohexylammonium | — |
| Cmc21 | else | [C₆H₁₁NH₃]PbBr₄ | 1 | Cyclohexylammonium | — |
| P-1 | else | [C₆H₅NH₃]₂PbCl₄ | 1 | Phenylethylammonium | — |
| Pnma | else | [CH₃(CH₂)₂NH₃]₂PbCl₄ | 1 | Propylammonium | — |
| P21/c | DJ | [C(NH₂)₃]₂SnI₄ | 1 | Guanidinium | — |
| (P21/n) | | | | | |
| Pbca | RP | [I(CH₂)₆NH₃]₂PbI₄ | 1 | 6-iodohexylammonium | — |
| P-1 | else | [C₆H₉(CH₂)₂NH₃]₂PbI₄ | 1 | 2-(1- | — |
| | | | | cyclohexenyl)ethylammonium | |
| P21/c | else | [C₆H₅CH(CH₃)NH₃]₂PbI₄ | 1 | 1-phenylethylammonium | — |
| (P21/a) | | | | | |
| P-1 | else | [(C₆H₅(CH₂)₂NH₃)₂(CH₃NH₃)]Pb₂I₇ | 2 | Phenylethylammonium | Methyl- |
| | | | | | ammonium |
| P1 | else | [ClC₆H₄CH₂(CH₃)NH₃]₂PbI₄ | 1 | R-1-(4- | — |
| | | | | chlorophenyl)ethylammonium | |
| P-1 | else | [ClC₆H₄CH₂(CH₃)NH₃]₂PbI₄ | 1 | S-1-(4- | — |
| | | | | chlorophenyl)ethylammonium | |
| P21/c | else | [ClC₆H₄CH₂(CH₃)NH₃]₂PbI₄ | 1 | rac-1-(4- | — |
| | | | | chlorophenyl)ethylammonium | |
| Cc | else | [NH₃(CH₂)₂(CH₃)(CH₂)₃NH₃]PbBr₄ | 1 | 3-aminopyridinium | — |
| Pc | DJ | [(C₅H₁₁NCH₂NH₃)[CH(NH₂)₂]_{0.5}(CH₃NH₃)_{0.5}]Pb₂Br₇ | 2 | 4-(aminomethyl)piperidinium | Methyl- |
| | | | | | ammonium |
| Pc | DJ | [(C₅H₁₁NCH₂NH₃)[CH(NH₂)₂]_{0.5}(CH₃NH₃)_{0.5}]Pb₂Br₇ | 2 | 4-(aminomethyl)piperidinium | Methyl- |
| | | | | | ammonium |
| C2 | DJ | [(C₅H₁₁NCH₂NH₃)[CH(NH₂)₂]_{0.5}(CH₃NH₃)_{0.5}]Pb₂Br₇ | 2 | 3-(aminomethyl)piperidinium | Methyl- |
| | | | | | ammonium |
| Pc | DJ | [(C₅H₁₁NCH₂NH₃)[CH(NH₂)₂]Pb₂Br₇ | 2 | 4-(aminomethyl)piperidinium | Forma- |
| | | | | | midinium |
| Cc | DJ | [(C₅H₁₁NCH₂NH₃)(CH₃NH₃)]Pb₂Br₇ | 2 | 4-(aminomethyl)piperidinium | Methyl- |
| | | | | | ammonium |
| Cc | else | [C₆H₅(CH₂)₂NH₃]₂PbI₄ | 1 | Phenylethylammonium | — |
| P21/c | else | [C₅H₄NH(CH₂)₂NH₃]PbI₄ | 1 | 2-(1-Pyridyl)ethylammonium | — |
| (P21/n) | | | | | |
| P21/c | else | [C₃H₄N₂(CH₂)₂NH₃]PbI₄ | 1 | imidazolium | — |
| (P21/n) | | | | ethylammonium | |
| P21/c | RP | [CH₃CH(CH₃)CH₂NH₃]₂PbI₄ | 1 | Isobutylammonium | — |
| Cc | — | [CH₃CH(CH₃)CH₂NH₃]₂[CH₃NH₃]Pb₂I₇ | 2 | Isobutylammonium | Methyl- |
| | | | | | ammonium |
| Pbcn | RP | [C₆H₅CH₂NH₃]₂[CH₃NH₃]Pb₂I₇ | 2 | Phenylmethylammonium | Methyl- |
| | | | | | ammonium |
| Cmc21 | RP | [C₆H₅CH₂NH₃]₂[CH₃NH₃]₂Pb₃I₁₀ | 3 | Phenylmethylammonium | Methyl- |
| | | | | | ammonium |
| P1 | else | [C₆H₅CH(CH₃)NH₃]₂PbI₄ | 2 | R1-phenylethylammonium | — |
| P1 | else | [C₆H₅CH(CH₃)NH₃]₂PbI₄ | 2 | S1-phenylethylammonium | — |
| P21/c | else | [CH₃(CH₂)₂NH₃]₂[CH₃NH₃]₂Pb₃I₁₀ | 3 | Propylammonium | Methyl- |
| (P21/a) | | | | | ammonium |
| Cc | else | [CH₃(CH₂)₂NH₃]₂[CH₃NH₃]₃Pb₄I₁₃ | 4 | Propylammonium | Methyl- |
| | | | | | ammonium |
| Pc (Pn) | else | [C₅H₄NCH₂NH₃]PbI₄ | 1 | 3-(aminomethyl)pyridinium | — |
| Pc | else | [C₅H₄NCH₂NH₃][CH₃NH₃]Pb₂I₇ | 2 | 3-(aminomethyl)pyridinium | Methyl- |
| | | | | | ammonium |
| Cc | else | [C₅H₄NCH₂NH₃][CH₃NH₃]₂Pb₃I₁₀ | 3 | 3-(aminomethyl)pyridinium | Methyl- |
| | | | | | ammonium |
| Pc | else | [C₅H₄NCH₂NH₃][CH₃NH₃]₃Pb₄I₁₃ | 4 | 3-(aminomethyl)pyridinium | Methyl- |
| | | | | | ammonium |
| Pc (Pn) | DJ | [C₅H₄NCH₂NH₃]PbI₄ | 1 | 4-(aminomethyl)pyridinium | — |
| Cc | DJ | [C₅H₄NCH₂NH₃][CH₃NH₃]Pb₂I₇ | 2 | 4-(aminomethyl)pyridinium | Methyl- |
| | | | | | ammonium |
| Pc | DJ | [C₅H₄NCH₂NH₃][CH₃NH₃]₂Pb₃I₁₀ | 3 | 4-(aminomethyl)pyridinium | Methyl- |
| | | | | | ammonium |
| Pc | DJ | [C₅H₁₁NCH₂NH₃]PbI₄ | 1 | 4-(aminomethyl)piperidinium | — |
| P21/c | DJ | [C₅H₁₁NCH₂NH₃]PbI₄ | 1 | 4-(aminomethyl)piperidinium | — |
| Cc | else | [(CH₃(CH₂)₄NH₃)₂(CH₃NH₃)]Pb₂I₇ | 2 | Pentylammonium | Methyl- |
| | | | | | ammonium |
| Pc | else | [(CH₃(CH₂)₄NH₃)₂(CH₃NH₃)₂]Pb₃I₁₀ | 3 | Pentylammonium | Methyl- |
| | | | | | ammonium |
| Cc | else | [(CH₃(CH₂)₄NH₃)₂(CH₃NH₃)₃]Pb₄I₁₃ | 4 | Pentylammonium | Methyl- |
| | | | | | ammonium |
| Pc | else | [(CH₃(CH₂)₄NH₃)₂(CH₃NH₃)₄]Pb₅I₁₆ | 5 | Pentylammonium | Methyl- |
| | | | | | ammonium |
| Cc | else | [(CH₃(CH₂)₅NH₃)₂(CH₃NH₃)]Pb₂I₇ | 2 | Hexylammonium | Methyl- |
| | | | | | ammonium |
| Pc | else | [(CH₃(CH₂)₅NH₃)₂(CH₃NH₃)₂]Pb₃I₁₀ | 3 | Hexylammonium | Methyl- |
| | | | | | ammonium |
| Cc | else | [(CH₃(CH₂)₅NH₃)₂(CH₃NH₃)₃]Pb₄I₁₃ | 4 | Hexylammonium | Methyl- |
| | | | | | ammonium |
| P21/c | else | [CH₃(CH₂)₇NH₃]₂PbI₄ | 1 | Heptylammonium | — |
| Pbca | RP | [CH₃(CH₂)₇NH₃]₂PbI₄ | 1 | Heptylammonium | — |
| Pbca | RP | [CH₃(CH₂)₇NH₃]₂PbI₄ | 1 | Heptylammonium | — |
| P21/c | else | [CH₃(CH₂)₈NH₃]₂PbI₄ | 1 | Octylammonium | — |
| Pbca | RP | [CH₃(CH₂)₈NH₃]₂PbI₄ | 1 | Octylammonium | — |
| Cmca | RP | [CH₃(CH₂)₈NH₃]₂PbI₄ | 1 | Octylammonium | — |
| P21/c | else | [CH₃(CH₂)₉NH₃]₂PbI₄ | 1 | Nonylammonium | — |
| Pbca | RP | [CH₃(CH₂)₉NH₃]₂PbI₄ | 1 | Nonylammonium | — |
| P21/c | else | [CH₃(CH₂)₁₀NH₃]₂PbI₄ | 1 | Decylammonium | — |
| Pbca | RP | [CH₃(CH₂)₁₀NH₃]₂PbI₄ | 1 | Decylammonium | — |
| Pbca | RP | [CH₃(CH₂)₁₀NH₃]₂PbI₄ | 1 | Decylammonium | — |
| Pbca | RP | [CH₃(CH₂)₁₀NH₃]₂PbI₄ | 1 | Decylammonium | — |
| Pbca | RP | [CH₃(CH₂)₁₀NH₃]₂PbI₄ | 1 | Decylammonium | — |
| P21/c | else | [FC₆H₄(CH₂)₂NH₃]₂PbI₄ | 1 | 4-fluorophenylethylammonium | — |
| C2/c | else | [ClC₆H₄(CH₂)₂NH₃]₂PbI₄ | 1 | p-chlorophenylethylammonium | — |
| Cmca | RP | [BrC₆H₄(CH₂)₂NH₃]₂PbI₄ | 1 | p-bromophenylethylammonium | — |
| C2/c | else | [C₂H₄N₃]₂PbBr₄ | 1 | 1,2,4-triazolium | — |
| C2/c | else | [C₂H₄N₃]₂PbBr₄ | 1 | 1,2,4-triazolium | — |
| P21/c | else | [C₂H₇N₂]₂PbBr₄ | 1 | Acetamidinium | — |
| P21/c | DJ | [C₂H₇N₂]₂PbBr₄ | 1 | Acetamidinium | — |
| Pbca | else | [C₇H₁₀N]₂PbI₄ | 1 | Phenylmethylammonium | — |
| P21/c | else | [C₇H₉FN]₂PbI₄ | 1 | 4-fluorophenylmethylammonium | — |
| P21 | else | [C₇H₉ClN]₂PbI₄ | 1 | 4-chlorophenylmethylammonium | — |
| P21 | else | [C₇H₉BrN]₂PbI₄ | 1 | 4-bromophenylmethylammonium | — |
| P21/c | else | [C₈H₉F₃N]₂PbI₄ | 1 | p-trifluoromethylphenyl- | — |
| | | | | methylammonium | |
| P-1 | else | (C₈H₁₂N)₂(CH₆N)Pb₂I₇ | 2 | Phenylethylammonium | Methyl- |
| | | | | | ammonium |
| C21/c | DJ | [C₁₂H₁₄N]₂PbBr₄ | 1 | 1-(1-naphthyl)ethylammonium | — |
| P212121 | else | [C₈H₁₂N]₂PbI₄ | 1 | 1-phenylethylammonium | — |
| P212121 | else | [C₈H₁₂N]₂PbI₄ | 1 | 1-phenylethylammonium | — |
| P21 | else | [C₁₂H₁₄N]₂PbBr₄ | 1 | S-1-(1-naphthyl)ethylammonium | — |
| P212121 | else | [C₈H₁₂N]₂PbI₄ | 1 | R-1-(1-naphthyl)ethylamine | — |
| P21 | else | [C₁₂H₁₄N]₂PbBr₄ | 1 | 1-phenylethylammonium | — |
| Pbcn | else | [C₁₅H₂₀NO₂]₂PbI₄ | 1 | naphthalene-based | — |
| | | | | organic layers | |
| Pbca | RP | [C₁₃H₁₆NO₂]₂PbI₄ | 1 | naphthalene-based | — |
| | | | | organic layers | |
| Pca21 | else | [C₁₄H₁₈NO]₂PbI₄ | 1 | naphthalene-based | — |
| | | | | organic layers | |
| P21/c | else | [C₁₆H₂₂NO]₂PbI₄ | 1 | naphthalene-based | — |
| | | | | organic layers | |
| P-1 | else | [C₁₇H₂₄NO₂]₂PbI₄ | 1 | naphthalene-based | — |
| | | | | organic layers | |
| P21/c | else | [C₉H₉Cl₅NO]₂PbI₄ | 1 | tetrachloro-1,2-benzoquinone | — |
| Pmn21 | else | [CH₃NH₃]₂Pb(SCN)₂I₂ | 1 | Methylammonium | — |
| Pmn21 | else | [CH₃NH₃]₂Pb(SCN)₂I₂ | 1 | Methylammonium | — |
| Pmmn | else | [CH₃NH₃]₂Pb(SCN)₂I₂ | 1 | Methylammonium | — |
| Pnma | DJ | [C₈H₁₂N]₂SnI₄ | 1 | R-methylbenzylammonium | — |
| P212121 | DJ | [C₈H₁₂N]₂SnI₄ | 1 | S-methylbenzylammonium | — |
| P212121 | DJ | [C₈H₁₂N]₂SnI₄ | 1 | Rac-methylbenzylammonium | — |
| P21 | else | [C₆H₁₂F₂N]₂PbI₄ | 1 | 4-fluorohexahydroazepine | — |
| Cmc21 | else | [C₆H₁₂F₂N]₂PbI₄ | 1 | 4-fluorohexahydroazepine | — |
| Imm2 | RP | [C₆H₁₂F₂N]₂PbI₄ | 1 | 4-fluorohexahydroazepine | — |
| I-4m2 | RP | [C₆H₁₂F₂N]₂PbI₄ | 1 | 4-fluorohexahydroazepine | — |
| P21/c | else | [C₄H₁₃N₅]PbBr₄ | 1 | N,N-dimethylbiguanidinium | — |
| Cmc21 | else | (C₂H₈N)₂(C₄H₁₂N)₂Pb₃I₁₀ | 3 | Butylammonium | Ethyl- |
| | | | | | ammonium |
| Cc | else | (BA)₂(EAₓMA₁₋ₓ)₂Pb₃I₁₀ | 3 | Butylammonium | Ethyl- |
| | | | | | ammonium, |
| | | | | | Methyl- |
| | | | | | ammonium |
| Cc | RP | (BA)₂(EAₓMA₁₋ₓ)₂Pb₃I₁₀ | 3 | Butylammonium | Ethyl- |
| | | | | | ammonium, |
| | | | | | Methyl- |
| | | | | | ammonium |
| Cc | RP | (BA)₂(EA)₂Pb₃I₁₀ | 3 | Butylammonium | Ethyl- |
| | | | | | ammonium |
| C2/m | else | PEA₂PbI₄ | 1 | Phenylethylammonium | — |
| P-1 | else | PEA₂PbI₄ | 1 | Phenylethylammonium | — |
| P-1 | else | PEA₂MA₂Pb₃I₁₀ | 3 | Phenylethylammonium | — |
| P-1 | else | PEA₂MAPb₂I₇ | 2 | Phenylethylammonium | — |
| P-1 | else | PEA₂PbI₄ | 1 | Phenylethylammonium | — |
| Cmcm | RP | (BA)₂(FA)Pb₂I₇ | 2 | Butylammonium | Forma- |
| | | | | | midinium |
| Cmca | RP | (BA)₂(DMA)Pb₂I₇ | 2 | Butylammonium | Dimethyl- |
| | | | | | ammonium |
| Cmcm | RP | (BA)₂(GA)Pb₂I₇ | 2 | Butylammonium | Guanidinium |
| Ama2 | RP | (BA)₂(FA)Pb₂I₇ | 2 | Butylammonium | Forma- |
| | | | | | midinium |
| Aba2 | RP | (BA)₂(DMA)Pb₂I₇ | 2 | Butylammonium | Dimethyl- |
| | | | | | ammonium |
| Ama2 | RP | (BA)₂(GA)Pb₂I₇ | 2 | Butylammonium | Guanidinium |
| P21/c | else | (C₅H₁₁NH₃)₂(CH₃NH₂CH₃)Pb₂I₇ | 2 | C5H11NH3 | Dimethyl- |
| | | | | | ammonium |
| Cmcm | else | [C₈H₁₁FN]₂PbBr₄ | 1 | 3-fluoro-N- | — |
| | | | | methylbenzylammonium | |
| Aba2 | RP | [C₅H₁₀F₂N]₂PbI₄ | 1 | 4,4-difluoropiperidinium | — |
| Cmca | RP | [C₆H₁₄N]₂PbBr₄ | 1 | Cyclohexylammonium | — |
| Cmca | RP | [C₆H₁₄N]₂PbI₄ | 1 | Cyclohexylammonium | — |
| Cmc21 | else | [C₅H₁₂ON]₂PbBr₄ | 1 | tetrahydropyranylammonium | — |
| Cmc21 | RP | [C₆H₁₆N]₂PbI₄ | 1 | Hexylammonium | — |
| Cmc21 | else | [C₇H₉FN]₂PbCl₄ | 1 | 2-fluorobenzylammonium | — |
| Cmc21 | else | [C₇H₁₀N]₂PbCl₄ | 1 | Phenylmethylammonium | — |
| Cmc21 | RP | [C₁₄H₁₆N]₂PbI₄ | 1 | 2-(4-biphenyl)ethylammonium | — |
| Pbcn | else | [C₇H₉FN]₂PbI₄ | 1 | 4-fluoro-N-methylanilinium | — |
| Pbcn | else | [C₈H₁₁FN]₂PbBr₄ | 1 | 3-fluoro-N- | — |
| | | | | methylbenzylammonium | |
| Pbcn | else | [C₈H₁₁ClN]₂PbI₄ | 1 | 3-chloro-N- | — |
| | | | | methylbenzylammonium | |
| Pbcn | else | [C₈H₁₁BrN]₂PbCl₄ | 1 | 3-bromo-N- | — |
| | | | | methylbenzylammonium | |
| Pbcn | else | [C₈H₁₁BrN]₂PbBr₄ | 1 | 3-bromo-N- | — |
| | | | | methylbenzylammonium | |
| Pnma | else | [C₃H₇N₂]₂PbI₄ | 1 | 2-cyanoethylammonium | — |
| Pnma | DJ | [C₅H₅BrN]₂PbBr₄ | 1 | 3-bromopyridinium | — |
| Pnma | else | [C₇H₉FN]₂PbCl₄ | 1 | 4-fluorobenzylammonium | — |
| Pnma | else | [C₈H₂₀N₂]PbCl₄ | 1 | 1,4-cyclohexanedimethyl- | — |
| | | | | ammonium | |
| Pbcm | else | [C₂H₁₀N₂]PbI₄ | 1 | 1,2-ethanediammonium | — |
| Pbca | RP | [C₄H₁₂N]₂PbCl₄ | 1 | Butylammonium | — |
| Pbca | RP | [C₅H₈SN]₂PbCl₄ | 1 | 2-thiophenemethylammonium | — |
| Pbca | RP | [C₅H₈SN]₂PbBr₄ | 1 | 2-thiophenemethylammonium | — |
| Pbca | else | [C₁₀H₁₆N]₂PbBr₄ | 1 | Deca-3,5-diyn-1-ammonium | — |
| Cc | else | [C₆H₁₈N₂]PbBr₄ | 1 | 2-Methylpentane-1,5-diammonium | — |
| Pca21 | RP | [C₁₆H₃₆N]₂PbI₄ | 1 | Hexadecylammonium | — |
| Pca21 | else | [C₁₄H₁₈ON]₂PbI₄ | 1 | 4-[(Naphthalen-1-yl)oxy]butyl-1- | — |
| | | | | ammonium | |
| P21/c | RP | [C₄H₁₂N]₂PbBr₄ | 1 | Butylammonium | — |
| P212121 | else | [C₃H₁₂N₂]PbCl₄ | 1 | 1,3-propyldiammonium | — |
| P212121 | else | [C₈H₁₂N]₂PbI₄ | 1 | 1-phenylethylammonium | — |
| Pn | else | [C₇H₉FN]₂PbI₄ | 1 | 3-fluoro-N-methylanilinium | — |
| P21/c | else | [C₄H₁₄S₂N₂]PbCl₄ | 1 | 2,2′-Dithiobis(ethylammonium) | — |
| P21/c | else | [C₆H₁₆N₂]PbI₄ | 1 | 4-(aminomethyl)piperidinium | — |
| P21/c | else | [C₆H₁₈N₂]PbCl₄ | 1 | 1,6-hexanediammonium | — |
| P21/n | else | [C₅H₁₂O₂N]₂PbBr₄ | 1 | 5-carboxipentylammonium | — |
| P21/n | else | [C₉H₉FN]₂PbI₄ | 1 | 4-fluorobenzylammonium | — |
| C2/c | else | [C₅H₁₂N]₂PbCl₄ | 1 | Piperidinium | — |
| C2/c | else | [C₂₀H₂₀S₄N]₂PbI₄ | 1 | 2-(3′′′,4′-dimethyl- | — |
| | | | | [2,2′:5′,2″:5″,2′′′- | |
| | | | | quaterthiophen]-5-yl)ethan- | |
| | | | | 1-ammonium | |
| Pnma | else | [C₅H₁₂N]₂PbBr₄ | 1 | Piperidinium | — |
| Pbnm | else | [C₂H₇ClN]₂PbI₄ | 1 | 2-chloroethylammonium | — |
| P21/n | else | [C₇H₁₂N₂]PbBr₄ | 1 | 2-(4-Pyridyl)ethylammonium | — |
| P21/n | else | [C₇H₁₂N₂]PbI₄ | 1 | 2-(2-Pyridyl)ethylammonium | — |
| P21/n | else | [C₇H₁₂N₂]PbI₄ | 1 | 2-(3-Pyridyl)ethylammonium | — |
| P21/n | else | [C₇H₁₂N₂]PbI₄ | 1 | 2-(4-Pyridyl)ethylammonium | — |
| Cc | else | [C₇H₁₀N]₂PbI₄ | 1 | N-methylanilinium | — |
| P21/c | — | FA₂PbBr₄ | 1 | Formamidinium | — |
| Pbam | — | [C₁₁H₁₂N]₂PbCl₄ | 1 | 1-(2-Naphthyl)-methylammonium | — |
| P21/a | else | [C₈H₁₂N]₂PbCl₄ | 1 | 4-methylbenzylammonium | — |
| P21/a | else | [C₈H₁₂N]₂PbBr₄ | 1 | 4-methylbenzylammonium | — |
| P21/a | else | [C₈H₁₂N]₂PbI₄ | 1 | 4-methylbenzylammonium | — |
| P21/a | RP | [C₈H₁₂ON]₂PbI₄ | 1 | 4-Methoxy-N-methylanilinium | — |
| P21/c | else | [C₆H₇ClN]₂PbI₄ | 1 | 4-Chloroanilinium | — |
| P21/c | else | [C₆H₇ClN]₂PbI₄ | 1 | 4-Bromoanilinium | — |
| P21/c | else | [C₈H₁₀Cl₂N]₂PbI₄ | 1 | 2-(3,5-Dichlorophenyl)ethyl-1- | — |
| | | | | ammonium | |
| P21/c | else | [C₈H₁₀Br₂N]₂PbI₄ | 1 | 2-(3,5-Dibromophenyl)ethyl-1- | — |
| | | | | ammonium | |
| P21/c | else | [C₁₀H₁₆N]₂PbI₄ | 1 | 2-(3,5-Dimethylphenyl)ethyl-1- | — |
| | | | | ammonium | |
| P21 | else | [C₈H₁₁BrN]₂PbI₄ | 1 | 2-bromophenylethylammonium | — |
| P-1 | else | [C₅H₁₂O₂N]₂PbCl₄ | 1 | 4-carboxibutylammonium | — |
| P-1 | else | [C₁₂H₁₈S₄N₂]PbI₄ | 1 | 2-([2,2′-bithiophen]-5- | — |
| | | | | yl)ethyl-1-ammonium | |
| Pna21 | — | [C₄₀H₄₈N₄S₁₂]Pb₃I₁₀ | 1 | 5,5′-bis(ammoniumethylsulfanyl)- | — |
| | | | | 2,2′-bithiophene | |
| P212121 | — | [C₃₀H₃₆N₃S₉]Bi₂I₉ | 1 | 2-([2,2′-bithiophen]-5-yl)ethyl-1- | — |
| | | | | ammonium | |
| P21 | DJ | [C₅H₁₆PN]PbBr₄ | 1 | (2-Azaniumylethyl)trimethyl- | — |
| | | | | phosphonium | |
| C2/c | else | [C₅H₁₁N₃]PbBr₄ | 1 | 4-(2-aminoethyl)imidazolium | — |
| P21/c | else | [C₅H₁₁N₃]PbBr₄ | 1 | 2-(2-aminoethyl)imidazolium | — |
| P21/c | else | [C₅H₁₅N₂]PbCl₄ | 1 | N-methylethane-1,2-diammonium | — |
| P21212 | DJ | [C₆H₁₆N₂]PbI₄ | 1 | Cyclohexane-1,2-diammonium | — |
| P-1 | else | [C₉H₁₄ON]₂PbI₄ | 1 | 2-(4-Methoxyphenyl)ethyl-1- | — |
| | | | | ammonium | |
| P1 | else | [C₁₀H₁₂S₂N]₂PbI₄ | 1 | 2-([2,2′-bithiophen]-5- | — |
| | | | | yl)ethyl-1-ammonium | |
| P-1 | else | [C₂4H₂₂S₄N]₂PbI₄ | 1 | 5,5′′′-bis-(aminoethyl)- | — |
| | | | | 2,2′:5′,2″:5″,2′′′-quaterthiophene | |
| Pbca | else | [C₅H₁₆N₂]PbI₄ | 1 | N,N′-dimethylpropane- | — |
| | | | | 1,3-diammonium | |
| Pbca | else | [C₆H₁₇N₃]PbI₄ | 1 | 1-(2-Aminoethyl)piperazinium | — |
| Pbca | else | [C₇H₁₂N₂]PbBr₄ | 1 | 2-(3-Pyridyl)ethylammonium | — |
| Pbca | else | [C₉H₁₄N]₂PbBr₄ | 1 | Phenylpropylammonium | — |
| Pmnm | else | [CH₃NH₂NH₂]PbBr₄ | 1 | Methylhydrazinium | — |
| Pmnm | — | [CH₃NH₂NH₂]PbBr₄ | 1 | Methylhydrazinium | — |
| Pmn21 | else | [CH₃NH₂NH₂]PbBr₄ | 1 | Methylhydrazinium | — |
| Pmn21 | else | [CH₃NH₂NH₂]PbBr₄ | 1 | Methylhydrazinium | — |
| P21 | else | [HOOC(CH₂)₆NH₃]4Pb₃I₁₀ | 1 | cis-4- | — |
| | | | | aminocyclohexanecarboxylic acid | |
| C2/c | else | [HOOC(CH₂)₆NH₃]PbI₄ | 1 | trans-4- | — |
| | | | | aminocyclohexanecarboxylic acid | |
| Cc | else | (CH₃(CH₂)₅NH₃)₂(CH₃NH₃)Pb₂Br₇ | 2 | Hexylammonium | Methyl- |
| | | | | | ammonium |
| C2/c | RP | (CH₃(CH₂)₅NH₃)₂(CH₃NH₃)Pb₂Br₇ | 2 | Hexylammonium | Methyl- |
| | | | | | ammonium |
| Cc | RP | (CH₃(CH₂)₆NH₃)₂(CH₃NH₃)Pb₂Br₇ | 2 | Heptylammonium | Methyl- |
| | | | | | ammonium |
| Cc | RP | (CH₃(CH₂)₇NH₃)₂(CH₃NH₃)Pb₂Br₇ | 2 | Octylammonium | Methyl- |
| | | | | | ammonium |
| Cc | else | (CH₃(CH₂)₇NH₃)₂(CH₃NH₃)Pb₂I₇ | 2 | Octylammonium | Methyl- |
| | | | | | ammonium |
| P21/c | else | [C₈H₁₁S₂(CH₂)₃NH₃]₂PbI₄ | 1 | 2,2′-bithiophene | — |
| P21/c | else | [C₈H₁₁S₂(CH₂)₃NH₃]₂PbBr₄ | 1 | 3-([2,2′-bithiophen]-5- | — |
| | | | | yl)propan-1-ammonium | |
| P21/c | else | [C₈H₁₁S₂(CH₂)₃NH₃]₂PbCl₄ | 1 | 3-([2,2′-bithiophen]-5- | — |
| | | | | yl)propan-1-ammonium | |
| P21/c | DJ | [C₈H₁₁S₂(CH₂)₃NH₃]₁₂Pb₉I₃₀ | 1 | 3-([2,2′-bithiophen]-5- | — |
| | | | | yl)propan-1-ammonium | |
| P21/c | else | [C₈H₁₁S₂(CH₂)₃NH₃]₄Pb₃I₁₀ | 1 | 3-([2,2′-bithiophen]-5- | — |
| | | | | yl)propan-1-ammonium | |
| Cc | else | [(CH₃)₃CNH₃]₂[CH₃NH₃]Pb₂Br₇ | 2 | Isobutylammonium | Methyl- |
| | | | | | ammonium |
| Ccc2 | RP | [CH₃(CH₂)₃NH₃]₂[CH₃NH₃]Pb₂Br₈ | 2 | Butylammonium | Methyl- |
| | | | | | ammonium |
| Ccc2 | RP | [CH₃(CH₂)₄NH₃]₂[CH₃NH₃]Pb₂Br₇ | 2 | Pentylammonium | Methyl- |
| | | | | | ammonium |
| P21/c | else | [NH₃CH₂C₆H₄F₄CH₂NH₃]₂PbI₄ | 1 | 2,3,5,6-tetrafluoro-1,4- | — |
| | | | | phenylenedimethanammonium | |
| P1 | else | [C₅H₁₂NO]₂PbBr₄ | 1 | tetrahydropyranylammonium | — |
| R3 | else | (COOH(CH₂)NH₂)PbI₂ | 1 | (2-carboxy)methylammonium | — |
| Pbca | RP | (COOH(CH₂)₃NH₃)₂PbI₄ | 1 | (2-carboxy)ethylammonium | — |
| P21/c | else | (COOH(CH₂)₇NH₃)₂PbI₄ | 1 | (2-carboxy)propylammonium | — |
| P2(1)/c | else | (COOH(CH₂)₉NH₃)₂PbI₄ | 1 | (2-carboxy)butylammonium | — |
| P-1 | else | [C₂2H₂₀N₃S₄]₂PbI₄ | 1 | 2-[5-[4-methyl-5-[7-(3- | — |
| | | | | methylthiophen-2-yl)- | |
| | | | | 2,1,3-benzothiadiazol-4- | |
| | | | | yl]thiophen-2-yl]thiophen-2- | |
| | | | | yl]ethylammonium | |
| Pbca | else | [CH₃(CH₂)₃NH₃]₂PbI₄ | 1 | Butylammonium | — |
| Pbca | else | [CH₃(CH₂)₃NH₃]₂PbI₄ | 1 | Butylammonium | — |
| Pbca | RP | [CH₃(CH₂)₃NH₃]₂PbI₄ | 1 | Butylammonium | — |
| P42/mnm | RP | [CH₃(CH₂)₃NH₃]₂[CH₃NH₃]Pb₂I₇ | 2 | Butylammonium | Methyl- |
| | | | | | ammonium |
| P-1 | else | [C₆H₅(CH₂)₂NH₃]₂PbI₄ | 1 | Phenylethylammonium | — |
| P-2 | else | [C₆H₅(CH₂)₂NH₃]₂PbI₄ | 1 | Phenylethylammonium | — |
| P-3 | else | [C₆H₅(CH₂)₂NH₃]₂PbI₄ | 1 | Phenylethylammonium | — |
| P21 | DJ | [(CH₃)₃N(CH₂)₂NH₃]PbBr₄ | 1 | 2-trimethylammoniumethyl- | — |
| | | | | ammonium | |
| P22 | DJ | [(CH₃)₃P(CH₂)₂NH₃]PbBr₄ | 1 | (2- | — |
| | | | | aminoethyl)trimethylphosphanium | |
| P23 | DJ | [(CH₃)₃P(CH₂)₂NH₃]PbBr₄ | 1 | (2- | — |
| | | | | aminoethyl)trimethylphosphanium | |
| P-1 | else | [CH₃OC₆H₄(CH₂)₂NH₃]₂PbI₄ | 1 | Methoxyphenethylammonium | — |
| P21/c | else | [CH₃O(C₂H₄)(CH₂)₂NH₃]₂PbCl₄ | 1 | 2-(6-ethoxy-1,2,4,5-tetrazin-3- | — |
| | | | | yl)oxyethylammonium | |
| Pbca | RP | [CH₃O(CH₂)₃NH₃]₂PbBr₄ | 1 | γ-Methoxypropylammonium | — |
| P-1 | else | [₃-FC₆H₄CH₂CH₂NH₃]₂PbI₄ | 1 | 2-(3-fluorophenyl)ethylammonium | — |
| P-1 | else | [NH₃CH₂C₆F4CH₂NH₃]₂PbI₄ | 1 | 2,3,5,6-tetrafluoro-1,4- | — |
| | | | | benzenediammonium | |
| P21/c | else | [(CH₃)₂NHC₆H₄NH(CH₃)₂]₂PbBr₄ | 1 | N,N,N′,N′-Tetramethyl- | — |
| | | | | p-phenylenediammonium | |
| Cmmm | else | [HSC(NH₂)₂][CH₃NH₃]₂Pb₂I₇ | 2 | Protonated thioureacation | — |
| Imma | else | [HSC(NH₂)₂][CH₃NH₃]₃Pb₃I₁₀ | 3 | Protonated thioureacation | — |
| Imma | else | [HSC(NH₂)₂][CH₃NH₃]PbI₄ | 1 | Protonated thioureacation | — |
| P21/c | else | [C₅H₁₀N(CH₂)₂NH₃]PbI₄ | 1 | 2-(aminoethyl)piperidinium | — |
| P21/n | else | [C₅H₁₀N(CH₂)₂NH₃]PbI₄ | 1 | 2-(aminoethyl)piperidinium | — |
| Cc | else | [CH₃(CH₂)₄NH₃]₂[CH₃NH₃]₄Pb₅I₁₆ | 6 | Pentylammonium | Methyl- |
| | | | | | ammonium |
| Pm | else | [COOHC₆H₁₀CH₂NH₃]₂ | 3 | 4-Aminomethyl-1- | Ethyl- |
| | | [CH₃CH₂NH₃]Pb₃Br₁₀ | | cyclohexanecarboxylate | ammonium |
| Pmmn | else | [COOHC₆H₁₀CH₂NH₃]₂ | 3 | 4-Aminomethyl-1- | Ethyl- |
| | | [CH₃CH₂NH₃]Pb₃Br₁₀ | | cyclohexanecarboxylate | ammonium |
| Pmmn | else | [COOHC₆H₁₀CH₂NH₃]₂ | 3 | 4-Aminomethyl-1- | Ethyl- |
| | | [CH₃CH₂NH₃]Pb₃Brio | | cyclohexanecarboxylate | ammonium |
| Cmcm | else | [COOHC₆H₁₀CH₂NH₃]₂ | 3 | 4-Aminomethyl-1- | Ethyl- |
| | | [CH₃CH₂NH₃]Pb₃Br₁₀ | | cyclohexanecarboxylate | ammonium |
| Cmc21 | RP | [Br(CH₂)₃NH₃]₂[CH(NH₂)₂]Pb₂Br₇ | 2 | 3-bromopropylammonium | Forma- |
| | | | | | midinium |
| Cmcm | RP | [Br(CH₂)₃NH₃]₂[CH(NH₂)₂]Pb₂Br₇ | 2 | 3-bromopropylammonium | Forma- |
| | | | | | midinium |
| Cmcm | RP | [Br(CH₂)₃NH₃]₂[CH(NH₂)₂]Pb₂Br₇ | 2 | 3-bromopropylammonium | Forma- |
| | | | | | midinium |
| Pmc21 | RP | [Br(CH₂)₃NH₃]₂[CH(NH₂)₂]Pb₂Br₇ | 2 | 3-bromopropylammonium | Forma- |
| | | | | | midinium |
| Pmc21 | DJ | [NH₃C₆H₄NH₃][CH(NH₂)₂]₂Pb₃I₁₀ | 2 | 3-bromopropylammonium | Forma- |
| | | | | | midinium |
| Cc | else | [NH₃C₆H₄NH₃]₂PbI₄ | 1 | m-phenylenediammonium | Forma- |
| | | | | | midinium |
| Pc | DJ | [NH₃C₆H₄NH₃][CH(NH₂)₂]Pb₂I₇ | 2 | m-phenylenediammonium | Forma- |
| | | | | | midinium |
| C2/m | else | [IC₄₈NH₃]₂[CH₃NH₃]₂Pb₃I₁₀ | 3 | 4-iodobutylammonium | Methyl- |
| | | | | | ammonium |
| Pc | else | [IC₄₈NH₃]₂[CH₃NH₃]₂Pb₃I₁₀ | 3 | 4-iodobutylammonium | Methyl- |
| | | | | | ammonium |
| Pca21 | else | (C₂H₆N₂,CH₃NH₃)PbI₄ | 1 | Acetamidinium | Methyl- |
| | | | | | ammonium |
| P212121 | else | [C₉H₁₄N]₂PbBr₄ | 1 | Phenyl-2-methylethylammonium | — |
| P21 | else | [C₉H₁₄N,C₃H₁₀N]PbBr₄ | 1 | Phenyl-2-methylethylammonium | — |
| P21 | else | [C₉H₁₄N,C₄H₁₂N]PbBr₄ | 1 | Phenyl-2-methylethylammonium, | — |
| | | | | Butylammonium | |
| P21 | else | [C₉H₁₄N,C₄H₁₂N]PbBr₄ | 1 | Phenyl-2-methylethylammonium, | — |
| | | | | Butylammonium | |
| P21 | else | [C₉H₁₄N,C₃H₁₀N]PbBr₄ | 1 | Phenyl-2-methylethylammonium, | — |
| | | | | Propylammonium | |
| P21/m | else | [C₁₀H₁₈N₂]PbBr₄ | 1 | N,N,N′,N′-tetramethyl-1,4- | — |
| | | | | phenylenediammonium | |
| P21/c | else | I₄Sn•₂(C₂₂H₂₀NS₅)•C₇H₈ | 1 | Thienothiophene | — |
| Cc | else | I₄Sn•₂(C₂₂H₂₀NS₅)•CH₂Cl₂ | 1 | Thienothiophene | — |
| P21/c | else | ₂(C₂₂H₂₀NS₅)I₄Sn•C₆H₅Cl | 1 | Thienothiophene | — |
| C2/c | else | ₂(C₂₄H₂₀NS₆)I₄Sn | 1 | Dithienothiophene | — |
| I4/mmm | RP | [₄-C1-₂-FBA]PbBr₄ | 1 | 4-Chloro-2- | — |
| | | | | fluorobenzylammonium | |
| Pnma | else | [₄-C1-₂-FBA]PbBr₄ | 1 | 4-Chloro-2- | — |
| | | | | fluorobenzylammonium | |
| P-1 | else | [NH₃C₄H₈NH₃]₂PbI₄ | 1 | 1,4-butanediammonium | — |
| P-1 | else | (₃Me-PEA)₂PbI₄ | 1 | 2-(3- | — |
| | | | | Methylphenyl)ethylammonium | |
| P-1 | else | [PDAPbI₄]₁₅•[PDAI₂] | 1 | 1,3-propanediammonium | — |
| P21/c | else | (DMePDA)PbI₄ | 1 | N,N-dimethylpropane- | — |
| | | | | 1,3-diammonium | |
| I4/mmm | RP | (i-BA)₂(DMA)Pb₂Br₇ | 2 | Isobutylammonium | — |
| P21/c | DJ | (PDMA)PbI₄ | 1 | 1,4-phenylenedimethanammonium | — |
| P4/mbm | DJ | (PDMA)(MA)Pb₂I₇ | 2 | 1,4-phenylenedimethanammonium | — |
| I4/mcm | DJ | (PDMA)(MA)Pb₂I₇ | 2 | 1,4-phenylenedimethanammonium | — |
| Pbcn | else | (DFP)₂PbI₄ | 1 | 3,3-difluoropyrrolidinium | — |
| P212121 | DJ | (DFP)₂PbI₄ | 1 | 3-fluoropyrrolidinium | — |
| Pmmn | — | Cs₂Pb(SCN)₂Br₂ | 1 | Caesium | — |
| P21/c | else | (₃AMPY)(FA)Pb₂I₇ | 2 | 3-(aminomethyl)pyridinium | — |
| Cmc21 | else | (PTEA)₂PbI₄ | 1 | 1-(p-tolyl)ethylammonium | — |
| P1 | else | [(R)MPA]₂PbI₄ | 1 | β-methylphenethylammonium | — |
| P1 | else | [(S)-MPA]₂PbI₄ | 1 | β-methylphenethylammonium | — |
| P212121 | else | I₄Sn•C₁₅H₁₁N₂S₂•C₁₅H₁₃N₂S₂•C₆H₄Cl₂ | 1 | 2-(5-(thiophen-2-yl)thiophen-2- | — |
| | | | | yl)acetamidinium, DCB | |
| C2 | else | R-[BPEA]₂PbI₄ | 1 | R-1-(4- | — |
| | | | | bromophenyl)ethylaminium | |
| C2 | else | S-[BPEA]₂PbI₄ | 1 | S-1-(4-bromophenyl)ethylaminium | — |
| P21/c | else | S-[BPEA]₂PbI₄ | 1 | S-1-(4-bromophenyl)ethylaminium | — |
| Cmc21 | else | BA₂EA₂Pb₃I₁₀ | 3 | Butylammonium | Ethyl- |
| | | | | | ammonium |
| I4/mmm | RP | BA₂EA₂Pb₃I₁₀ | 3 | Butylammonium | Ethyl- |
| | | | | | ammonium |
| Cmmm | — | Cs₂[C(NH₂)₃]Pb₂Br₇ | 2 | Guanidinium | Cs |
| P-1 | else | (₃AP)PbI₄ | 1 | 3-amidinopyridinium | — |
| C2/c | else | (₃AP)PbBr₄ | 1 | 3-amidinopyridinium | — |
| C2/c | else | (₃AP)PbCl₄ | 1 | 3-amidinopyridinium | — |
| P21/c | RP | (PA)PbI₄ | 1 | Propylammonium | — |
| P21/c | RP | (AA)2MA₂Pb₃I₁₀ | 3 | Allylammonium | Methyl- |
| | | | | | ammonium |
| P21/c | else | (IdPA)₂MA₂Pb₃I₁₀ | 3 | 2-iodopropylammonium | Methyl- |
| | | | | | ammonium |
| Cc | RP | [(AA)ₓ(IdPA)₁-ₓ]₂MAPb₂I₇ | 2 | Allylammonium | 2- |
| | | | | | iodopropyl- |
| | | | | | ammonium |
| P21/c | else | (IdPA)₂PbI₄ | 1 | 2-iodopropylammonium | — |
| P21/c | else | (AA)₂MA₂Pb₃I₁₀ | 3 | Allylammonium | Methyl- |
| | | | | | ammonium |
| P-1 | DJ | (AA)₁₂(MA)₂Pb₉I₃₂ | 2 | Allylammonium | Methyl- |
| | | | | | ammonium |
| P212121 | else | (AA)₃Pb₂I₇ | 1 | Allylammonium | |
| C2/c | else | (IdPA)₂MAPb₂I₇ | 2 | 2-iodopropylammonium | Methyl- |
| | | | | | ammonium |
| P21212 | else | (R)-C₆H₁₆N₂PbBr₄ | 1 | (1R,2R)-(−)-1,2- | — |
| | | | | Cyclohexanediammonium | |
| P21212 | else | (S)-C₆H₁₆N₂PbBr₄ | 1 | (1S,2S)-(+)-1,2- | — |
| | | | | Diaminocyclohexane | |
| Pbca | RP | (C₁₁H₂₃NH₃)₂PbI₄ | 1 | Undecylammonium | — |
| P212121 | else | (C₁₁H₂₃NH₃)₂PbI₄ | 1 | Undecylammonium | — |
| Pbca | RP | (C₁₁H₂₃NH₃)₂PbI₄ | 1 | Undecylammonium | — |
| P21/c | else | (C₁₃H₂₇NH₃)₂PbI₄ | 1 | Tridecylammonium | — |
| P21/c | RP | (C₁₃H₂₇NH₃)₂PbI₄ | 1 | Tridecylammonium | — |
| P212121 | else | (C₁₃H₂₇NH₃)₂PbI₄ | 1 | Tridecylammonium | — |
| P21/c | else | (C₁₅H₃₁NH₃)₂PbI₄ | 1 | Pentadecylammonium | — |
| P212121 | else | (C₁₅H₃₁NH₃)₂PbI₄ | 1 | Pentadecylammonium | — |
| C2/c | else | (C₈H₁₁FN)₂PbBr₄ | 1 | 4-fluorophenethylammonium | — |
| P21/c | else | (MACH)₂PbI₄ | 1 | Cyclohexanemethylammonium | — |
| Pbca | RP | (BA)₂PbBr₄ | 1 | Butylammonium | — |
| Cmce | RP | (BA)₂PbBr₄ | 1 | Butylammonium | — |
| Cmce | RP | (MACH)₂PbI₄ | 1 | Cyclohexanemethylammonium | — |
| Pmc21 | else | [(CH₃)₂CH(CH₂)₂NH₃]₂(CH₃NH₃)₂Pb₃Cl₁₀ | 3 | Butylammonium | Methyl- |
| | | | | | ammonium |
| I4/mmm | RP | [(CH₃)₂CH(CH₂)₂NH₃]₂(CH₃NH₃)₂Pb₃Cl₁₀ | 3 | Butylammonium | Methyl- |
| | | | | | ammonium |
| Cmc21 | else | (IA)₂(EA)₂Pb₃Br₁₀ | 3 | Isoamylammonium, | — |
| | | | | Ethylammonium | |
| P21/c | else | (PREA)₂PbI₄ | 1 | Ethylammonium pyrene | — |
| Pnma | else | (HCya)₂PbI₄ | 1 | Tioethylammonium | |
| Cc | else | (FPEA)₂(MA)Pb₂I₇ | 2 | 4-fluorophenethylammonium | Methyl- |
| | | | | | ammonium |
| P212121 | else | (MPA)₂PbI₄ | 1 | β-methylphenethylammonium | — |
| Pbca | else | [C₇N₂H₁₈]PbBr₄ | 1 | Propylpiperazinium | — |
| C2/c | else | [_{1,3}-C₆H₁₀N₂]PbBr₄ | 1 | 1,3-phenylenediammonium | — |
| P-1 | else | [_{1,4}-C₆H₁₀N₂]PbBr₄ | 1 | 1,4-phenylenediammonium | — |
| P21/c | DJ | [_{1,4}-C₈H₁₄N₂]PbBr₄ | 1 | 1,4-xylylenediammonium | — |
| P-1 | else | [C₆H₄CH₂CH₂NH₃]₂GeBr₄ | 1 | Phenylethylammonium | |
| Pna21 | else | [BrC₆H₄CH₂CH₂NH₃]₂GeBr₄ | 1 | 2-bromophenylethylammonium | — |
| P21/c | else | [FC₆H₄CH₂CH₂NH₃]₂GeBr₄ | 1 | 2-fluorophenylethylammonium | — |
| (P21/n) | | | | | |
| P-1 | else | [C₆H₄CH₂NH₃]₂GeBr₄ | 1 | Benzylammonium | — |

The ink may include 2D perovskite crystals in an amount ranging from 0.1 to 20 mol %, this amount being based on (B) the metal halide concentration, such as from a lower limit of any of 0.1, 0.5, 1, 5 or 10 mol % to an upper limit of any of 12, 15, 17, or 20 mol %, where any lower limit may be mathematically paired with any upper limit.

According to one or more embodiments, the spacer cation A′, also referred to as the interlayer cation, may be any of those recited in Table 1, and in particular embodiments may be selected from the group consisting of butylammonium (BA), pentyl ammonium (PA), hexyl ammonium, heptyl ammonium, phenyl ethyl ammonium (PEA), octyl ammonium (OA), 4-aminomethyl piperidine (4AMP), 3-aminomethyl piperidine (3AMP), 3-(aminomethyl)pyridine (3AMPY), butyldiamine (BDA) and combinations thereof.

In the formulae described above, the intralayer cation A may be any cation described in Table 1, and in particular embodiments may be selected from dimethylammonium, formamidinium (FA), cesium (Cs), guanidinium (GA) and combinations thereof. Furthermore, λ is a monovalent anion such as a halide or pseudohalide as defined above. In particular embodiments, X may be selected from iodide, bromide, chloride and combinations thereof. B in the above formulae is a divalent metal and in particular embodiments is selected from lead, germanium, bismuth, copper, silver, gold, gallium, indium, antimony, or tin.

While any of the perovskites described in Table 1 may be used as seed crystals, in particular embodiments, suitable 2D perovskite precursors include but are not limited to BA₂PbI₄ and BA₂FAPb₂I₇.

The 2D perovskite crystals may be made using techniques known in the art. Briefly, precursors (e.g., lead oxide, formamidine hydrochloride, and butylamine) may be dissolved in an acidic solution (e.g., a mixture of hydrochloric and hypophosphorous acids) and stirred at an elevated temperature to dissolve the precursors. Then, the solution may be cooled to room temperature, and 2D crystals with sizes ranging from micrometers to millimeters precipitate out of solution.

As noted above, the ink may also include a solvent. According to one or more embodiments, the solvent may be selected from DMF, DMSO or mixtures thereof. For mixtures, the amount of DMF and DMSO may be any suitable ratio in the range of 1:1 to 9:1 DMF:DMSO.

The ink described herein may be made by any suitable methods known in the art. For example, each of the above-described components may be combined with an appropriate amount of solvent and mixed (e.g., via stirring) until the components are dissolved/suspended in the solvent. Mild heating may be used as needed. The ink described herein may also be referred to as a “seed solution” meaning a solution that includes the 2D seed crystals herein. As is understood by those of ordinary skill, an ink is generally a colored liquid material that is used for writing and printing. In some particular fields, it includes a suspension or dispersion of solid nanocrystals. The nanocrystals are stable, meaning they do not settle or precipitate out of solution for reasonable periods of time (hours to days/weeks/months). In the present disclosure, the nanocrystals are the 2D perovskites. As such, the ink may be considered a nanocrystal ink. The ink may be used in printing applications including spin-coating, slot-die coating, blade-coating, ink-jet printing, thermal evaporation (e.g., sublimation printing).

As noted above, methods described herein include depositing the ink onto a substrate. According to one or more embodiments, the ink may be deposited using any suitable method which may include to spin-coating, doctor blading, drop casting, and drop-die coating techniques.

When a perovskite material is printed into a film form, such as by the depositing step described herein, annealing may be required to aid in completely crystallizing the as-deposited film for improved optical and electrical properties in, for example, a photovoltaic (PV) application. Annealing may comprise applying heat above room temperature, commonly above 25° C. (thermal annealing), washing with one or more solvents (solvent annealing), exposing to a UV, visible and/or IR light source (photonic annealing).

Once a suitable amount of the ink has been deposited onto the substrate, the substrate may be annealed to form a 3D perovskite film. The annealing may be conducted at a suitable temperature for a suitable time to form the 3D film. The temperature may range from room temperature to 200° C., such as from a lower limit of any one of 25, 30, 35, 45, 55 or 65° C., to an upper limit of any one of 70, 80, 90, 120, 150 or 200° C., where any lower limit may be paired with any upper limit. The annealing time may range from about 20 minutes to several hours, such as from a lower limit of any one of 20, 40 or 60 minutes to an upper limit of any one of 2, 3, 4, or 7 hours, where any lower limit may be paired with any upper limit. After annealing, the perovskite film may be formed. An exemplary perovskite film formed from the methods described herein is a 3D structured FAPbI₃.

The exemplary FAPbI₃ perovskite may be stabilized using 2D n=1 Ruddlesden popper perovskite using a seed-based templating approach. The 2D n=1 or n=2 perovskite with different organic cations as described above may stabilize the formamidinium-based 3D perovskite. The lattice mismatch between the 2D and 3D perovskites may be used to minimize the 2D-3D interfacial energy and to encourage growth of the 3D phase via templating. When a pure FAPbI₃ precursor solution is brought in contact with the 2D perovskite, the black phase (α-FAPbI₃) forms preferentially at 100° C., much lower than the standard FAPbI₃ annealing temperature of 150° C. X-ray diffraction and optical spectroscopy suggest that the resulting FAPbI₃ film compresses slightly to acquire the (011) interplanar distances of the 2D perovskite seed. More details regarding the crystal growth mechanisms are provided in the examples below.

In another aspect, embodiments disclosed herein relate to a perovskite seed crystal solution. The perovskite seed crystal solution is as previously described.

In another aspect, embodiments disclosed herein also relate to a device including a perovskite film formed from the methods described above. The device includes a perovskite heterostructure including a substrate and a perovskite film on the substrate. The method described above may be used to form the perovskite film for the device. As such, the perovskite film of the device may be formed from a precursor solution. As a non-limiting example, a ink as described above may be used to form a 3D stabilized perovskite film comprising FAPbI₃ or other perovskites described herein.

In one or more embodiments, perovskite heterostructures may exhibit properties desirable for use in solar cells or other optoelectronic devices including light-emitting diodes, radiation detection, field-effect transistors, lasing or any suitable device that includes a semiconductor. As noted above, the method disclosed herein may provide a stabilized 3D perovskite film that possesses a low band gap of ˜1.48 eV. As a result, the devices disclosed herein may include a perovskite film with an optimal band gap for perovskite solar cells. In one or more embodiments, the solar cell device may include a substrate, an electron transport layer, a 3D perovskite film, a hole transport layer, and an indium doped tin oxide layer.

According to one or more embodiments, the device may be an optoelectronic device including a solar cell. For example, a perovskite solar cell including a disclosed solution-processed perovskite heterostructure may have an efficiency of 23.5% giving a high open-circuit voltage (VOC) of 1.2 V in a regular n-i-p device (where n refers to an electron transporting layer, i refers to an active material and p refers to a hole transporting layer). Additionally, in a perovskite solar cell including the above exemplary perovskite heterostructure, a high ISOS-L1 photostability may be observed when encapsulated, with T₉₉> of about 1000 hours. The T₉₉ relates to the percent efficiency of the solar cell retained after certain hours of durability testing. Herein, T₉₉> of about 1000s hour describes that under constant illumination using simulated solar light, the photovoltaic device retained more than 99% of its original efficiency after 1000 hours.

The thickness of the perovskite film may range from 1 nm to 1 μm. The device may have an interface transition between the substrate and the perovskite film ranging from 1 to 30 nm. This process may be compatible with other large-scale thin film processing techniques, such as doctor blading, drop casting, and slot-die coating.

### EXAMPLES

### General Procedures—Methods and Characterization

### 1.1 High Purity 2D Perovskite Powder Synthesis

The 2D Ruddlesden-Popper perovskite parent crystals, BA₂FAPb₂I₇ were synthesized by combining the lead oxide (PbO, Sigma Aldrich, 99%), formamidine hydrochloride (FACl, Sigma Aldrich, ≥98%), and butylamine (BA, Sigma Aldrich, 99.5%) in precise stoichiometric ratios. This mixture was dissolved in a solution of hydroiodic acid (HI, 57 wt % in H₂O) and hypophosphorous acid (H₃PO₂, 50% in H₂O) and stirred at a temperature of 240° C. until complete dissolution of the precursor materials and boiling of the solution occurred. Subsequently, the precursor solution was allowed to cool down to room temperature, resulting in the crystallization of flat single crystals with sizes ranging from micrometres to millimetres. To ensure the quality and phase purity of the synthesized crystals, we performed a comprehensive analysis using a combination of X-ray diffraction and absorbance measurements.

1.2 Åir-Liquid Interface Method for Single Crystal Growth of BA₂FAPb₂I₇

To synthesize large-area 2D Ruddlesden-Popper perovskite crystals, BA₂FAPb₂I₇, we combine lead oxide (PbO, Sigma Aldrich, 99%), formamidine hydrochloride (FACl, Sigma Aldrich, ≥98%), and butylamine (BA, Sigma Aldrich, 99.5%) in precise stoichiometric ratios. This mixture is dissolved in a solution of hydroiodic acid (HI, 57 wt % in H₂O) and hypophosphorous acid (H₃PO₂, 50% in H₂O), and stirred at a temperature of 240° C. until the precursor materials completely dissolve and the solution begins to boil. Subsequently, the solution is kept at a temperature of 100° C. without stirring. A clean glass is introduced at the bottom of the vial, allowing the large-area crystals to form at the air-liquid interface. Once the crystal has formed, the glass is carefully extracted from the vial using forceps, with the slightest movement aiding in scooping up the formed crystals. The resulting film on the glass is washed with ether and annealed at a temperature of 125° C. to remove any trapped solvents in the crystals.

### 1.3 Solar Cell Fabrication

Inverted planar perovskite solar cells: The patterned glass/ITO substrates underwent a sequential cleaning process involving ultrasonication in soap water, followed by deionized water, acetone, and a mixture of acetone and ethanol (1:1), each for 15 minutes. After drying the substrates and subjecting them to 30 minutes of UV-ozone cleaning, they were transferred to a glove box. Inside the glove box, a hole-transporting layer (HTL) with a thickness of approximately 10 nm was created using the SAMs layer (MeO-2PACz, TCI, America) at a concentration of 0.8 mg/ml in Ethanol. The HTL was deposited by spin coating at 5000 rpm for 30 seconds, followed by annealing at 100° C. for 10 minutes.

To prepare the FAPbI₃ perovskite precursor solution with a concentration of 1.0 M, the PbI₂, and FAI, were mixed in a solvent mixture of DMF and DMSO (6:1). The solution was continuously stirred for 4 h, following which various mol % of the formamidinium based 2D perovskite, A′2 Fan+1PbₙI₃ₙ₊₁, where A′ stands for different bulky organic cations such as butylammonium, and pentylammonium etc, was introduced and left for aging on the hot plate at 70° C. for 30 min. A single-step spin coating process was employed to achieve a uniform coverage of the perovskite film by spin coating the solution at 5000 rpm for 30 seconds with an acceleration of 2500 rpm/s. The samples were subsequently annealed at 150° C. for 20 minutes. Lastly, the devices were completed by thermal evaporation of C60 (30 nm), BCP (1 nm), and Copper (100 nm) under a vacuum of less than 2×10⁻⁶ torr. The active area selected for the devices was 0.5 cm².

### 1.4 Optical Absorbance and Photoluminescence Measurements

Thin film absorbance measurements: Film absorbance measurements were carried out using a setup that involved illuminating the samples with modulated monochromatic light at a frequency of 2 kHz. The light was generated by a quartz-tungsten-halogen light source and passed through a monochromator (SpectraPro HRS 300, Princeton Instruments). To detect the transmitted light, synchronous detection was employed using a silicon photodiode connected to an SR865 lock-in amplifier. The measurements were conducted in the spectral range of 400-800 nm, with a dwell time of 0.1 s for each data point. Throughout the experiment, the samples were maintained under vacuum conditions of approximately 10⁻⁴ torr and kept at room temperature.

Steady-state photoluminescence measurements: Thin-film photoluminescence (PL) measurements were performed using a lab-built confocal microscopy system to acquire steady-state photoluminescence (SS-PL) data. Spectra were collected using an Andor Kymera 329i spectrometer and an Andor iDus 416 CCD detector. The acquired spectra were then processed using Savitzky-Golay filtering for optimal signal-to-noise ratio. For photoexcitation, the samples were illuminated with a monochromatic pulsed laser emitting at 2.58 eV (480 nm). The laser, with a pulse duration of 6 ps and a repetition rate of 78.1 MHz, was focused near the diffraction limit, achieving a resolution of approximately 0.5 μm. The excitation intensity was carefully adjusted to 360 W/cm². PL measurements were conducted in the spectral range of 450-900 nm with a dwell time of 0.1 s. The experiments were performed under vacuum conditions (10⁻⁵ torr) at room temperature. PL maps were acquired by scanning a region of either 40 μm×40 μm or 100 μm×100 μm, using a step size of 1 μm. At each step, the peak position of the photoluminescence signal was extracted and recorded for further analysis.

### 1.5 Time-Resolved Photoluminescence (TRPL) Measurements

Time resolved photoluminescence (TRPL) measurements were performed by exciting the samples with various fluence laser pulse (420 nm, 40 fs pulse duration and 100 kHz repetition rate). These laser pulses are generated by frequency doubling the laser pulse from diode-pumped Yb:KGW femtosecond laser system (PHAROS) using barium-beta-borate crystal. This laser pulse (beam spot size of 20 μm) was then focused onto sample with a 3.8 mm focal length lens. The emitted light was then collected using a Mitutoyo objective lens (numerical aperture=0.7, magnification=100×) from the transmission side and subsequently spatially filtered using a mechanical iris located at the conjugate plane. Elastically scattered light was rejected by using a long pass filter (wavelength 650 nm, optical density=6.0). Additionally, bandpass filter centered at 800 nm (wavelength=800±20 nm, optical density=4.0) was employed to filter the emitted light. The emitted light was then focused onto the Micro Photon Device (MPD) PDM series single-photon avalanche photodiode with an active area of 50 μm. The temporal resolution was set at a binning size of 64 ps. Photoluminescence spectra were collected by directing the emitted light towards a spectrometer using a flippable mirror.

### 1.6 Ultrafast Transient Absorption Spectroscopy

Time-resolved absorption (TA) data of the samples were obtained using transient femtosecond pump-probe spectroscopy. The samples were excited by 420 nm laser pulse generated by using an optical parametric amplifier having a pulse duration of 40 fs and a beam spot size of 120 μm. Diode-pumped Yb:KGW femtosecond laser system based on the principle of chirped-pulse amplification (PHAROS) produces light pulses centered at 840 nm. These laser pulses were then passed through 0.5 mm thick barium-beta-borate crystal where the frequency will be doubled to produce laser pulses centered at 420 nm acting as pump pulse. These laser pulses are focused on the sample with a spot size of 120 μm in diameter (1/e²). Another laser pulse from the amplifier is focused onto a sapphire crystal to produce white-light supercontinuum that acts as a probe pulse. The optical path length between pump and probe is manipulated by passing the probe beam through a retroreflector mounted on high precision motorized translational stage. Probe pulse (beam diameter 35 μm) was then focused and spatially overlapped with the pump pulse onto the sample. It is then re-collimated and directed onto a multi-mode fibre for wavelength-sensitive detection.

### 1.7 X-Ray Diffraction Measurements

1D X-ray diffraction of the 3D perovskite thin films were measured in the 20 between 2° and 30°, with a step of 0.010 and a speed of 2°/min, using a Rigaku SmartLab X-Ray diffractometer with Cu(Kα) radiation (λ=1.5406 Å). For lattice parameter determination, thin films were scraped with a blade and wiped onto a glass slide to remove any residual strain from the substrate. The scraped films were then coated with a thin film of PMMA to prevent α→δ conversion during XRD measurement in air. Single crystal X-Ray diffraction of the 2D perovskite crystals was taken with a Rigaku Synergy-S diffractometer using a Mo target. The temperature was held at 300K.

### 1.8 Differential Scanning Calorimetry (DSC) Measurements

FAPbI₃ powders for DSC were prepared by spin-coating 300 μL of FAPbI₃ precursor solution onto a large-area (25 cm²) substrate, drying at room temperature under vacuum, and scraping with a blade. DSC was performed using a TA DSC 250 with a scan rate of 1° C./min.

### 1.9 Nuclear Magnetic Resonance (NMR) Measurements

FAPbI₃ powders for NMR were prepared by spin-coating 300 μL of FAPbI₃ precursor solution onto a large-area (25 cm²) substrate, annealing, and scraping with a blade. Powders were dissolved in 600 μL of deuterated DMSO. Liquid-state ¹H NMR was performed on a 600 MHz Bruker NEO Digital NMR Spectrometer. A higher BA n=2 concentration of 5 mol % was employed to better resolve the butylammonium signal. For solid-state NMR measurements, thin films of control 2D and 2D-doped FAPbI₃ were deposited on glass substrates, scraped with a blade, and collected as a powder. A higher 2D n=2 concentration of 10 mol % was employed to better resolve the spacer cation signal. To minimize the material degradation during solid-state NMR data collection, the materials were separately packed into air-tight and opaque zirconia rotors (1.3 mm, outer diameter) fitted with VESPEL caps. All ex-situ solid-state MAS NMR experiments were conducted at 21.1 T (Larmor frequency of ¹H=900 MHz). The MAS frequency was 50 kHz in all ssNMR experiments. 1D ¹H MAS NMR spectra were acquired by co-addition of 16 transients. An interscan delay was set to 45 s, as determined from saturation recovery measurements and analyses, to ensure the full Ti relaxation and hence the quantitative proton peak intensities. 2D ¹H-¹H spin diffusion NMR experiments were acquired using a three-pulse NOESY-like sequence with different mixing times for the α-FAPbI₃-low dimensional phase (BA or PA). A rotor-synchronized increment of 20 ps was applied to detect 400 t1 increments, each with 2 co-added transients. For all materials, the ¹H experimental shift was calibrated with respect to neat TMS using adamantane as an external reference (¹H resonance, 1.81 ppm).

From 1D ^{I}H ssNMR spectra of precursor compounds, control 2D materials and 2D-doped FAPbI₃ materials, the ¹H peaks corresponding to the different organic cations can be identified and distinguished. For reference, the ¹H signals of the FA⁺ is attained (blue boxes), and BA⁺ signals in the BA-stabilized perovskite can be found in the orange box, and PA+ signals in the PA-stabilized perovskite are presented in the purple box. The origin of these signals is further corroborated by acquiring the ¹H ssNMR spectra of neat 2D BA₂FAPb₂I₇ and PA₂FAPb₂I₇ phases. The comparison of the ¹H peak integrals associated with the of FA⁺ and BA⁺ suggests that there is ˜6 mol % of 2D phase present in the 3D phase, which is estimated to be ˜7 mol % for the 2D PA₂FAPb₂I₇ doped material.

To gain insights into the local proximities between the BA cations and the FA cations in the 2D BA₂FAPb₂I₇/PA₂FAPb₂I₇ doped FAPbI₃ phases, 2D ¹H-¹H spin-diffusion (SD) NMR experiments were carried out and analyzed. Specifically, magnetization exchange between dipolar coupled spins (here protons) allows the through-space proximities between neighboring sites, for example, information on through-space ¹H-¹H proximities in different organic cations to be probed. In 2D ¹H-¹H SD spectra, the on-diagonal peaks provide information on chemical shifts and the off-diagonal peaks contain information on spin magnetization exchange between chemically inequivalent spins. For both BA and PA-stabilized 3D phases, a mixing delay of 50 ms was insufficient to produce off-diagonal peaks, but a mixing delay of 500 ms leads to the magnetization exchange between the ¹H sites in in BA⁺ (orange), FA⁺ (blue) and between BA⁺/FA⁺ (green) and PA+/FA⁺ (gray regions) as seen in green and gray boxes, respectively. These peaks indicate the coexistence of a mixed 2D/3D phase. Relatively strong intensity peaks observed for the BA-stabilized FAPbI₃ phase suggesting that the high degree of mixing of 2D phase within the 3D phase, as compare to the PA-stabilized FAPbI₃. In addition, the peaks with in the purple and orange boxes indicate the close proximities between the proton sites within PA and BA cations respectively.

### 1.10 Time-of-Flight Secondary Ion Mass Spectrometry (ToF-SIMS) Measurements

Positive high mass resolution depth profiles were conducted using a combined TOF-SIMS NCS instrument, which integrates a TOF·SIMS instrument (ION-TOF GmbH, Münster, Germany) and an in-situ Scanning Probe Microscope (NanoScan, Switzerland) at the Shared Equipment Authority from Rice University. The analysis field of view covered an area of 80×80 μm² (Bi³⁺ at 30 keV, 0.35 pA) with a raster of 128×128 during the depth profile. To compensate for charge effects, an electron flood gun was employed throughout the analysis. The charge effects were adjusted using a surface potential of −36V and an extraction bias of 0 V.

The cycle times were set at 90 s, corresponding to a mass range of m/z=0-735 a.m.u. During sputtering, a raster of 450×450 μm² was used (Cs⁺@1 keV, 44 nA). The beams operated in a non-interlaced mode, alternating between 1 analysis cycle and 1 frame of sputtering (taking approximately 1.31s), followed by a 2-second pause for charge compensation. To enhance the understanding of the data, MCsⁿ⁺ (n=1, 2) depth profiling was also employed. This method is particularly useful for quantifying alloys and identifying ion compounds. The cesium primary beam was utilized for sputtering during the depth profile, enabling the detection of MCs⁺ or MCs²⁺ cluster ions, where M represents the element of interest combined with one or two Cs atoms. The use of MCs⁺ and MCs²⁺ ions in ToF-SIMS analysis offers several advantages, including the reduction of matrix effects and the ability to detect compounds containing both electronegative and electropositive elements. All depth profiles were point-to-point normalized based on the total ion intensity, and the data were plotted using a 5-point adjacent averaging. The normalization and smoothing techniques facilitated a better comparison of the data obtained from different samples. Depth calibrations were established by measuring the thicknesses using a surface profiler, which generated a line scan of the craters using in-situ SPM through contact scanning.

### 1.11 In-Situ WAXS Measurements for FAPbI₃ Film Formation

The experimental setup took place in a custom-made analytical chamber located at the 12.3.2 microdiffraction beamline of the Advanced Light Source. This specialized chamber was designed to accommodate various measurements and processes simultaneously, including the handling of thin films. The indium-doped tin oxide substrate, which had been cleaned using plasma, was securely positioned on the integrated spin coating puck-heater and affixed with a heat transfer paste. To initiate the deposition process, a liquid precursor containing 1 M PbI₂ and formamidinium in a solvent mixture of 6:1 DMF:DMSO was carefully pipetted onto the substrate's surface. To maintain a controlled environment, the chamber was sealed off from the external surroundings and kept under a continuous nitrogen flow. The experiment proceeded by subjecting the precursor to spin coating, which involved two steps: the first spin coating was carried out at 4000 rpm for 30 s to create a thin film. During the second spin coating step, precisely 10 s into the process, a remotely controlled pipette dispensed a stream of ethyl acetate. After the completion of the spin coating protocol, a remote heating protocol was initiated. A nonlinear stepwise annealing sequence was applied, in which the substrate temperature was increased by steps of 20° C. in 20 sec intervals up to 100° C. and then increased by steps of 25° C. up to 150° C. The temperature was then maintained at 150° C. for the duration of the experiment, which lasted until t=300 s. The incident X-ray beam was directed at an incidence angle of 1° with a beam energy of 10 keV. The distance between the sample and detector, known as the sample detector distance (SDD), was approximately 155 mm. The detector itself was positioned at an angle of 39° relative to the sample plane. WAXS (wide-angle X-ray scattering) data were acquired with an exposure time of 1.0 s and an additional pause of 0.8 s (total 1.8 s) between measurements using a 2D Pilatus 1 M detector (Dectris Ltd.). Photoluminescence excitation was achieved by utilizing a 532 nm Thorlabs diode-pumped solid-state laser with a power density of 40 mW/cm². The resulting photoluminescence signal was collected by a lens, directed into an optical fiber, and transmitted to a grating OceanOptics QE Pro spectrometer for detection. To regulate the annealing temperature and protocol, a pre-calibrated Raytek MI3 pyrometer recorded the temperature of the heating puck. The temperature control system utilized a pre-programmed PID loop.

Calibration of peak positions during heating: The heat transfer paste holding the substrate is known to expand with temperature, changing the height of the substrate slightly. A change in height also changes the sample-detector distance and the direct beam position with respect to the detector, giving the illusion that peaks are shifting towards higher q-values as temperature increases. It is best practice to correct for this height change over the temperature ramping with regards to the principal ITO peak at q=2.15 Å-1. However, this peak overlaps with the (112) diffraction peak from the FAPbI₃ δ-phase, which emergers once the antisolvent is deposited and persists during temperature ramping. Instead, we compared the position of the principal ITO peak at room temperature before antisolvent dropping with its position at 150° C. after the δ-phase had converted to α-phase. We assumed a linear relation between temperature and change in substrate height, which allowed us to use the in-situ temperature data to correct for this peak shift during temperature ramping.

### 1.12 Dynamic Light Scattering (DLS) Measurements

Experimental methods: The solutions of FAPbI₃+BA₂FAPb₂I₇ perovskites were prepared by dissolving precursors and high purity crystal powders in DMF as described in section S1.3 and adding 5 and 10 mg of n=2 BA₂FAPb₂I₇. The prepared solutions were loaded into cylindrical glass cuvettes (Wilmad® NMR tubes 5 mm diam., high throughput. 103 mm length). Dynamic Light Scattering (DLS) measurements were performed immediately by capturing correlation curves at four different angles: 60°, 90°, 120°, and 150°. The measurements were conducted at an ambient temperature of 20° C. using a fully automated 3D LS Spectrometer (LASER: 660 nm, 65 mW, LS Instruments AG, Fribourg). Each angle was measured in triplets. Extraction of the size of the particles in solution: Below is a detailed description of the analysis conducted on the multi-angle Dynamic Light Scattering (DLS) data obtained from various concentrations of precursor solutions. The autocorrelation curves were measured for each solution to examine their angular dependence. These correlation curves were then fitted using a single-exponential decay model. The residuals resulting from the correlation fitting were measured and plotted. Furthermore, a linear regression of Γ versus q2 was performed, focusing on the range between 60° and 150°. The scattered light correlation function, g⁽²⁾, compares the intensity of received signal between time t and later time t+τ, (5)

$${g}^{( 2 )} ( q , τ ) = \frac{< I ( t ) I ( t + τ ) >}{< {I ( t )}^{2} >} \qquad ( 2 )$$

Using the Siegert relationship that relates the field correlation function and intensity correlation function given by (6)

$${g}^{( 2 )} ( q , τ ) − 1 = β {\vert {g}^{( 1 )} ( q , τ ) \vert}^{2} \qquad ( 3 )$$

where β is a constant proportional to the signal-to-noise ratio.

For a system undergoing Brownian motion the electric field correlation function is shown to decay exponentially as

$${g}^{( 1 )} ( q , τ ) = exp ( - Γτ ) \qquad ( 4 )$$

When several groups of particles with different sizes (labelled i) are present in solution, the DLS data can be fitted using (δ)

$${g}^{( 2 )} ( q , τ ) − 1 = {\sum }_{i}^{} {α}_{i} {\vert {g}_{i}^{( 1 )} ( q , τ ) \vert}^{2} = {\sum }_{i}^{} {α}_{i} {\vert exp ( − {Γ}_{i} τ ) \vert}^{2} \qquad ( 5 )$$

Then, for the group of particles i the value Γᵢ is related to the translational diffusion coefficient D_{T,i} and wave number q through

$${Γ}_{i} = {D}_{T , i} {q}^{2} \qquad ( 6 )$$

with,

$$q = \frac{4 π η}{λ} sin ( \frac{θ}{2} ) \qquad ( 7 )$$

η is the refractive index of the solvent, λ is the wavelength of the laser, and θ the angle between the incident laser beam and the scattered light. Finally, the diffusion coefficient is related to the hydrodynamic radium R_{H} of the particles in a Brownian motion by the Stokes-Einstein equation (7)

$${D}_{T , i} = \frac{{k}_{B} T}{6 πμ {R}_{H , i}} \qquad ( 8 )$$

with k_{B} is the Boltzmann constant, T the temperature, μ the dynamic viscosity, and R_{H,i} the median hydrodynamic radium of the group i of particles.

### 1.13 Nano X-Ray Diffraction Measurements.

Nano X-ray Diffraction measurements were taken at the hard X-ray nanoprobe at Sector 26 ID-C of the Advanced Photon Source at Argonne National Laboratory. Samples were fabricated on X-ray transparent silicon nitride (Norcada, part no. NX5050D) windows for measurement in transmission geometry, enabling measurements at near-normal incidence and minimizing beam projection on the sample surface. Measurements were taken at 9.6 keV incident X-ray energy using an X-ray probe with a full width at half maximum of approximately 25 nm focused using a Fresnel zone plate and order-sorting aperture to minimize the probe broadening contribution of higher order diffraction. Diffraction patterns were collected with a zero-noise diffraction CCD. Diffraction patterns were recorded using a Dectris Eiger2 single photon counting detector with 75 μm pixel width and angular resolution ranging from 0.018-0.023° per pixel at low and high two theta, respectively. Dwell times of 0.1 s per point were used to generate nano-diffraction maps. The X-ray diffraction pattern remained consistent for many seconds of X-ray irradiation at a single point, as determined by measuring X-ray diffraction patterns over time for all samples.

### 1.14 Grazing Incidence Wide Angle X-Ray Scattering

Experimental methods: The GIWAXS (grazing-incidence wide-angle X-ray scattering) measurements presented in this paper were conducted at two different synchrotron beamlines: 8-ID-E at the Advanced Photon Source (APS) and 11-BM at the National Synchrotron Light Source-II (NSLS II). For experiments performed at beamline 8-ID-E, the samples were positioned on a specialized Linkam grazing incidence x-ray-scattering (GIXS) stage placed inside a vacuum chamber with a pressure of 10⁻⁴ torr. The Pilatus 1M (Dectris) area detector was situated approximately 228 mm away from the sample. A photon energy of 10.91 keV was employed, and the X-ray beam had a size of 200 μm×20 μm (horizontal×vertical). On the other hand, experiments at beamline 11-BM utilized a robotic stage within a vacuum chamber maintained at a pressure of 6×10⁻² torr. The sample-to-detector distance was approximately 267 mm, and the Pilatus 800K (Dectris) area detector was employed. The photon energy used was 13.5 keV, and the X-ray beam had dimensions of 200 μm×50 μm (horizontal×vertical).

In-situ GIWAXS during degradation was performed using a solvent vapor annealing chamber in the open sample staging area at 11-BM. The measurement beam entered and exited the chamber through Kapton windows on either side. For high-humidity measurements, liquid water was added to the bottom of the chamber to fix the atmosphere at >90% RH. For illuminated measurements, AM1.5G light entered the chamber from the top through a glass window. For heated measurements, a resistive heating element below the sample controlled the chamber temperature.

GIWAXS analysis: To analyze the GIWAXS patterns, a full angular integration was conducted to obtain a 1-D X-ray spectrum. The Debye-Scherrer formula was employed to determine the average grain size (Dₕₖₗ) of the perovskite thin film, where (hkl) represents the Miller indices. For the analysis of the 2D perovskite top film, the (200) plane was utilized, while the (001) plane was selected for the 3D perovskite film. The Scherrer equation incorporated a shape factor (K) of 0.9. The formula is presented as follows:

$${D}_{hkl} = \frac{K λ}{{β}_{hkl} cos cos {θ}_{hkl}} \qquad ( 1 )$$

where λ is 1.1365 Å and is the X-ray wavelength, θ is the diffraction peak position, β is the full-with-at-half-max (FWHM). The FWHM was extracted by fitting the diffraction profile to a pseudo-Voigt function. The FWHM was correct for the geometry of the measurement such as the X-ray beam divergence, energy bandwidth, and the parallax effect of the beam footprint.

### 1.15 Thin-Film Morphology Measurements

Scanning electron microscopy (SEM) measurements: The surficial and cross-sectional SEM images were acquired using the FEI Quanta 400 ESEM FEG instrument. The fabrication process involved depositing the 3D control and the 2D templated 3D perovskite films onto a Silicon substrate, followed by sputtering approximately 15 nm of gold to improve film conductivity. The SEM images were captured at a voltage of 12.5 kV, and a dwell time of 30 μs was utilized during image acquisition.

Atomic force microscopy (AFM) measurements: The AFM measurements were conducted utilizing the NX20 ÅFM instrument from Park Systems. Surface topographical images were acquired in tapping mode, employing a silicon tip with a resonant frequency of 300 kHz and a spring constant of 26 N/m. The root mean square (RMS) roughness values were extracted from a 5 μm×5 μm image.

### 1.16 Determination of Electronic Band Levels Using Photoemission Yield Spectroscopy (PES)

PES (AC-2, Riken-Keiki) measurements were conducted to determine the valence bandmaximum (VBM) of the 3D, 2D (BA₂FAPb₂I₇) templated 3D perovskite samples. The measurements were performed under ambient conditions, with the samples being illuminated by monochromatic ultraviolet (UV) light. The UV photons used had energy levels exceeding the ionization energy (IE) of the sample being measured. These photons caused the ionization of an electron to the vacuum level, which, in turn, ionized a gas molecule in proximity to the surface, as detected by the instrument. During the measurement, the energy of the photons ranged from 4.2 eV to 6.2 eV, and the number of generated photoelectrons was recorded for each energy level. This recorded value was corrected based on the intensity spectrum of the UV lamp used. For semiconductors, the number of photo-generated electrons near the VBM typically increases as the cube root of the energy. Therefore, the cube root of the corrected PYSA spectrum was plotted against the photon energy. The linear region of the plot above the onset was fitted to determine the VBM, which was identified at the crossing point between the linear fit and the background level. To calculate the conduction band minimum (CBM) relative to the vacuum level, the measured bandgap was subtracted from the ionization energy, resulting in the electron affinity (EA).

### 1.17 Characterization of Solar Cell Devices

Solar cell performances: The performances of the solar cells were obtained by measuring the current-voltage (J-V) curves of each device illuminated by an ABB solar simulator from Newport (model 94011). The arc simulator modelled AM 1.5G irradiance of 100 mW/cm² whose intensity was calibrated using a NIST-certified Si solar cell (Newport 91150V, ISO 17025) and corrected by measuring the spectral mismatch between the solar spectrum, reference cell, and the spectral response of the PV device. We estimate a mismatch factor of 3%. The solar cells were measured with a Keithley 2401 instrument from 1.2 to 0 V and back, with a step size of 0.05 V and a dwell time of 0.1 s, after light soaking for 10 s. The defined active area was 3.14 mm²

External quantum efficiency: The external quantum efficiency (EQE) of the solar cell devices was collected by first illuminating each device with monochromatic light modulated at 2 kHz coming from a quartz-tungsten-halogen light source fed into a monochromator (SpectraPro HRS 300, Princeton instruments). The photocurrent response of the solar cells was measured by an SR865 lock-in amplifier. The light source spectrum response was calibrated using a calibrated silicon diode (FDS1010, Thorlabs).

Stability tests: For stability test measurements, the perovskite devices were encapsulated with a UV-curable epoxy (Poland Inc.) and a glass coverslip as a barrier layer in an argon-filled glove box. The devices were blown with the argon gun to remove any contaminants or dust particles just before encapsulation. All the devices were tested at the continuous maximum power point condition, under full-spectrum simulated AM 1.5G (100 mA·cm⁻² irradiance) in the air using an ABB solar simulator (94011A, Newport)-ISOS-L1 protocol. Each data point was collected after an interval of 15 min. The relative humidity was measured to be constant at 60±5% RH.

### 1.18 Mechanism of 3D FAPbI₃ Formation.

In our synthesis methodology, selective 2D perovskite crystals (BA₂FAPb₂I₇) were dispersed in a FAPbI₃ solution containing FAI:PbI₂ (1:1) dissolved in a DMF: DMSO solvent. Subsequently, we observed sub-micrometer-sized crystallites, referred to as 2D seeds, which retained their perovskite structure and acted as nucleation sites during film formation (42). Upon spin coating, these 2D crystal transferred their n-value to the solution-processed films which comprises of 2D perovskite (BA₂FAPb₂I₇) alongside the δ-phase of FAPbI₃. During annealing, we propose that the transformation to bulk FAPbI₃ occurs through an intercalation process. Ions such as FA⁺, Pb²⁺, and I⁻ permeate the lattice from the edges of the 2D-HaP crystal, diffusing along the interface between the perovskite layers. These ions fill voids in the corner-sharing PbI₆ structure, forming additional linkages and integrating with the [PbₙI₃ₙ₊₁] lattice to form the 3D bulk FAPbI₃ pushing the bulky organic cations to the grain boundaries. The observed templating effect is attributed to the delicate ionic interactions between the 2D inorganic octahedral sheets and the organic spacers, coupled with the lattice matching between the 2D perovskite (BA₂FAPb₂I₇) and the 3D FAPbI₃ lattice planes. Our results are consistent with the previous reports that observe the intercalation of precursor ions into the lattice to form higher layer thickness 2D-HaP (45).

### Example 1

This example illustrates methylammonium and cesium-free stabilization of formamidinium perovskite for efficient and stable devices. To elucidate the mechanism of perovskite film formation, the present inventors performed in-situ absorbance, photoluminescence, and wide-angle X-ray scattering (WAXS) measurements while spin coating, and annealing at any temperature between 100-150° C. for 5 min.

This example involves stabilization of FAPbI₃ three-dimensional (“3D”) perovskite using a two-dimensional, Ruddlesden-popper (n=1) perovskite as the starting template. The stabilization of the 3D FAPbI₃ perovskite used the 2D, n=1 or n=2 Ruddlesden-popper (“RP”) perovskite with an organic spacer cation. Suitable organic spacer cations included one or more of butylammonium, pentyl ammonium, phenyl ethyl ammonium, and octyl ammonium. The 2D n=1,2, or 3 perovskite (for example BA₂PbI₄ or BA₂FAPb₂I₇) was introduced as an excess additive into an equimolar solution of formamidinium iodide (FAI), and lead iodide (PbI₂) used for making 3D HaP FAPbI₃ thin films. The thin film formation followed an intermediate 2D perovskite stage which acts as a template or seed for the fabrication of the stabilized cubic (α) phase-FAPbI₃.

A FAPbI₃ perovskite was successfully stabilized using 2D n=1 Ruddlesden popper perovskite using a seed-based templating approach. The 2D n=1 or n=2 perovskite with different organic cations like butylammonium, pentyl ammonium, octyl ammonium, and phenylethyl ammonium has been shown to stabilize the Formamidinium-based 3D perovskite. The thin film quality of the 3D FAPbI₃ layer was not compromised which shows high crystallinity compared to control FAPbI₃ films, or multiple cations stabilized FAPbI₃ perovskite films. An optimum bandgap of ˜1.48 eV was achieved which is optimum for the α-FAPbI₃ perovskite, and lower than usually A-cation site stabilized FAPbI₃. A high material stability was measured under accelerated aging conditions (85° C., 85 R_{H}%, AM1.5G continuous illumination, and X-rays. The present inventors fabricated a solar cell with an efficiency of 24.1% giving a J_{SC} of 26.5 mA·cm⁻², open-circuit voltage (V_{OC}) of 1.14 V, and fill factor of 80% in a regular n-i-p device geometry. The universality of this technique was tested by using 2D RP n=1 and n=2 perovskite with different organic cations like pentyl ammonium, octyl ammonium, and phenylethylamine. A high ISOS-L1 photostability was observed for operating solar cells with T₉₉>1000 hours with encapsulation, and T₉₀>500 hours without encapsulation implying high stability of the photovoltaic device under operating conditions.

The designed strategy was tested for the Dion Jacobson phase (e.g. (3AMP-PbI₄) which preferentially forms a 2D HaP perovskite then stabilizing the 3D FAPbI₃ perovskite considering the strong interaction between the interlayers. The obtained FAPbI₃ thin films showed a bandgap of 1.48 eV which is optimum for the α-FAPbI₃ phase. We further fabricated n-i-p, and p-i-n solar cells with a maximum PCE of 23.5% enabled by a high current density of 26.0 mA·cm⁻², fill factor of 82%, and open circuit voltage (V_{OC}) of 1.14 V. The fabricated devices show enhanced material stability under accelerated testing conditions (85 R_{H}%, 85° C., and continuous AM 1.5G light illumination) and device stability with T₉₉>1000 h for epoxy-encapsulated devices and T₉₀>500 h for unencapsulated devices.

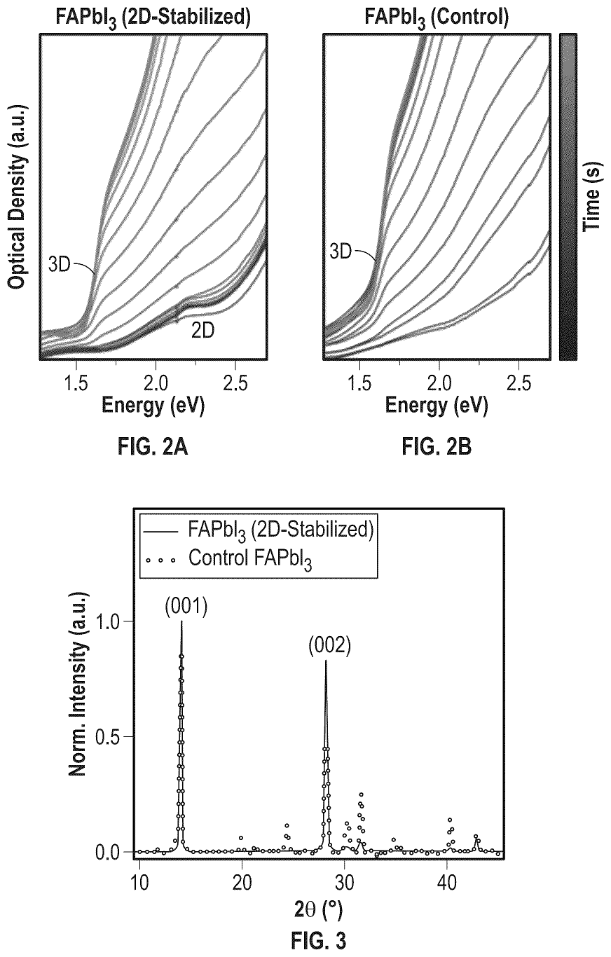

FIG. 1 shows a schematic diagram depicting the strategy of stabilizing FAPbI₃ perovskite using Ruddlesden-popper n=1 or n=2 2D perovskite. The schematic diagram in FIGS. 2A and 2B show the various stages involved in obtaining a stabilized FAPbI₃ 3D perovskite. The stabilized FAPbI₃ 3D perovskite may be free of one or more of methylammonium, cesium, rubidium, and bromine. This process involves the addition of trace amounts of 2D, RP (n=1 or n=2) perovskite in a ink as an excess additive into an equimolar concentration of FAI, and PbI₂ dissolved in a solvent mixture of dimethylformamide, and dimethyl sulfoxide. This synthesis technique shows an intermediate phase (red film) which eventually transforms into a black α-FAPbI₃ phase at 100° C. or 150° C. This contrasts with a typical synthesis approach, in which a yellow δ-FAPbI₃ phase forms initially after spin coating which on annealing at 150° C. converts to α-FAPbI₃.

FIGS. 2A and 2B depict the evolution of the absorbance under continuous ramp annealing (0 to 150° C.) of the 3D FAPbI₃ films using both techniques. FIG. 2A shows in-situ absorption measurements during annealing depicting the evolution of the α-FAPbI₃ 3D perovskite with an excess additive of n=1 or n=2 2D RP. FIG. 2A shows in-situ absorption measurements for control FAPbI₃. The normal synthesis approach (FIG. 2B) shows a direct transformation from δ-FAPbI₃ to α-FAPbI₃ on annealing, whereas using our approach (FIG. 2A) we observe an intermediate BA₂FAPb₂I₇ 2D RP phase which eventually transforms to α-FAPbI₃ on annealing. The blue shift in the absorption band edge and the photoluminescence of the control (FIG. 2B) and 2D-stabilized FAPbI₃ (FIG. 2A) is purely temperature dependent as reported previously. In addition, the 2D-stabilized FAPbI₃ (FIG. 2A) shows a weaker Urbach tail absorption compared to the control FAPbI₃ indicating the high electronic quality of the thin films.

The in-situ PL measurements shown in demonstrate similar transformation behavior and characteristics. shows in situ photoluminescence measurement during annealing depicting the evolution of the α-FAPbI₃ 3D perovskite with an excess additive of n=1 or n=2 2D RP. The inset shows the evolution of the PL for control-FAPbI₃.

The in-situ change in the crystal structure during film formation was monitored using the synchrotron WAXS technique,. and demonstrated the evolution in the structure of α-FAPbI₃ 3D perovskite during stabilization using 2D n=1 or n=2 RP perovskite. The formation of a yellow δ-FAPbI₃ phase was observed immediately after spin coating which transformed into a 2D BA₂FAPb₂I₇ identified by the oriented Bragg spots at q<1 Å⁻¹ which eventually disappeared and converted to α-FAPbI₃ verified by the concentric diffraction rings.

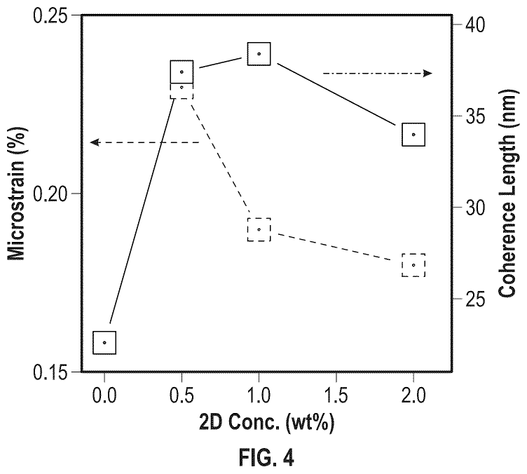

The crystallinity of the final perovskite film obtained by the two techniques was investigated using the grazing incidence x-ray diffraction (GIXRD) technique (FIG. 4). FIG. 4 shows a comparison of GIXRD spectra for the 2D stabilized FAPbI₃ perovskite (red line) and control FAPbI₃ (dotted black line), respectively. Two dominant diffraction peaks at diffraction angles (2θ, CuKα) of 14.1°, and 28.2° corresponding to the lattice planes (100) and (200) were observed in the 2D stabilized α-FAPbI₃ whereas the normal synthesis approach showed multiple peaks which correspond to the hexagonal (δ-phase) and cubic phase (α-phase) of the FAPbI₃ perovskite.

A Halder-Wagner plot was generated to extract the coherence length, and the microstrain in different samples with various concentrations of 2D, RP n=1 or n=2 perovskite additive. The plot shows the correlation length, and micro strain extracted from the Halder-Wagner plot as a function of the concentration of the 2D perovskite used for stabilizing 3D FAPbI₃ perovskite. The coherence length increased from 22.62 to 38.4 nm when for a concentration of 1.0 wt %, which further reduces to 33.97 nm for 2.0 wt %. A relaxation in local lattice strain was observed with the introduction of 2D, n=1 or n=2 RP perovskite as verified by the reduction in microstrain. This result indicated higher crystallinity, reduced atomic defects, and non-radiative recombination in the 2D-stabilized FAPbI₃ compared to the control sample.

The optical absorbance and photoluminescence spectra of the 2D-stabilized FAPbI₃. showed absorbance (black line) of a 600-nm stabilized FAPbI₃ thin film along with the photoluminescence spectra for excitation at 1.96 eV (red line). An optical bandgap (E_{g}) of 1.48±0.002 eV was measured. This optical bandgap is optimum for the α-FAPbI₃ which is lower than most of the A-cation site stabilized FAPbI₃ reported in the literature.

The material stability of the control-FAPbI₃, and the material stability of the FAPbI₃ stabilized by our approach were investigated. An in-situ aging system was developed to test the intrinsic stability of the device stack (ITO/SnO₂/FAPbI₃/Sprio-MeOTAD/Au) using GIWAXS. The structural degradation of the perovskite was monitored under an accelerated aging condition of 85° C., 85 R_{H}%, AM1.5 G continuous illumination, and open circuit voltage condition.

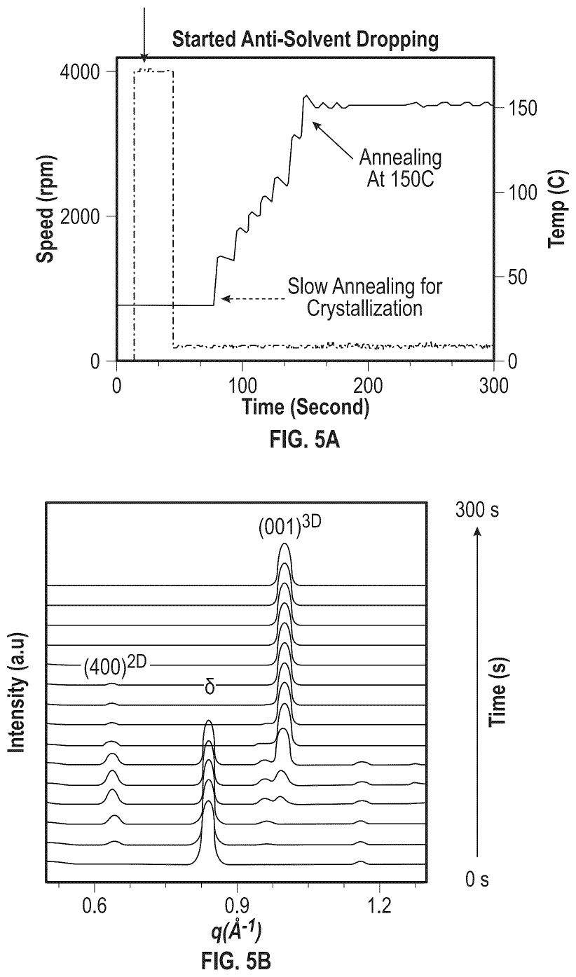

Contour plots depicting the variation in integrated peak intensity of various diffraction peaks of the FAPbI₃ fabricated using both techniques were analyzed. The contour plots showed the degradation of control FAPbI₃ as a function of time and 2D perovskite stabilized FAPbI₃ thin film device stack (unencapsulated) as a function of time. The control FAPbI₃ show immediate degradation into the δ-FAPbI₃ and PbI₂, whose intensity keeps on increasing at the expense of the intensity of the α-FAPbI₃ phase as a function of time. After 35 min, most of the control α-FAPbI₃ transformed into the δ phase with the presence of PbI₂. However, as shown in FIGS. 5A and 5B, the experimental log and corresponding time evolution of the WAXS diffraction pattern during the thin-film formation of the FAPbI₃ stabilized using our approach showed incredibly high stability throughout 3 hours with barely any degradation in the main perovskite (001) peak.

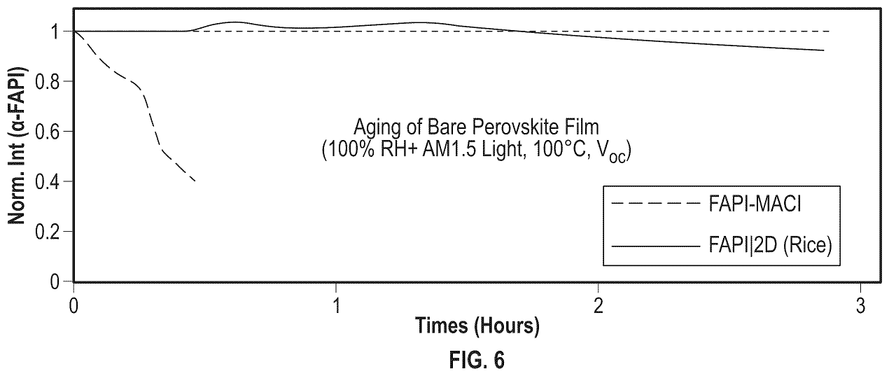

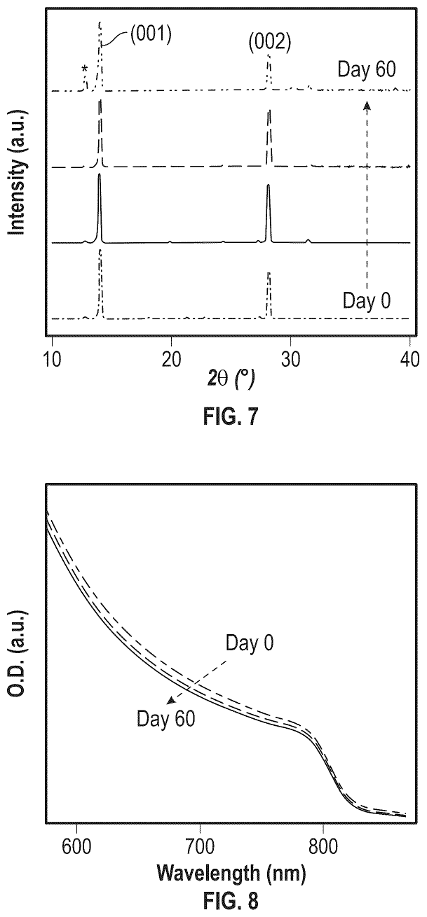

FIG. 6 shows a plot comparing the degradation of control and 2D stabilized FAPbI₃ extracted by integrating the main perovskite peak (001) as a function of time. FIG. 6 shows high intrinsic material stability of the 2D stabilized FAPbI₃. FIG. 7 shows the variation in the integrated peak intensity of the main perovskite peak (001) in a device stack (with the control and 2D stabilized FAPbI₃) as a function of time extracted from the in-situ degradation measurements done in. After 1440 h in an ambient atmosphere (with a humidity of 55 R_{H}%), as shown in FIG. 8, the 2D stabilized FAPbI₃ did not show any macroscopic traces of δ-FAPbI₃ phase formation.

Specifically, FIGS. 7-8 show lack of macroscopic traces of δ-FAPbI₃ phase in the 2D stabilized FAPbI₃ which was confirmed by the GIXRD (FIG. 7), and absorption (FIG. 8) measurements. FIG. 7 shows shelf-life stability of the thin films of 2D stabilized FAPbI₃ measured by monitoring the GIXRD over a period of 60 days under ambient conditions. FIG. 8 shows shelf life stability of the thin films of 2D stabilized FAPbI₃ measured by monitoring the absorption over a period of 60 days under ambient conditions. We only observed some formation of PbI₂ as degradation after 1440 h. All these measurements show the resilient stabilizing effect of the stabilized FAPbI₃ against the phase impurities for the bare devices and thin films operated or measured under rigorous external stressors.

The band alignments of the FAPbI₃ photoactive phase stabilized using 2D, n=1 RP perovskite were obtained with the help of photoemission yield spectroscopy combined with the bandgap (evaluated from the Tauc plot) and compared it with the MACl stabilized FAPbI₃ to attest the feasibility of making a solar cell device. The alignment of the FAPbI₃ with the appropriate transport layers and electrodes for fabricating an n-i-p geometry showed energy-level alignment of the n-i-p solar cell stack with different FAPbI₃ photoactive absorber fabricated by 2D perovskite stabilization, and MACl stabilization. This demonstrated that the champion 2D stabilized FAPbI₃ n-i-p perovskite solar cell is a suitable device.

An appropriate band alignment for charge carrier (electrons or holes) extraction was observed. Current-voltage curves of the champion 2D stabilized FAPbI₃ n-i-p perovskite solar cell and external quantum efficiency of the 2D stabilized FAPbI₃ n-i-p perovskite solar cell device showed the absorption and current generation ability of the stack. The current density measured from the current-voltage curve closely matches the integrated current density calculated from the EQE measurements.

The long-term operational stability of the 2D stabilized FAPbI₃ encapsulated device following the ISOS-L-1 protocol at an operating temperature of 55° C., and ambient humidity of 50-60 R_{H}% showed ISOS-L-1 stability measured at maximum power point tracking in ambient condition under continuous 1-sun illumination (55° C.) for an epoxy encapsulated PSC. After 1000 hours of continuous illumination, the FAPbI₃ stabilized device showed negligible degradation with T₉₉>1000 hours. The solar cell achieved a maximum of PCE=23.5%.

Considering the high intrinsic material stability, we also measured an unencapsulated FAPbI₃ solar cell under continuous illumination at an operating temperature of 55° C., and ambient humidity of 50-60 R_{H}%. shows ISOS-L-1 stability measured at maximum power point tracking in ambient condition under continuous 1-sun illumination (55° C.) for an unencapsulated PSC. After 500 h, the stabilized FAPbI₃ device showed T₉₀>500 hours, whereas the control FAPbI₃ device degraded more than 80% before 50 h of continuous illumination.

Example 1 illustrates that embodiments of the present disclosure may provide at least one of the following advantages. An optimum bandgap of 1.48 eV was achieved which enabled the fabrication of high-efficiency n-i-p, and p-i-n solar cells with a maximum PCE of 23.5%. Accelerated stability tests performed under 85° C., 85 R_{H}%, and continuous light soaking show incredibly high material stability, and excellent device stability. In addition to this, a high ISOS-L1 photostability for operating solar cells was observed with T₉₉>1000 hours with encapsulation, and T₉₀>500 hours without encapsulation implying high stability of the photovoltaic device under operating conditions.

### Example 2

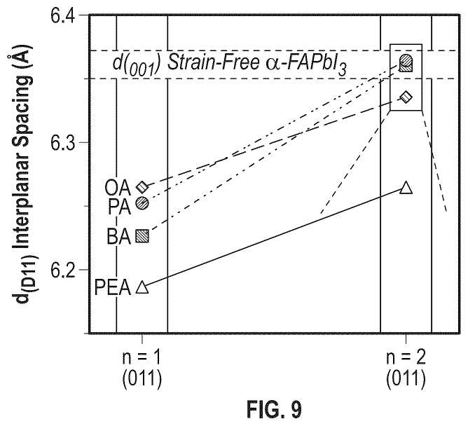

This example describes the general design principle, the analysis of lattice matching for the 2D perovskite-based templating of FAPbI₃ and a proof-of-concept. FIG. 9 shows the average inplane lattice parameter corresponding to the Pb—I—Pb distance, (011) plane for the 2D perovskite and the (001) plane for the 3D FAPbI₃ perovskites as a function of layer thickness or n-value for 2D perovskites formed with a range of A′ site cations: PA, BA, OA and PEA. The solid red line represents the average lattice parameter of strain-free bulk FAPbI₃, obtained from previous reports of their single crystal structure. The range of reported lattice parameter values for FAPbI₃ d(001) interplanar spacing is plotted as a gray horizontal bar. A′2FAₙ₋₁PbₙI₃ₙ₊₁ RP 2D perovskites, with A′=BA, PA, PEA, or OA. For BA₂FAPb₂I₇ and PA₂FAPb₂I₇ the (011) spacing is close to the (001) spacing of metastable and strain-free bulk FAPbI₃. Following the lattice mismatch model developed for MAPbI₃,⁴² it was hypothesized to keep the lattice mismatch between the 2D and 3D perovskites was kept low to minimize the 2D-3D interfacial energy and to encourage growth via templating, which motivated a search for FA-based 2D perovskites with an inplane lattice parameter close to FAPbI₃. It was found that 2D, n=2 FA-based perovskites with the bulky cations butylammonium (BA) and pentylammonium (PA) with (011) interplanar spacings of 6.359 Å and 6.368 Å respectively, were almost perfectly lattice matched (lattice mismatch of 0% and 0.15% respectively) with the (001) interplanar spacing of 3D FAPbI₃ (6.359 Å, taking the average of two reported lattice constants of 6.352 Å and 6.365 Å).^{5,6}

The lattice match for FA-based perovskites with the bulky cations butylammonium (BA) was further evaluated in the crystal structures of α-FAPbI₃ and BA₂FAPb₂I₇2D perovskite, with a focus on projections of (001) and (011) lattice planes. The typical 2D perovskite structure of BA₂FAPb₂I₇ is shown in two crystal directions, displaying projections of (111), (011) and (200) lattice planes. In addition, the figure highlights the lattice matched planes in both the 3D and 2D perovskites, which correspond to the Pb—I—Pb distance and its lattice parameter, respectively.

On the other hand, crystal structure analysis revealed that for n=2 FA-based 2D perovskites with phenylethylammonium (PEA) and octylammonium (OA) the Pb—I—Pb distance was smaller (6.261 Å and 6.336 Å) and gave a larger lattice mismatch (1.54% and 0.36%, respectively) with the 3D strain-free structure. Notably, all the n=1 2D perovskites were lattice mismatched with their 3D counterparts, indicating their non-viability for templating the 3D phase. Due to the intrinsic structural instability of the strain-free FAPbI₃, a stable strained FAPbI₃ black phase was rather formed through a templating effect observed between the (001) plane of FAPbI₃ and the (111) plane of 2D perovskites. The (111) interplanar spacing of the 2D n=2 structures is therefore also shown in FIG. 9. The guidance from the design principles was used to conduct a drop-coating experiment was developed for 2D perovskite lattice templating of FAPbI₃.

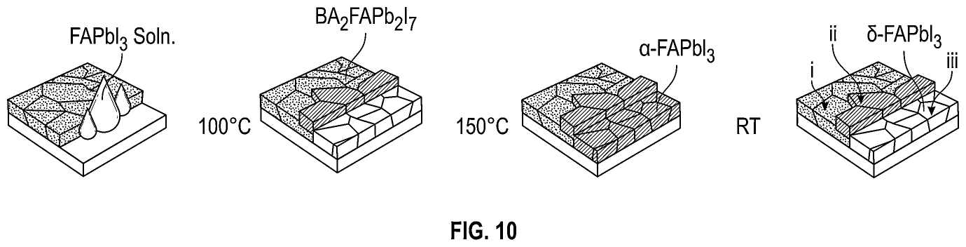

As shown in FIG. 10, a FAPbI₃ precursor solution was dropped onto a glass substrate and allowed to flow over crystals of BA₂FAPb₂I₇. When heated, the d-FAPbI₃ on top of the BA₂FAPb₂I₇ transformed to α-FAPbI₃ before the d-FAPbI₃ on top of the bare substrate. Left in ambient air, the α-FAPbI₃ on top of the bare substrate transformed to d-FAPbI₃ before the α-FAPbI₃ on top of the BA₂FAPb₂I₇. Initially, a substrate was partially covered with a film of red colored mm-scale BA₂FAPb₂I₇ monocrystals, fabricated using the air-liquid interface method and spread on an ITO glass substrate. Once these crystals were dried on a hot-plate at 100° C., half the glass slide was wiped away to create a bare glass region approximately 50% of the 1 inch glass area. A few drops of FAPbI₃ precursor solution (composed of an equimolar ratio of FAI and PbI₂) was added onto the blank surface and the substrate was annealed at a temperature of 100° C., 125° C. and 150° C. (experiments shown in FIG. 10 were performed at a substrate temperature of 100° C.). After annealing, the solution was allowed to flow over and react with the BA₂FAPb₂I₇2D perovskite crystal film. Upon contact with the 2D crystals, the solution spontaneously (within 10⁻¹⁵ seconds) transformed to form a shiny black film. The same result was obtained for 125° C. and 150° C. all of which showed the same transformation. After letting the film equilibrate over a period of 5 min, three distinct regions on the substrate were obtained as shown in FIG. 10. i: BA₂FAPb₂I₇ without FAPbI₃ solution, ii: BA₂FAPb₂I₇ below FAPbI₃ solution, and iii: FAPbI₃ solution on bare glass.

The lower region of the substrate, which was originally bare, changes to a black color with partially converted α-FAPbI₃, at 100° C. The middle region where the solution touched the 2D perovskite consisted of the black phase FAPbI₃ on the surface and BA₂FAPb₂I₇ below that. Finally on top part of the substrate, where the solvent did not flow remained as BA₂FAPb₂I₇ crystal film. The film was left for one hour under ambient conditions. As the temperature decreased, the bottom region converted to the yellow phase of FAPbI₃ while the intermediate region remained black, suggesting the successful phase stabilization of the FAPbI₃. The BA₂FAPb₂I₇ crystal film remained unchanged over this time due to its inherent stability compared to its 3D counterpart.

The three regions of the final film were characterized using both photoluminescence (PL) and X-ray diffraction (XRD) measurements. The PL spectra of the film obtained at the three specific regions, labelled (i), (ii), and (iii). The red region (i) was the unexposed FAPbI₃ solution area of the BA₂FAPb₂I₇ single crystal. The black region (ii) was the edge of the BA₂FAPb₂I₇ single crystal that was in contacted with the FAPbI₃ solution. The yellow region (region (iii) in FIG. 10) corresponded to the opposite edge of the sample where the FAPbI₃ sample is on glass. PL spectra of 2 different regions, one of which (region 1) is on top of the 2D crystal and the other (region 2) is where there is no 2D crystal.

Region (i) showed a dominant PL emission at 2.15 eV, corresponding to the excitonic ground state emission of BA₂FAPb₂I₇ film, accompanied by a small shoulder around 2.0 eV. The intermediate region (ii), showed a strong emission which peaked at 1.48 eV, corresponding to the intrinsic bandgap of the α-FAPbI₃ phase, with very weak emission at around 2.15 eV consistent with the PL emissions measured on single crystals of BA₂FAPb₂I₇. These results indicate the coexistence of the bulk black phase FAPbI_{3 3}D perovskite atop the 2D perovskite crystal film. The complete transformation all the way to the depth of the BA₂FAPb₂I₇ was limited by the low quantity of the FA precursor used for this experiment. The presence of the 2D perovskite at the bottom was confirmed by photoluminescence measurements taken from the back of the film in region (ii), which exhibited emission solely from the 2D perovskite. As anticipated, region (iii) remained void of any emission due to the photoinactive nature of the yellow phase of the FAPbI₃.

Further, integrated PL peaks as a function of probe intensity for the n=2 and hypothesized (n=3) excitonic peak in (blue and red, respectively). The log-log linear fit constants are were k=0.9 when measured at 2.15 eV and k=1.2 when measured at 1.95 eV. Phase stabilization of FAPbI₃ also occurred at 100° C. and 125° C., which are well below the standard annealing temperature of 150-160° C.

The X-ray diffraction measurements validated the findings from the measurements of the regions in FIG. 10. Diffraction results from region (i) showed a pure 2D BA₂FAPb₂I₇ perovskite, which is evidenced by the strong out-of-plane (h00) diffractions plane originating from the inorganic layer stacking. From region (ii) a similar diffraction pattern was found but with the (001) and (002) diffraction planes from the α-phase FAPbI₃ perovskite indicating a mixture of 2D and 3D perovskites. Lastly, in region (iii) the XRD showed only the existence of the yellow (δ) phase FAPbI₃.

The above results suggested that the incorporation of BA₂FAPb₂I₇ into FAPbI₃ during film formation could stabilize the perovskite phase through templating between the two structures' Pb—I—Pb interatomic distances.

### Example 3

To test the hypothesis in forming FAPbI₃ films, 2D perovskites were added as templating agents to precursor solutions of 1:1 FAI:PbI₂ in mixed 4:1 DMF:DMSO solvent. Using a technique developed previously by our lab, 41 pre-synthesized 2D crystals were added instead of the more conventional choice of A′ cation halide salts. Rather than dissolving completely into constituent ions, 2D crystals in a DMF:DMSO solvent will break into sub-μm sized crystallites, which preserve their perovskite structure and serve as nucleation sites during film formation. These 2D crystals can transfer their initial n-value to solution-processed films. However, when dissolved in a FAPbI₃ precursor solution rather than pure DMF:DMSO, 2D perovskite crystallites are surrounded by a high concentration of mobile A-site cations, which tend to intercalate into the seeds and increase their n-value. As a result, a 2D dopant with a given A′-site cation will grow from a FAPbI₃ solution at its thermodynamically preferred n-value in such an environment. With this in mind, only 2D perovskites of the n-value that will precipitate from a FAPbI₃ solution can be considered as templating candidates. Through solution processing experiments it was found that all of the RP 2D perovskites considered here grew in their n=2 phase from FAPbI₃ solution.

Differential Scanning Calorimetry of a scraped FAPbI₃ film before annealing was performed with 2 mol % BA n=2 dopant (red) compared to without (black) showing δ→α conversion at lower temperature for 2D-doped FAPbI₃. 1D XRD of films of spin-coated FAPbI₃ solution doped with 10 mol % A′ iodide salt, annealed for 5 min at 70° C. were also collected for BAI, PAI, OAI and PEAL. In each case, the A′I precipitated as phase-pure A′2FAPb₂I₇. This confirmed that the dopants BA₂FAPb₂I₇ and PA₂FAPb₂I₇ are physically realizable candidates for FAPbI₃ templating. We found no qualitatively different behavior between FAPbI₃ films doped with BA₂PbI₄ (n=1) and films doped with BA₂FAPb₂I₇ (n=2) for the same molar concentrations, so either n-value crystal were able to be used as a source of 2D seeds.

Incorporating the selectively designed 2D perovskites BA₂FAPb₂I₇ and PA₂FAPb₂I₇ enabled the fabrication of stabilized FAPbI₃ perovskite thin films. As described in accordance with FIG. 1, the film formation process of FAPbI₃ with 2D perovskite additive, offers insight into the alterations that occur during the process. Perovskite films were synthesized via spin-coating, using precursors of FAI:PbI_{2:2}D perovskite with a molar ratio of 1:1:x mol %. After antisolvent washing with diethyl ether, the thin film underwent a series of intermediate stages, which were seen visually as changes in color from pale red (before annealing) to dark brown, and finally to a black film when annealed at temperatures ranging from 100° C. to 150° C. for 20 minutes.

In order to elucidate the mechanism that produces a RT phase-stable FAPbI₃ film, we measured the structural dynamics of the perovskite during thin-film formation using synchrotron-based in-situ Wide Angle X-ray Scattering (WAXS). The perovskite thin-films were deposited from solution onto an ITO substrate via a robotic antisolvent pipette and a self-heating spin-coater in a WAXS chamber under a Nitrogen atmosphere. We first investigated the crystallization kinetics of a FAPbI₃ film doped with 1.0 mol % BA₂FAPb₂I₇ incorporated. The WAXS pattern taken during thin-film formation showed concentric diffraction rings corresponding to the Bragg reflections of the stacking axis diffraction planes of BA₂FAPb₂I₇ and α- and δ-phases of 3D-FAPbI₃. The corresponding time evolution of the diffraction pattern during the thin-film formation presented in WAXS patterns taken during thin-film formation showed the coexistence of δ-FAPbI₃, α-FAPbI₃, and BA₂FAPb₂I₇ diffraction peaks.

The WAXS pattern can be azimuthally integrated and plotted over time along with spin speed and temperature to observe the film's structural evolution during in-situ spin-coating of a FAPbI₃ precursor solution with 1 mol % BA n=2. The in-situ experiment was divided into 4 steps, i) antisolvent dropping during spin-coating, ii) after spin-coating but before annealing, iii) slow annealing ramping from RT to 150° C., and iv) constant annealing at 150° C. The δ-phase FAPbI₃ immediately forms after depositing antisolvent (10s, phase (i)), indicated by strong (100)^{δ} (q (length of reciprocal lattice vector)=0.84 Å⁻¹), (101)^{δ}, and (110)^{δ} diffraction planes. Once the spin-coating was completed (30s), the δ-phase that persisted as 2D BA₂FAPb₂I₇ seeds began to crystallize at RT, evidenced by the 2D out-of-plane (400)^{2D} (q=0.646⁻¹) and (600)^{2D} (q=0.960⁻¹) diffraction peaks.

The BA₂FAPb₂I₇ diffraction peaks grew in intensity as the substrate temperature increased until the δ-FAPbI₃ began to convert to α-FAPbI₃, after which point the peaks slowly faded. The position of the BA₂FAPb₂I₇ (400) peak over time started at a lower q-value than expected (expansive strain) and relaxed to the expected (400) peak position from BA₂FAPb₂I₇ single-crystal diffraction.

Next, a nonlinear stepwise annealing sequence was applied, in which the substrate temperature was increased by steps of 20° C. in 20 sec intervals up to 100° C. and then increased by steps of 25° C. up to 150° C. (phase iii). Slow ramping to 150° C. allowed for the observation of the onset temperature of the FAPbI₃ α-phase peak. In this stage, results illustrated that when annealing at low temperatures (<100° C.), the diffraction intensity of the 2D increased significantly and a new peak emerged at q=1 Å⁻¹ corresponding to the (001) plane from α-phase FAPbI₃. The α-phase showed very slight (˜0.1%) expansive strain at the onset of its formation, but it underwent lattice compression from 6.36 Å of the (000 plane to the (111) plane at 6.275 Å (˜1.4% compressive strain) during annealing. Interestingly, the strained lattice parameter of 6.275 Å corresponded not to the (011) interplanar spacing of BA₂FAPb₂I₇ (the 2D Pb—I—Pb distance) but to the (111) interplanar spacing. In fact, a 1.4% compressive strain is significantly higher than FAPbI₃ templated on (011) BA₂FAPb₂I₇ with practically no compressive strain. Simultaneous with the emergence and growth of the α-phase peak, a decrease in the δ-phase peaks, and a compression in the δ-phase (201) and (220) interplanar spacing was also observed.

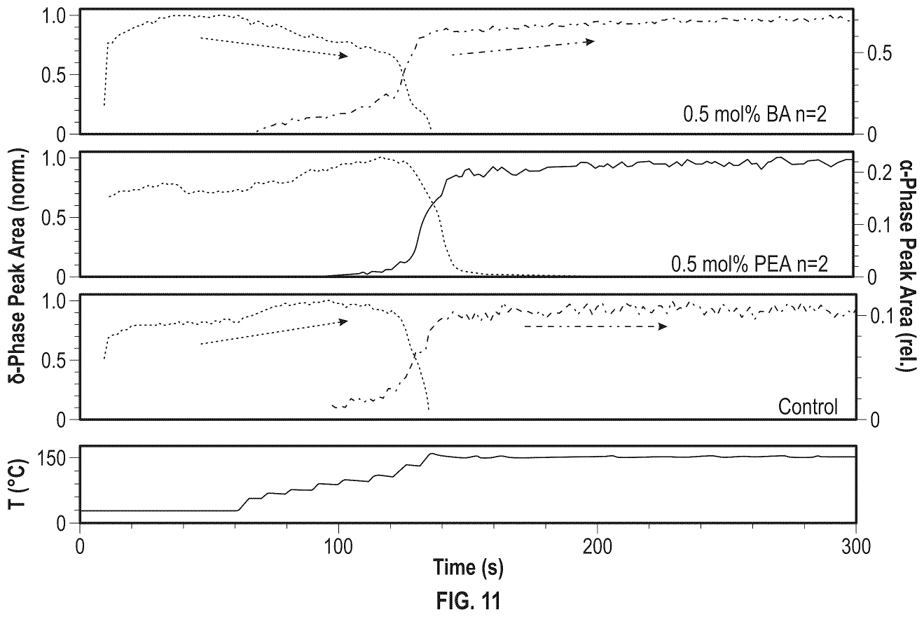

Further, and as shown in FIG. 11, the integrated peak area for the (100)^{δ} and (001)^{3D} peaks as a function of time for FAPbI₃ with 0.5 mol % BA n=2 incorporated was observed. The (001)^{3D} peak emerged after 75 s and slowly increased in intensity as the (100)d peak simultaneously decreased. After around 130-150° C. the remaining δ-phase abruptly converted into α-phase. As the film continued to anneal at 150° C. for the remainder of the experiment (phase iv) the 2D diffraction peaks slowly faded and the residual traces of the 2D perovskite were eventually eliminated (˜200 seconds) leaving only α-phase FAPbI₃ which slowly grew more intensely.

### Example 4

The formation of stabilized films was repeated for various other precursor solutions including i) undoped FAPbI₃ with no additives, ii) phase stabilized FAPbI₃ with 35 mol % MACl, iii) concentration dependent doping of BA₂FAPb₂I₇ crystals and iv) doping with various other families of 2D perovskite crystals.

In the in-situ contour WAXS plot for the undoped FAPbI₃, a 1:1 FAI:PbI₂ solution was evaluated. In contrast to the behavior of the FAPbI₃-2D sample which exhibited a gradual emergence of α-phase between 100° C. and 150° C. followed by a complete δ→α transformation at ˜130-150° C., the additive-free control FAPbI₃ showed a more abrupt transition from δ-phase to α-phase near ˜150° C. The (001)3D peak emerged later, with a shorter tail in control FAPbI₃, and the (100)d peak did not prematurely decrease as in the film that incorporated BA n=2. Although the initial emergence of the α-phase occurred at much lower temperatures with a 2D dopant, the complete δ→α transformation in the 2D-doped sample was delayed compared to the control sample, which suggested that the presence of BA₂FAPb₂I₇ slows FAPbI₃ crystallization kinetics even as it reduces the energy barrier to α-phase growth. The additive-free control FAPbI₃ showed a pre-strained α-phase with a Pb—I—Pb distance of 6.32 Å (consistent with previous works). During annealing the control lattice compressed further from 6.32 Å to 6.30 Å, a −0.32% relative strain. Unlike the film with added BA n=2, the (001)3D peak of control FAPbI₃ did not grow more intense as annealing at 150° C. continued.

The experiment was repeated for a precursor solution of 1:1:35 mol % FAI:PbI₂:MACl in 4:1 DMF:DMSO. The introduction of MA into the A-site of FAPbI₃ lowered the effective tolerance factor and stabilized the α-phase at a lower temperature compared to undoped/additive free FAPbI₃. As a result, an abrupt α→δ transformation occurred at ˜75° C. for the FAPbI₃-MACl sample. However, like the control sample and in contrast to the 2D-doped sample no region of gradual δ→α transformation can be observed, once again indicative of a lack of a templating effect. The α-phase Pb—I—Pb distance of the FAPbI₃-MACl film began at 6.32 Å at the outset and quickly fell to 6.29 Å, followed by a slow lattice expansion back to 6.32 Å as the sample annealed. This expansion was indicative of the gradual volatilization of the MA cation and Cl atoms (unstable above 100° C.) and the resulting increase in the effective A-site radius.

Next, BA₂FAPb₂I₇ (n=2) was added to 1:1 PbI₂:FAI with concentrations of 0.25, 0.5, and 1.0 mol %. In all cases, the contour plots of the in-situ WAXS experiments showed an increase in the (001)3D peak intensity relative to the control. The formation behavior appears concentration-invariant. In all cases 2D seeds form before annealing, the α-phase emerged at low temperature, and δ→α conversion is slowed. Additionally, there was the same ˜6.36 Å→6.27 Å compression of the α (001) plane in all the films. In all cases, the results suggested that even minute amounts of BA n=2 could improve α-phase crystallinity as they all demonstrate increases in the (001)^{3D} peak. The 0.5 mol % BA n=2-incorporated FAPbI₃ showed a similar film formation process to the 1.0 mol % sample, that is, a decrease in the (100)^{δ} peak and a slow emergence of the (001)^{3D} peak at a lower temperature. However, 0.25 mol % BA n=2 incorporation did not lower the onset temperature of the (001)3D peak relative to the control, and it did not cause the same characteristic decrease in (100)d intensity below 150° C. The phase stabilization appeared to be concentration invariant down to a certain minimum 2D concentration, below which the templating effect was lost but the film crystallinity was still improved. Furthermore, the 2D (400) peaks indicated the same out-of-plane lattice parameter for all three concentrations, with an initial contraction pre-annealing (˜19.5 Å) and an expansion towards a strain-free lattice (19.7 Å) as temperature was increased.

A series of 2D additives were then examined, including PA n=2, OA n=2, and PEA n=2. The effect of PA n=2 was evaluated using in-situ WAXS measurements. From the contour and parameter plots for PA n=2 doped in FAPbI₃ at 1.0% molar weight ratio, the effect was found to be similar to that of BA n=2, in that it lowered the onset temperature of the α-phase peak and caused a decrease in the d-phase below 150° C. In contrast, the contour and parameter WAXS plots revealed that OA n=2 and PEA n=2 had markedly different effects. For OA n=2 based FAPbI₃ films at 0.1% molar weight percentage, the 2D peaks formed weakly, and the α-phase emerged earlier than for the control sample, but no d→a transformation was observed. Instead, the d-phase persisted throughout annealing, suggesting that OA₂FAPb₂I₇ seeds could serve as nucleation sites for FAPbI₃ to a limited extent but slowed the d→a transformation. FAPbI₃ with 0.5 mol % PEA n=2 additive showed no 2D peaks and no early α-phase emergence. Moreover, FAPbI₃ with 1 mol % PEA n=2 also retained d-phase peaks throughout the measurement, suggesting that the PEA₂FAPb₂I₇ not only failed to form seeds for templating FAPbI₃ but also suppressed d→a transformation kinetics. Neither OA₂FAPb₂I₇ nor PEA₂FAPb₂I₇-doped samples showed α-phase lattice contraction, instead retaining the Pb—I—Pb spacing of the control sample, which suggested that neither dopant templates α-phase FAPbI₃.

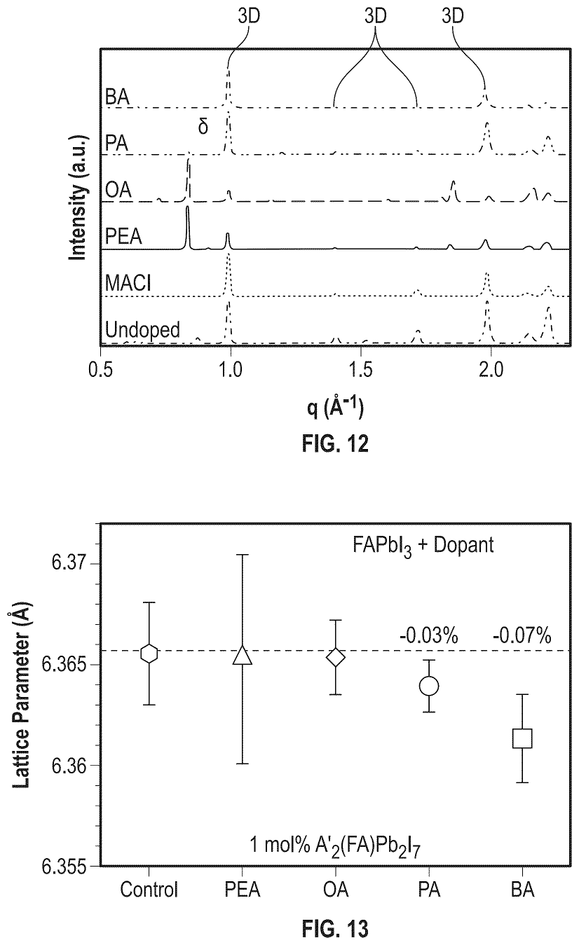

FIG. 12 shows a summary of azimuthally integrated WAXS patterns of FAPbI₃ samples with 1 mol % 2D BA and PEA, averaged across the first 90 s of annealing at 150° C. Additional plots revealed the incomplete δ→α transformation for the films incorporating 1 mol % OA and PEA n=2, which contrasted with the complete transformation for 1 mol % BA and PA n=2. Notably, all 2D films showed a slow decrease in the 2D peak intensities and a slow increase in the (001)3D peak intensity during annealing at 150° C. that was not observed for the control film. Although gradual volatilization of the A′ cation in A′2FAPb₂I₇, leaving behind FAPbI₃, could account for these changes, optical and nuclear magnetic resonance (NMR) results suggested that the 2D phase was not completely lost to volatilization and that there may be a competing mechanism of 2D restructuring within the lattice.

The in situ WAXS results suggested that BA₂FAPb₂I₇ and PA₂FAPb₂I₇ could template α-phase FAPbI₃, but OA₂FAPb₂I₇ and PEA₂FAPb₂I₇ could not. Ex situ 1D XRD was performed on separate 1 mol %2D-incorporated FAPbI₃ films. The ex-situ 1D XRD showed that FAPbI₃ films with added OA n=2 or PEA n=2 had a (001)3D interplanar spacing identical to that of control FAPbI₃ (˜6.365 Å), but that PAn=2 and BAn=2 caused a small but noticeable compression of the (001)3D interplanar spacing by −0.03 and −0.07%, respectively. Because the (011)2D interplanar spacing was slightly smaller for BA n=2 than for PA n=2, a higher compressive strain for FAPbI₃ with added BA n=2 compared to PA n=2 also supports the (011) lattice templating hypothesis.

To verify the structural results, similar in situ optical spectroscopy measurements were performed on the BA₂FAPb₂I₇-templated FAPbI₃ samples. During the initial stages of annealing, the film exhibited a strong excitonic absorption peak at 2.15 eV corresponding to BA₂FAPb₂I₇, which, with progressive annealing, transformed into α-FAPbI₃, characterized by a 3D perovskite absorption band edge. Similarly, a strong emission of the BA₂FAPb₂I₇ perovskite was observed at 2.15 eV in the in situ PL measurement, accompanied by a broad emission at lower energies. The butylammonium demonstrated a wider bandgap distribution and took a longer time (200 seconds) to convert to the FAPbI₃ band gap. It was hypothesized that the lower energy emissions were from a combination of effects, including edge state emission (46, 47), the formation of higher n-value 2D phases (e.g., n=3BA₂FA₂Pb₃I₁₀) (48, 49), and quantum confinement effects of the 2D and FAPbI₃ crystallites (50-53). Sub-bandgap edge state emission in BA₂FAPb₂I₇ was verified by spatially resolved PL, which showed a 1.8 eV PL emission peak only at the edges of an exfoliated BA₂FAPb₂I₇ single crystal. Additionally, the presence of a PL emission peak at 1.85 eV and the observation of n=3 excitons in power-dependent PL indicated that FA intercalation increased the layer thickness from n=2 to n=3 during annealing and eventually 3D FAPbI₃. A similar broad emission below the n=2 bandgap was observed during film formation for FAPbI₃ with PA₂FAPb₂I₇ additive, consistent with the structural results for PA₂FAPb₂I₇. However, no sub-bandgap emission was observed for the control FAPbI₃ or for FAPbI₃ incorporating MACl, OA₂FAPb₂I₇, or PEA₂-FAPb₂I₇.

On the basis of the in situ WAXS and PL measurements, we proposed the following film-formation process mediated by 2D templating. The film first formed grains of d-phase FAPbI₃ and 2D seeds at RT. The 2D likely formed initially because of its more negative formation enthalpy, its RT phase stability, and the presence of 2D (˜3 μm) seeds in the precursor solution as confirmed through dynamic light scattering (DLS) measurements. 2 mol % and 4 mol % BA n=2 doped FAPbI₃ were compared using DLS to determine the particle sizes. Correlation function (g2) versus lag time was measured at several scattering angles overlayed with the corresponding fits to determine the particle size. During annealing, the d-phase restructured itself beginning at the low-energy surfaces of the 2D seed crystals to form α-phase FAPbI₃. At the interface with FAPbI₃, the arrangement of PbI₆ octahedra in a 2D perovskite might have facilitated nucleation of a stable α-phase FAPbI₃, with subsequent phase transformation toward the bulk (54). It was deduced that the growth mechanism favored the formation of a compressively strained α-phase (001) plane templated by the 2D (011) interplanar spacing as shown in FIG. 13. The error bars indicated the standard deviation based on data from three to five samples. The low-temperature α-phase formation only being observed for films with added PA and BA n=2, and these films also being the only ones that exhibited lattice strain, was strong evidence for a templating effect off the (011)2D spacing.

The (011) interplanar spacings of BA₂FAPb₂I₇ (6.359 Å) and PA₂FAPb₂I₇ (6.364 Å) were almost perfectly lattice matched with the (001)3D interplanar spacing of FAPbI₃, both falling within the range of reported FAPbI₃ lattice constants from 6.352 to 6.365 Å(5, 6), whereas the (011) interplanar spacings of OA₂FAPb₂I₇ (6.336 Å) and PEA₂FAPb₂I₇ (6.265 Å) were not well matched. This structural difference explained why OA-2D and PEA-2D did not show the same d→a conversion process as BA-2D and PA-2D. The templating process and the resulting FAPbI₃ strain appeared 2D concentration-independent down to some minimum threshold, which for BA-2D perovskites was between 0.25 and 0.5 mol %. As the temperature was raised to 150° C. and the sample continued to anneal, we hypothesized that the 2D perovskite simultaneously volatilized its A′ cation and underwent a slow FA intercalation process, which increased its n value.

Other reports have suggested that the A′ cation of 2D perovskites incorporated into FAPbI₃ volatilized completely during annealing except for a small fraction left at grain boundaries (19, 38, 39), which also explained the disappearance of our 2D signal over time and the slow increase in the (001)3D peak intensity during annealing at 150° C. Solid-state 1HNMR on scraped films of FAPbI₃ were evaluated. NMR of FAPbI₃—5 mol % BA₂PbI₄ films annealed at various temperatures (70° C. for 3 min, 150° C. for 20 min, and 200° C. for 20 min), scraped with a blade and the resultant powder dissolved in deuterated DMSO before and after annealing did reveal a partial volatilization of the spacer cation during film formation but also confirmed appreciable fractions of BA and PA even after annealing at 150° C. for 20 min. After annealing for 20 min at 200° C. nearly all BA had left the film. Time-of-flight secondary ion mass spectrometry (ToF-SIMS) were studied as a function of depth (nm) and across concentrations of 0 mol %, 0.5 mol % and 1.0 mol % of the cations. The TOF-SIMS results suggested that the remaining 2D spacer cations were homogeneously distributed up to 1 mol % and, for higher concentrations, appeared more pronounced toward the film interface with the substrate.

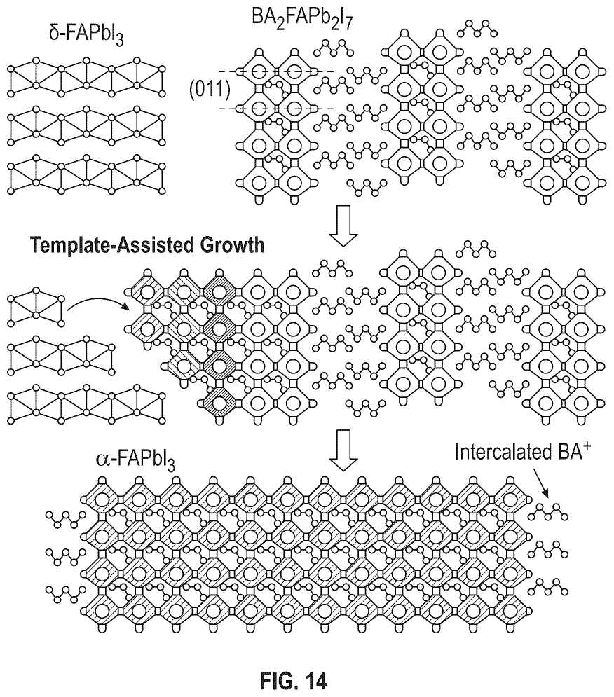

The BA and PA cations led to the formation of a mixed 2D-3D phase that was challenging to characterize with the aforementioned long-range techniques. Instead, high-field (21 T) solid-state NMR spectroscopy was applied to resolve the local structures of the organic cations in the mixed phase. The 1HNMR peaks associated with the large (BA and PA) and small (FA) cations were well resolved, so the amount of 2D phase present in the templated FAPbI₃ materials could be identified and quantified. In addition, the local structures of the mixed phases, elucidated by analyzing 2D 1H-1H correlation NMR spectra showed the presence of through-space intermolecular interactions between the large cations (BA or PA) in the 2D phase and the small cations (FA) in the 3D FAPbI₃ phase. In view of these findings, a comprehensive schematic diagram was formed for capturing the different stages of film formation in a 2D-templated FAPbI₃ (FIG. 14).

### Example 5

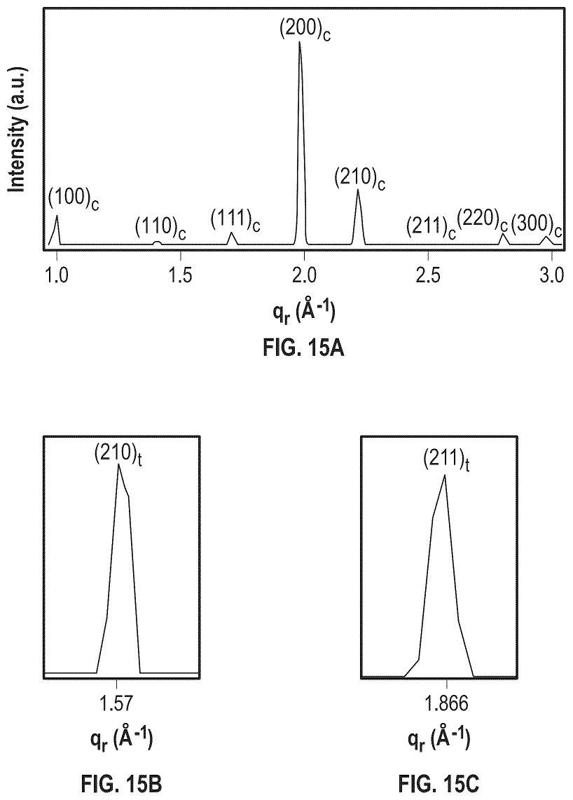

It was hypothesized that the observed compressive lattice strain applied by the templating 2D phase can result in the formation of a locally segregated tetragonal structure (55, 56). To investigate the impact of 2D stabilization on nanoscale structural properties of FAPbI₃, nanoscale XRD was performed with a 25-nm spot size x-ray probe on MACl-stabilized FAPbI₃ and 2D-stabilized FAPbI₃. The high brilliance of a synchrotron light source enabled resolution of diffraction from minority phases (57, 58). Pearson correlation coefficient of the CCD image of the diffraction pattern with respect to the initial diffraction CCD image over 10 s of irradiation time were measured. The substantial correlation over long times indicated X-ray stability much longer than the 100 ms dwell time used for nanoprobe diffraction mapping. Both films showed sufficient x-ray stability to accommodate the measurement. Localized x-ray scattering from both cubic (i.e., a) and tetragonal phases was observed. A representative summed diffraction charge-coupled device image from a map of 2D-stabilized FAPbI₃ was collected. An azimuthally integrated nano-XRD pattern as shown in FIG. 15A was collected for a film of BA₂FAPb₂I₇-templated FAPbI₃. In addition to intense scattering from the cubic perovskite lattice, two subtle peaks were observed that were indexed to the tetragonal phase, the (210)t (t=tetragonal) at 1.57 Å-1 and (211)t at 1.866 Å-1 (FIGS. 15B-15C). The (211)t peak could not be definitively indexed as tetragonal because of the overlapping (210)h (h=hexagonal, d-phase) peak at virtually the same scattering vector, but the (210)t was unambiguously identified (59). Furthermore, because no additional scattering peaks from the hexagonal phase were observed in this sample, the (211)t peak was attributed to the tetragonal phase. The diffraction from the tetragonal phase was far less intense than diffraction from the cubic phase, with total summed diffraction intensity from the (211)t peak amounting to 0.8% of the intensity of the (200)c (c=cubic) peak.

To investigate the impacts of 2D stabilization on the quality of the perovskite crystallites in the thin film, 5D rocking curves (rocking curves with 2D detector and 2D spatial mapping) were performed on the sample where the angle of the incident x-ray was varied, and spatial maps in the plane of the sample were repeated over the same area to precisely analyze the width of the diffraction peak.

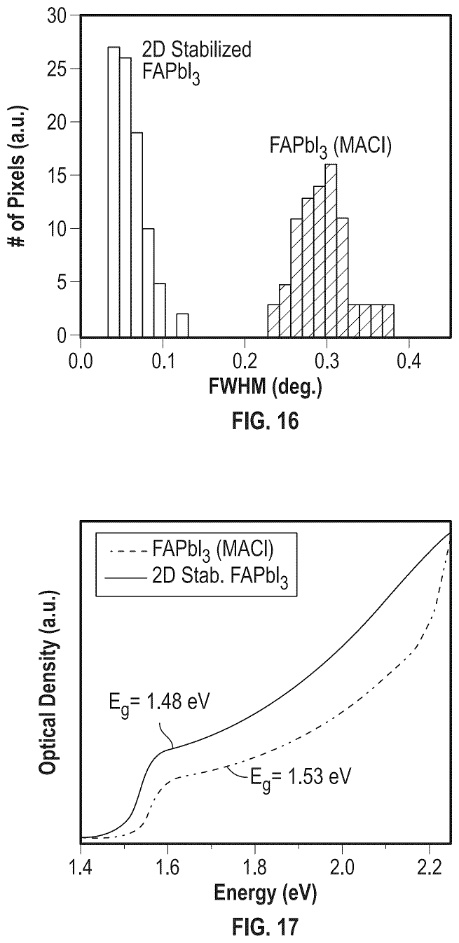

The 2D-stabilized FAPbI₃ exhibited substantially narrower diffraction full width at half maximum (FWHM) than the MACl-doped FAPbI₃ (FIG. 16). The narrower diffraction peak could be a result of an increase in domain size or reduced microstructural disorder (microstrain) (60). However, the well-established increase in domain size seen when MACl was included in perovskite precursors suggested that a smaller domain size in MACl-doped FAPbI₃ was not the cause (26, 61, 62). It was concluded that the 2D-stabilization resulted in a reduced structural disorder within the crystallites of the thin film, which is consistent with previous reports (54). Halder-Wagner analysis of the micro-strain and coherence length of various concentrations of BA₂FAPb₂I₇ crystal doping further revealed that microstrain in 2D-stabilized FAPbI₃ decreased with increasing 2D concentration. The following concentrations were investigated: 35 mol % MACl, 0.25 mol % BA n=2, 0.5 mol % BA n=2, and 1.0 mol % BA n=2. Halder-Wagner plots were used for extracting the strain E and crystallite size D from XRD data using the equation:

$${( \frac{{β}^{⋆}}{{d}^{*}} )}^{2} = \frac{K}{D} \cdot \frac{{β}^{⋆}}{{( {d}^{*} )}^{2}} + {( 2 ε )}^{2} ,$$

$$where$$

$${β}^{*} = \frac{β cos cos θ}{λ}$$

is the integral breadth of the reciprocal lattice point,

$${d}^{*} = \frac{2 sin sin θ}{λ}$$

is the reciprocal lattice plane spacing, and K is the shape factor.

The grazing-incidence WAXS (GIWAXS) patterns of the MACl-doped FAPbI₃ perovskite thin films were collected and FAPbI₃ with BA₂FAPb₂I₇ additive revealed two different characteristics of the thin films. The MACl-doped FAPbI₃ films exhibited Bragg intensities extended along arc segments, indicating a random orientation of crystal domains or grains within a polycrystalline film (high mosaicity). Furthermore, these films showed PbI₂ diffraction peaks. In contrast, the 2D-stabilized FAPbI₃ films revealed well-defined Bragg diffraction spots along the (001) plane, observed along the Debye-Scherrer ring near q=1 Å-1. This distinct observation implied smaller mosaicity and improved grain orientation in the out-of-plane direction, perpendicular to the substrate. Furthermore, mosaicity appeared to be reduced with increasing 2D concentration. Atomic force microscopy likewise showed an increase in FAPbI₃ grain size when 2D concentration was increased from 0.25 mol % to 0.5 mol %, although a further increase to 1.0 mol % caused the grain size to decrease. These results were consistent with the observation of improved crystallinity for FAPbI₃ films incorporating even small amounts of BA n=2.

An increase in the absorption of the 2D-stabilized FAPbI₃ was observed compared with the MACl-doped FAPbI₃. A bandgap of 1.61 eV was derived for the triple cation C_{0.05}FA_{0.85}MA_{0.01}Pb(I_{0.9}Br_{0.1})₃. As shown in FIG. 17, a bandgap of 1.53 eV was derived for the MACl-doped films that was much closer to the smallest reported (1.48 eV) bandgap of FAPbI₃ (5). Further, comparison of the bandgap values to the optimum of 1.34 eV were evaluated with a Shockley-Qeisser limit curve. This bandgap reduction was consistent with experimental signatures pointing toward a reduction of the lattice disorder (54). In a polymorphous picture of the cubic phase of FAPbI₃, the reduction of polymorphism also led to reduced tilt amplitudes (4, 63). As 2D concentration increased, the valence band maximum decreased and the bandgap widened. For MACl doped FAPbI₃, the VBM was 5.34 eV. For 0.25 mol % BA n=2, the VBM was 5.15 eV. For 0.50 mol % BA n=2, the VBM was 5.23 eV. For 1.0 mol % BA n=2, the VBM was 5.26 eV.

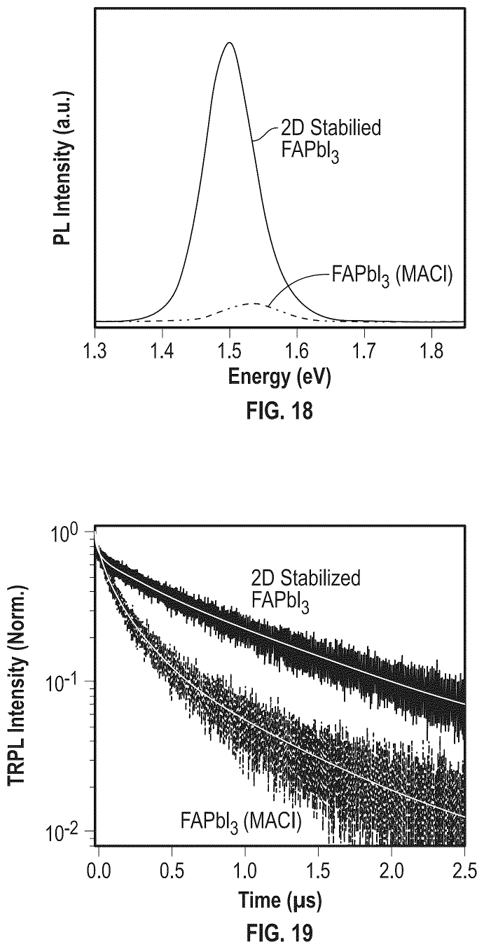

We also observed an order of magnitude increase in the PL intensity of the 2D-stabilized FAPbI₃ compared with the MACl-doped FAPbI₃ indicating reduced nonradiative recombination (FIG. 18). The PL peak positions aligned with the absorption thresholds for both the films. In time-resolved PL measurements (FIG. 19), the 2D-stabilized FAPbI₃ film exhibited a slower PL decay rate compared with the reference, implying a decrease in nonradiative recombination attributable to a reduction in trap-mediated bulk or surface recombination processes.

### Example 6

2D-stabilized FAPbI₃ were used to fabricate perovskite solar cells using an inverted architecture with MeO-2PACz {[2-(3,6-dimethoxy-9Hcarbazol-9-yl)ethyl]phosphonic acid} as the hole transport layer and C60 as the electron transport layer. To construct a band diagram of the device architecture, we measured the valence band maxima and conduction band minima of the MACl-doped FAPbI₃ and 2D-stabilized FAPbI₃ by combining photoemission yield spectroscopy (PES) and absorption measurements. The 2D-stabilized FAPbI₃, although slightly shifted toward higher energy compared with the MACl-doped FAPbI₃, had an appropriate band alignment for charge carrier separation and extraction.

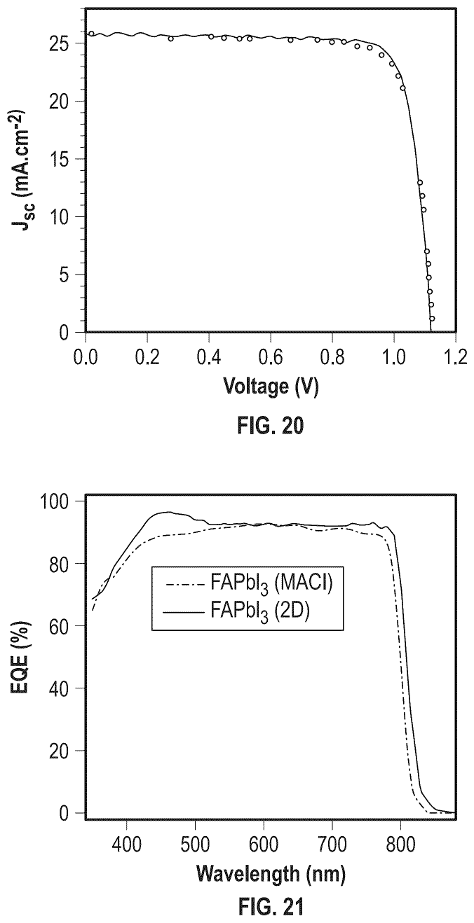

The current density-voltage (J-V) characteristics of the best-performing 2D-stabilized FAPbI₃ device in reverse and forward bias sweeps are illustrated in FIG. 20. A PCE of 24.1% was measured for an active area of 0.5 cm² under AM1.5G illumination with a short-circuit current density (JSC) of 25.5 mA·cm⁻², open circuit voltage (VOC) of 1.12 V, and fill factor (FF) of 82%. These metrics compared favorably with the corresponding thermodynamic limits of 31.1 mA·cm⁻², 1.21 V, and 89%, respectively (64). FIG. 21 shows the external quantum efficiency (EQE) for the same device as that of the J-V curve. Solar cells under identical conditions using different 2D perovskite concentrations were fabricated to confirm the impact of concentration on performance. The statistical distributions of JSC, VOC, FF, and PCE for 40 devices of each condition were evaluated. The J_{SC} obtained by integrating the EQE over the wavelength is 24.3 mA·cm⁻², which was in good agreement with that of the device's J-V curve measured using a solar simulator. For comparison, FAPbI₃ devices stabilized using 0.5 mol % PA₂FAPb₂I₇, OA₂FAPb₂I₇, and PEA₂FAPb₂I₇ were fabricated. The PA-templated FAPbI₃ device exhibited a PCE of 21% with a J_{SC} of 25.2 mA·cm⁻², VOC of 1.06 V, and FF of 78.1%. In the case of optimized OA- and PEA-templated FAPbI₃, achieved PCEs of 16.54% (J_{SC} of 23.93 mA·cm⁻², V_{OC} of 0.97 V, and FF of 71%) and 14.65% (J_{SC} of 23.15 mA·cm⁻², V_{OC} of 0.96 V, and FF of 65%), respectively, were obtained.

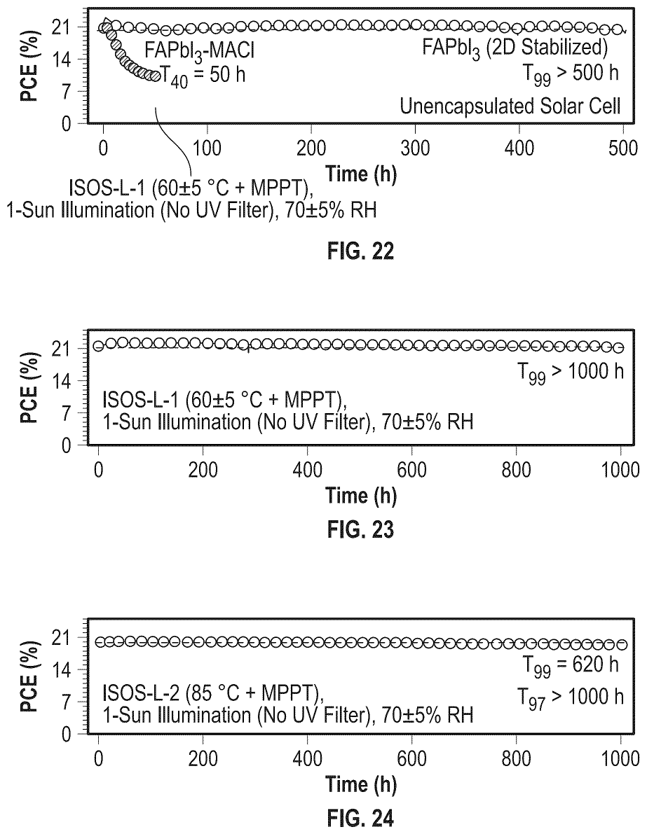

Finally, we compared the intrinsic and operational stability of undoped, BA₂FAPb₂I₇-templated, and MACl-doped FAPbI₃ films and devices. The 2D-templated FAPbI₃ was exceptionally stable under a variety of conditions compared with both undoped and MACl-doped FAPbI₃. The shelf stability of 2D-stabilized FAPbI₃ films showed a significant improvement compared with undoped FAPbI₃ over the course of 0 to 30 days. Further, pristine undoped FAPbI₃ was compared to a 0.5 mol % NA n=2 doped film sample in ambient air for 10 hours. While the 0 hour 0.5 mol % Ba n=2 doped FAPbI₃ sample showed strong peaks evident of the α-FAPbI₃ phase and minimal δ-FAPbI₃, the 10 hr ambient air sample almost exclusively yielded the δ-FAPbI₃ phase. Further, the color change between the undoped FAPbI₃ and the 0.5 mol % BA n=2 doped FAPbI₃ film were compared. Within 10 hours, the undoped FAPbI₃ film degraded, while that of the 0.5 mol % BA n=2 doped FAPbI₃ film showed little degradation of the course of 30 days. In-situ GIWAXS measurements were also performed to compare the stability of MACl-doped and BA₂FAPb₂I₇-incorporated FAPbI₃ devices in a >90% RH environment at 65° C. with 1-sun illumination. The 2D-templated FAPbI₃ device showed minimal a→d conversion over 170 min in the degrading environment. In contrast, the d-phase became dominant in the MACl-doped FAPbI₃ device within the first 15 min of measurement. The much higher stability of the 2D-templated FAPbI₃ device in this experiment corroborated the MPPT device stability tests shown in FIG. 22 for 2D-templated FAPbI₃ and MACl-doped FAPbI₃.

We evaluated the device stability with standard interfaces. Measurements were first performed on unencapsulated p-i-n solar cells in ambient air under 1-Sun illumination (no UV filter) with MPPT. As shown in FIG. 22, the 2D-templated devices showed almost no PCE drop during the first 500 hours of operation with T99>500 h. In contrast, the unencapsulated MACl doped FAPbI₃ sample degraded within the first 50 hr of operation showing a T40=50 h. Further, as shown in FIG. 23, an encapsulated 2D-templated FAPbI₃ device showed almost no efficiency drop from an initial 21% PCE for more than 1000 hours (T99>1000 hr) of continuous 1-Sun illumination at MPPT in ambient air (ISOS-L-1 protocol). This stability is among the best reported for FAPbI₃-based perovskite devices, which in recent reports (26,27,36) have been measured under inert conditions. The encapsulated solar cells were additionally measured under 1-sun illumination at MPPT at 85° C. on a hot plate in the ambient atmosphere (ISOS-L-2 protocol), as shown in FIG. 24. The 2D-stabilized FAPbI₃ devices retained 99% of their initial PCE after 620 hours, and more than 97% of their initial PCE after 1000 hours. Using the rule of thumb from Si photovoltaics that a 10° C. increase in temperature translates to a 2× increase in degradation rate (64), a T97=1000 hours at 85° C. corresponds to a T97=16000 hours (1.8 years) at 45° C. This result is a critical step towards a FAPbI₃-based device with commercially-relevant stability.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of forming a perovskite film comprising:
depositing an ink onto a substrate, the ink comprising:
one or more 2D perovskite crystals;
one or more group one cations or ammonium halides;
one or more metal halides; and
one or more solvents; and
annealing the substrate to form the perovskite film.

2. The method of claim 1, wherein the annealing comprises heating the substrate to a temperature ranging from room temperature to 200° C.

3. The method of claim 1, wherein the group one cation or ammonium halide is selected from the group consisting of a formamidinium halide, a cesium halide, a guanidinium halide, a methyl ammonium halide and combinations thereof.

4. The method of claim 1, wherein the metal halide is lead iodide.

5. The method of claim 1, wherein the ink comprises from 0.1 to 50 mol % of the 2D perovskite crystals.

6. The method of claim 1, wherein the 2D perovskite crystals comprise a perovskite having a formula A′Aₙ₋₁BₙX₃ₙ₊₁ or A′AₙBₙX₃ₙ₊₁ where A′ is a spacer cation, A is a monovalent cation, B is a divalent metal, n=1-7, and X is a halide.

7. The method of claim 6, wherein A′ is selected from the group consisting of butylammonium, pentyl ammonium, hexyl ammonium, heptyl ammonium, phenyl ethyl ammonium, octyl ammonium, 4-aminomethyl piperidine, 3-aminomethyl piperidine, 3-(aminomethyl)pyridine, butyldiamine, and combinations thereof.

8. The method of claim 6, wherein A is selected from the group consisting of formamidinium, dimethylammonium, cesium, and guanidinium.

9. The method of claim 6, wherein X is selected from the group consisting of iodide, bromide, chloride and combinations thereof.

10. The method of claim 6, wherein B is selected from the group consisting of lead, germanium, bismuth, copper, silver, gold, gallium, indium, antimony, tin and combinations thereof.

11. The method of claim 1, wherein the 2D perovskite is selected from the group consisting of BA₂PbI₄, BA₂FAPb₂I₇, and combinations thereof.

12. The method of claim 1, wherein the perovskite film comprises FAPbI₃.

13. The method of claim 1, wherein the solvent is selected from the group consisting of dimethylformamide, dimethyl sulfoxide, and combinations thereof.

14. The method of claim 13, wherein the solvent is a mixture of DMF and DMSO provided in a ratio ranging from 1:1 to 9:1 DMF:DMSO.

15. An optoelectronic device comprising a perovskite film formed from the method of claim 1.

16. The device of claim 15, wherein the optoelectronic device comprises a solar cell.

17. The device of claim 16, wherein the solar cell has an efficiency of at least 23.5%.

18. A perovskite ink comprising:
2D perovskite crystals;
a group one cation or ammonium halide;
a metal halide; and
a solvent.

19. The ink of claim 18, wherein the group one cation or ammonium halide is selected from the group consisting of a formamidinium halide, a cesium halide, a guanidinium halide, a methyl ammonium halide and combinations thereof.

20. The ink of claim 18, wherein the 2D perovskite crystals comprise a perovskite having a formula A′Aₙ₋₁BₙX₃ₙ₊₁ or A′AₙBₙX₃ₙ₊₁ where A′ is a spacer cation, A is a monovalent cation, B is a divalent metal, n=1-7, and X is a halide.
